(19) United States
(12) Patent Application Publication
(10) Pub. No.: US 2012/0274888 A1
(43) Pub. Date: Nov. 1, 2012

(54) OPTICALLY ANISOTROPIC SUBSTANCE

(75) Inventors: YOSHIHARU HIRAI, CHIBA (JP); NORIO TAMURA, CHIBA (JP)

(73) Assignees: JNC PETROCHEMICAL CORPORATION, TOKYO (JP); JNC CORPORATION, TOKYO (JP)

(21) Appl. No.: 13/547,849

(22) Filed: Jul. 12, 2012

Related U.S. Application Data
(62) Division of application No. 12/781,201, filed on May 17, 2010.

(30) Foreign Application Priority Data
May 22, 2009 (JP) 2009-123984
Feb. 3, 2010 (JP) 2010-021918

(51) Int. Cl. G02F 1/1335; G02B 5/30; B05D 5/06

(52) U.S. Cl. 349/117; 427/553; 359/489.07

(57) ABSTRACT

A polyamic acid-type photo-alignment layer in a heating process only below approximately 140° C., and an optically anisotropic substance in which various polymerizable liquid crystal compositions are uniformly oriented by use of the layer are provided. An optically anisotropic substance obtained by applying a polyamic acid varnish which is a composition including a polyamic acid having a divalent azobenzene group in the principal chain or its derivative, or a composition including a mixture of both this polyamic acid or its derivative and other polyamic acids or its derivative as a polymer component, to a supporting substrate, by drying the resultant layer at a temperature range of approximately 50° C. to approximately 140° C., by carrying out alignment treatment by irradiation of the layer with light, applying a polymerizable liquid crystal composition to a alignment layer formed by means of the treatment, and polymerizing the composition.

### CROSS-REFERENCE TO RELATED APPLICATION

This application is a divisional application of and claims the priority benefit of U.S. application Ser. No. 12/781,201, filed on May 17, 2010, now pending, which claims the priority benefit of Japan application Serial No. 2010-021918, filed on Feb. 3, 2010 and Japan application Serial No. 2009-123984, filed on May 22, 2009. The entirety of each of the above-mentioned patent applications is hereby incorporated by reference herein and made a part of specification.

### BACKGROUND OF THE INVENTION

1. Field of the Invention

The invention relates to a method for producing a photo-alignment layer from a polyamic acid varnish which includes a polyamic acid having a divalent azobenzene group in the principal chain as a polymer component. This invention also relates to an optically anisotropic substance formed on this photo-alignment layer.

2. Related Art

A polymerizable compound having a liquid crystal phase gives a polymer having a function such as optical compensation by means of polymerization. This is because the orientation of liquid crystal molecules is fixed by polymerization. A rubbing method and a photo-alignment method are generally used for an adjustment of the orientation of the polymer. A stretched birefringent film has been used for an optical retardation film, and in recent years, an optical retardation film having more complex optical characteristics which are not attained by way of a stretched birefringent film has been obtained, where polymerizable liquid crystals are applied to an alignment layer on a substrate, the liquid crystal molecules are oriented in a rubbing direction, and then the orientation is fixed by means of polymerization, which lead to a combination of the alignment direction of the alignment layer and the orientation method of the polymerizable liquid crystals. However, the rubbed alignment layer has a subject to be solved in which scratches and dust are formed in the rubbing process. Moreover, it is not easy to carry out rubbing treatment so that the direction of liquid crystal molecules is adjusted in each divided area on the surface of a substrate.

The rubbing treatment is not carried out to a photo-alignment layer. The photo-alignment layer constitutes one of alignment methods in which liquid crystal molecules can be oriented without rubbing, and the layer can gain ability to align liquid crystals, without contact, only by irradiation of the layer formed on a substrate with light. In the photo-alignment method, the orientation direction of liquid crystal molecules can be adjusted by regulating the direction of light, and there is no possibility that scratches and dust are formed. Therefore, the degree of freedom for adjusting orientation is increased and an optical retardation film with few defects can be formed in the preparation of an optical retardation film by using polymerizable liquid crystals.

A photo-alignment layer utilizing a polyamic acid which has an azobenzene group in the principal chain is known until now (see patent documents Nos. 1 and 2). Photo-alignment treatment utilizes the photoisomerization of a divalent azobenzene group, and is proposed for the purpose of adjusting orientation of liquid crystals for driving, which are sealed in the liquid crystal cell of a liquid crystal display device. In this case, thermal imidization is necessary in order to ensure reliability. Such thermal imidization is carried out at a temperature of at least approximately 140° C., and its application to an optical film for an optical use is difficult in consideration of the allowable temperature limit of the film.

Related art is disclosed in patent document No. 1: JP H10-253963 A (1998) and patent document No. 2: JP 2005-275364 A (2005).

An advantage of the invention is to provide a polyamic acid-type photo-alignment layer in a heating process only below approximately 140° C., and to provide an optically anisotropic substance in which various polymerizable liquid crystal compositions are uniformly oriented by use of the layer.

The inventors have found that a photo-alignment layer formed from a varnish gains an excellent ability to align liquid crystals without thermal treatment at a temperature of at least approximately 140° C. after photo-alignment treatment by irradiation with light, when a polyamic acid having a divalent azobenzene group in the principal chain is used as a polymer component of the varnish. The inventors have also found that reliability as an optically anisotropic substance is ensured even when a polymerizable liquid crystal composition is applied to the photo-alignment layer and polymerized for fixing the alignment. Thus, the invention has been completed. The optically anisotropic substance of the invention is shown in the following item [1].

### SUMMARY OF THE INVENTION

[1] The invention concerns an optically anisotropic substance obtained by applying a polyamic acid varnish which is a composition including a polyamic acid having a divalent azobenzene group in the principal chain or a composition including a mixture of this polyamic acid and other polyamic acids as a polymer component, to a supporting substrate, by drying the resultant layer at a temperature range of approximately 50° C. to approximately 140° C., by carrying out alignment treatment by irradiation of the layer with light, applying a polymerizable liquid crystal composition to an alignment layer formed by means of the treatment, and polymerizing the composition, and also concerns an optical retardation film, a liquid crystal display device and a liquid crystal display apparatus that have the optically anisotropic substance.

### BRIEF DESCRIPTION OF THE DRAWINGS

FIG. 1: Results of the measurement of retardation on the optically anisotropic substance in Example 46.

### DETAILED DESCRIPTION OF THE INVENTION

In the following, a varnish including a polyamic acid which has a divalent azobenzene group in the principal chain, a polymerizable liquid crystal compound, a polymerizable liquid crystal composition including this compound, an optically anisotropic substance obtained from this composition and their use, regarding the invention, are explained in detail.

Usage of the terms in this specification is as follows. The term “a liquid crystal compound” is a generic name of a compound having a liquid crystal phase, such as a nematic phase and a smectic phase, and a compound which has no liquid crystal phases but useful as a component for a liquid crystal composition. A diamine represented by formula (1-1) may be abbreviated to the diamine (1-1). Diamines represented by other formulas may also be abbreviated in a similar manner. A tetracarboxylic acid dianhydride may be abbreviated to an acid anhydride, and a tetracarboxylic acid dianhydride represented by formula (A-1) may be abbreviated to the acid anhydride (A-1). Tetracarboxylic acid dianhydrides represented by other formulas may also be abbreviated in a similar manner. A compound represented by formula (M1) may be abbreviated to the compound (M1). Compounds represented by other formulas may also be abbreviated in a similar manner. “(Meth)acryloyloxy” means acryloyloxy or methacryloyloxy, “(meth)acrylate” means acrylate or methacrylate, and “(meth)acrylic acid” means acrylic acid or methacrylic acid.

The term “arbitrary” used in the explanation of chemical structural formulas means that “not only in cases when the position is arbitrary but also in cases when the number is arbitrary”. For example, the expression “arbitrary A may be replaced by B, C or D,” means that at least one A may be replaced by at least one B, at least one A may be replaced by at least one C, at least one A may be replaced by at least one D, and a plurality of A may be replaced by at least two of B, C and D, with proviso that a plurality of continuous —CH₂— are not replaced by a plurality of the same groups, or —CH₂— which is combined with —O— is not replaced by —O— in cases when arbitrary —CH₂— may be replaced by other groups.

A group in which a letter (for example, D) in a chemical structural formula is surrounded by a hexagon indicates that it is a group having a ring structure (ring D). When the same symbols are used in a plurality of formulas, these symbols represent any group within the definition, which however does not mean that these symbols should simultaneously represent the same groups within the definition. That is, the symbols may represent the same groups in a plurality of formulas or may represent different groups in every formula. Incidentally, the substituent, Me, in chemical structural formulas means methyl.

When, in these specifications, a liquid crystal skeleton exhibits orientation states such as homogeneous (horizontal), tilt (inclined), homeotropic (vertical) and twist (twisted) orientations, the skeleton may be described as having “a homogeneous orientation”, “a tilt orientation”, “a homeotropic orientation”, “a twist orientation” or the like. For example, a liquid crystal film with a homogeneous molecular orientation, namely a liquid crystal film oriented homogeneously, may be described as a liquid crystal film having a homogeneous orientation, or a liquid crystal film of a homogeneous orientation.

A polyamic acid varnish for a photo-alignment layer used in the invention had a divalent azobenzene group in the principal chain, and had an excellent ability to align liquid crystals even if thermal imidization treatment was not carried out after photo-alignment treatment. The optically anisotropic substance of the invention was excellent in a plurality of characteristics, such as refractive index anisotropy, transparency, chemical stability, heat resistance, hardness, adhesiveness, adhesion and mechanical strength, and thus was suitable for an optical retardation film, a polarizer, a circularly polarized light element, an elliptically polarized light element, an antireflection film, a selective reflection film, a color compensation film, a viewing angle-compensation film or the like.

The invention includes item [1] described above and item [2] to item [27] described below.

[2] The optically anisotropic substance according to item [1], wherein the polyamic acid having a divalent azobenzene group in the principal chain is a reaction product of a diamine having a divalent azobenzene group or of a mixture of the diamine having a divalent azobenzene group and other diamines with a tetracarboxylic acid dianhydride, where the diamine having a divalent azobenzene group is at least one of diamines represented by formula (1-1) to formula (1-7); and the polymerizable liquid crystal composition includes at least one compound selected from the group of compounds represented by formula (M1), formula (M2-1) to formula (M2-3), formula (M3) and formula (M4):

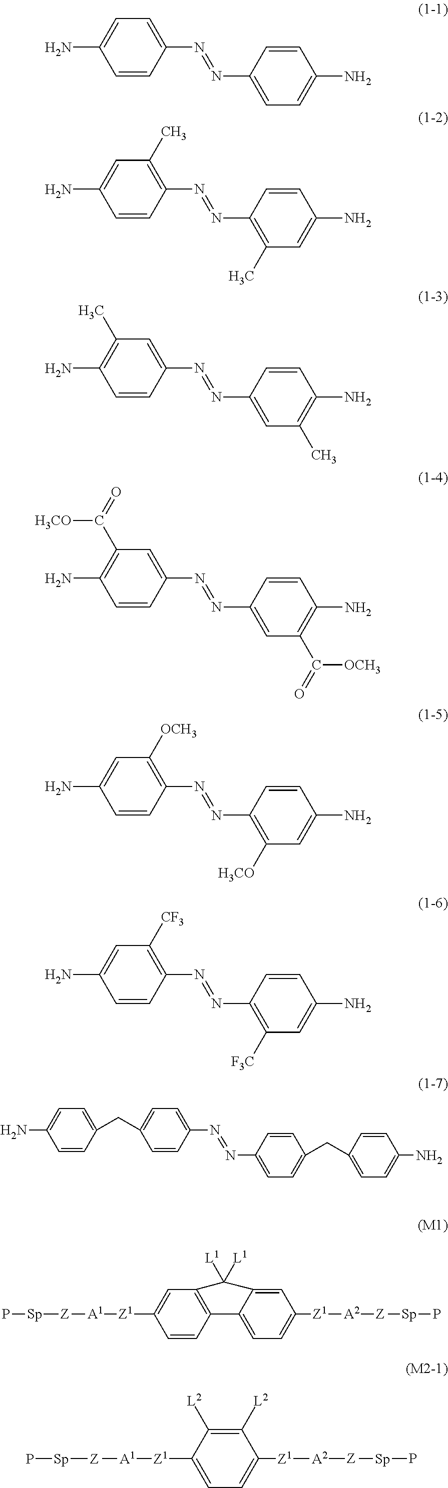

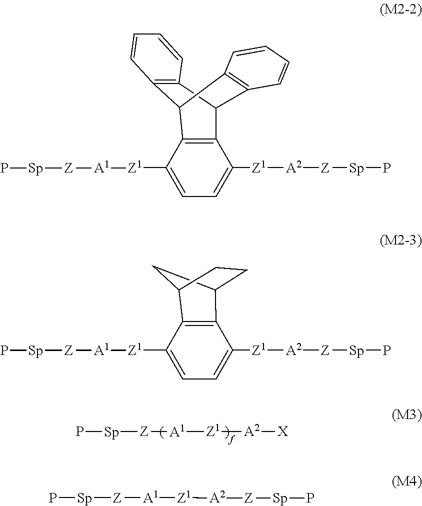

wherein

Sp is a single bond or alkylene having 1 to 20 carbons; and when the number of carbon is two or more in this alkylene, one or two nonadjacent —CH₂— may be replaced by —O—;

Z is independently a single bond, —O—, —COO—, —OCO— or —O—COO—;

A¹ and A² are each independently 1,4-cyclohexylene or 1,4-phenylene; and in these rings, one or two nonadjacent —CH₂— may be replaced by —O—, arbitrary —CH═ may be replaced by —N═, arbitrary hydrogen may be replaced by halogen, —C≡N, alkyl having 1 to 5 carbons or halogenated alkyl having 1 to 5 carbons;

Z¹ is independently a single bond or alkylene having 1 to 10 carbons; in this alkylene, arbitrary —CH₂— may be replaced by —O—, —CO—, —COO—, —OCO—, —CH═CH— or —C≡C— and arbitrary hydrogen may be replaced by halogen;

L¹ is independently hydrogen, fluorine or methyl;

L² is independently hydrogen, fluorine, methyl or trifluoromethyl;

f is an integer of 0 to 3; when f is 2 or 3, a plurality of A¹ in formula (M3) may be the same groups or may be consisting of at least two different groups, and a plurality of Z¹ in formula (M3) may be the same group or may be consisting of at least two different groups;

X is hydrogen, halogen, —C≡N, alkyl having 1 to 20 carbons or alkoxy having 1 to 20 carbons; arbitrary hydrogen of these alkyl and alkoxy may be replaced by halogen; and

P is any one of groups represented by formula (2-1) to formula (2-6):

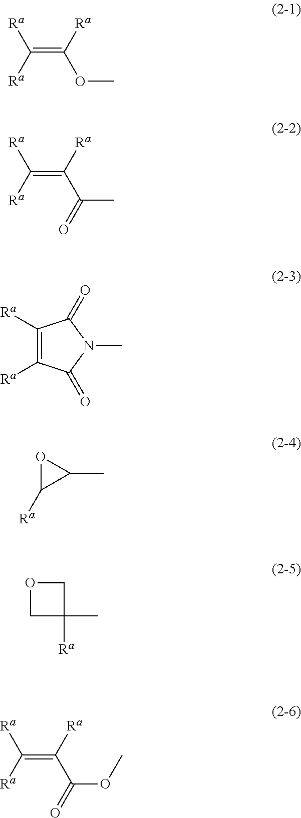

wherein R^{a} is independently hydrogen, halogen or alkyl having 1 to 5 carbons, and arbitrary hydrogen in this alkyl may be replaced by halogen.
[3] The optically anisotropic substance according to item [2], wherein the polyamic acid having a divalent azobenzene group in the principal chain is a reaction product of a mixture of a diamine having a divalent azobenzene group and other diamines with a tetracarboxylic acid dianhydride, where the other diamines are represented by formula (3):

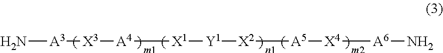

wherein A³, A⁴, A⁵ and A⁶ are each independently 1,3-cyclohexylene, 1,4-cyclohexylene, 1,3-phenylene or 1,4-phenylene, and arbitrary hydrogen of these rings may be replaced by alkyl having 1 to 4 carbons or benzyl; X¹ and X² are each independently a single bond, —O— or —S—; X³ and X⁴ are each independently a single bond, —CH₂—, —CH₂CH₂—, —O—, —S— or —C(R¹¹)(R¹²)—; Y¹ is alkylene having 1 to 12 carbons, —C(R¹¹)(R¹²)—, —CO— or —SO₂—; R¹¹ and R¹² are each independently alkyl having 1 to 6 carbons or perfluoroalkyl having 1 to 6 carbons; and m1, m2 and n1 are each independently 0 or 1.
[4] The optically anisotropic substance according to item [3], wherein, in formula (3), A³, A⁴, A⁵ and A⁶ are each independently 1,3-phenylene or 1,4-phenylene; arbitrary hydrogen of these rings may be replaced by alkyl having 1 to 4 carbons; X¹ and X² are each independently a single bond, —O— or —S—; X³ and X⁴ are each independently a single bond, —CH₂—, —CH₂CH₂—, —O— or —C(R¹¹)(R¹²)—; Y¹ is alkylene having 1 to 8 carbons, —C(R¹¹)(R¹²)— or —CO—; and R¹² are each independently alkyl having 1 to 3 carbons or perfluoroalkyl having 1 to 3 carbons; and m1, m2 and n1 are each independently 0 or 1.
[5] The optically anisotropic substance according to item [3], wherein, in formula (3), A³, A⁴, A⁵ and A⁶ are each independently 1,3-phenylene or 1,4-phenylene; arbitrary hydrogen of these rings may be replaced by methyl; X¹ and X² are each independently a single bond, —O— or —S—; X³ and X⁴ are each independently a single bond, —CH₂—, —CH₂CH₂—, —O— or —C(R¹¹)(R¹²)—; Y¹ is alkylene having 1 to 6 carbons, —C(R¹¹)(R¹²)— or —CO—; R¹¹ and R¹² are each independently methyl or trifluoromethyl; and m1, m2 and n1 are each independently 0 or 1.
[6] The optically anisotropic substance according to any one of item [2] to item [5], wherein the tetracarboxylic acid dianhydride is at least one compound selected from the group of tetracarboxylic acid dianhydrides represented by formula (A-1) to formula (A-44).

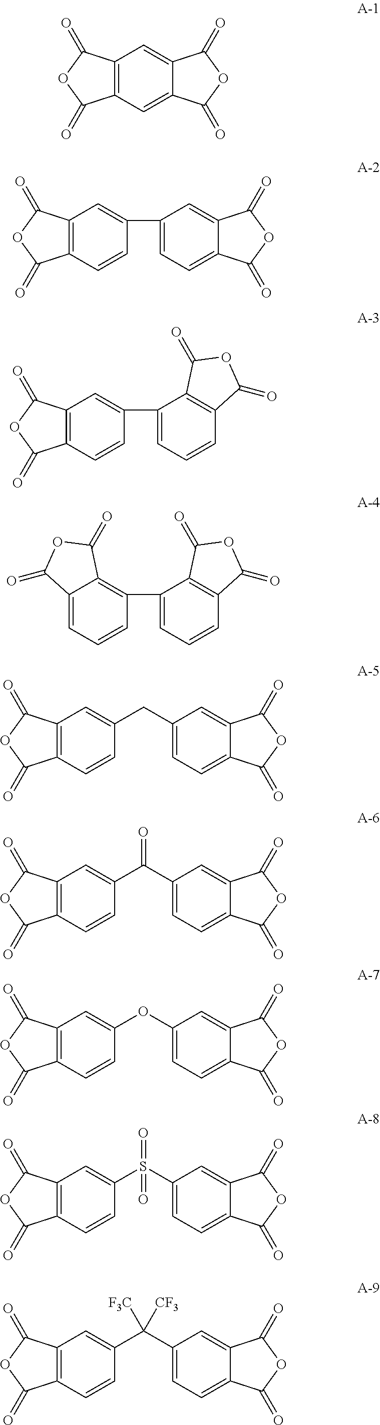

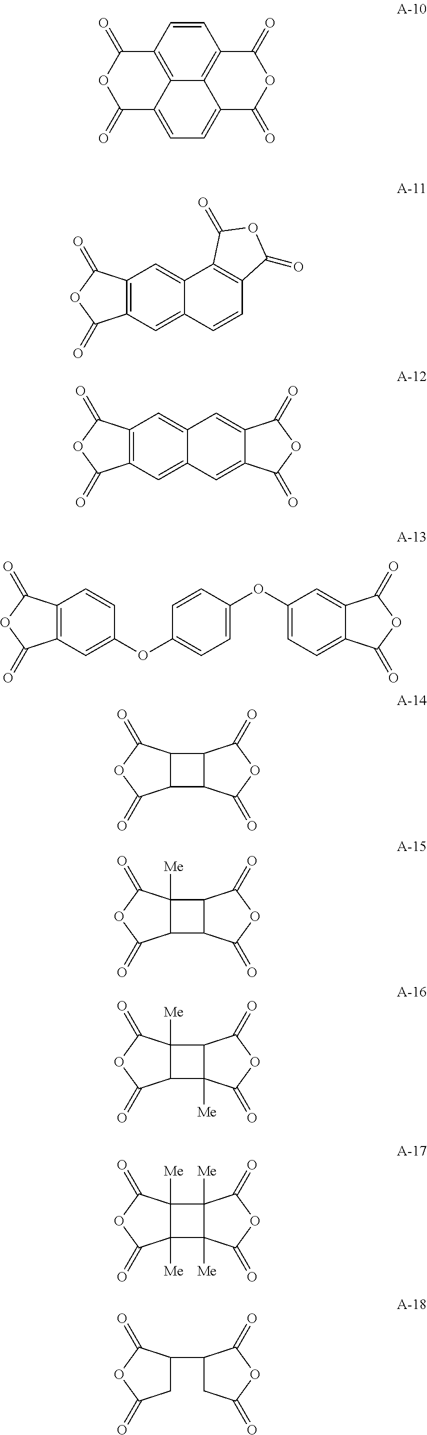

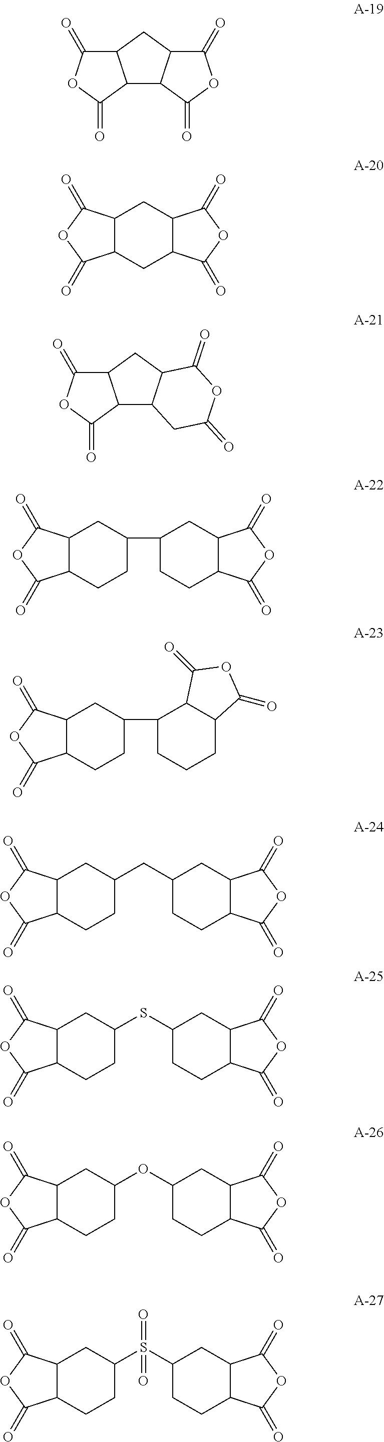

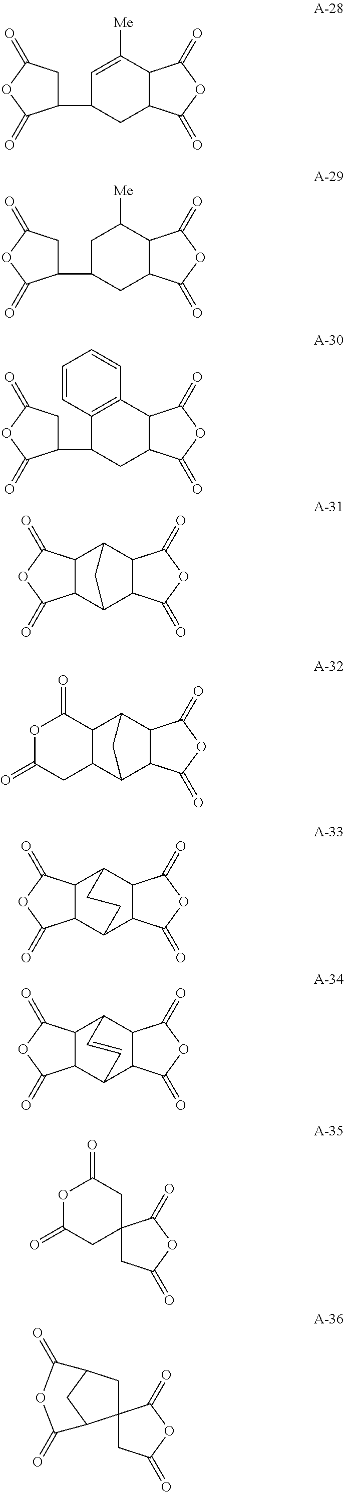

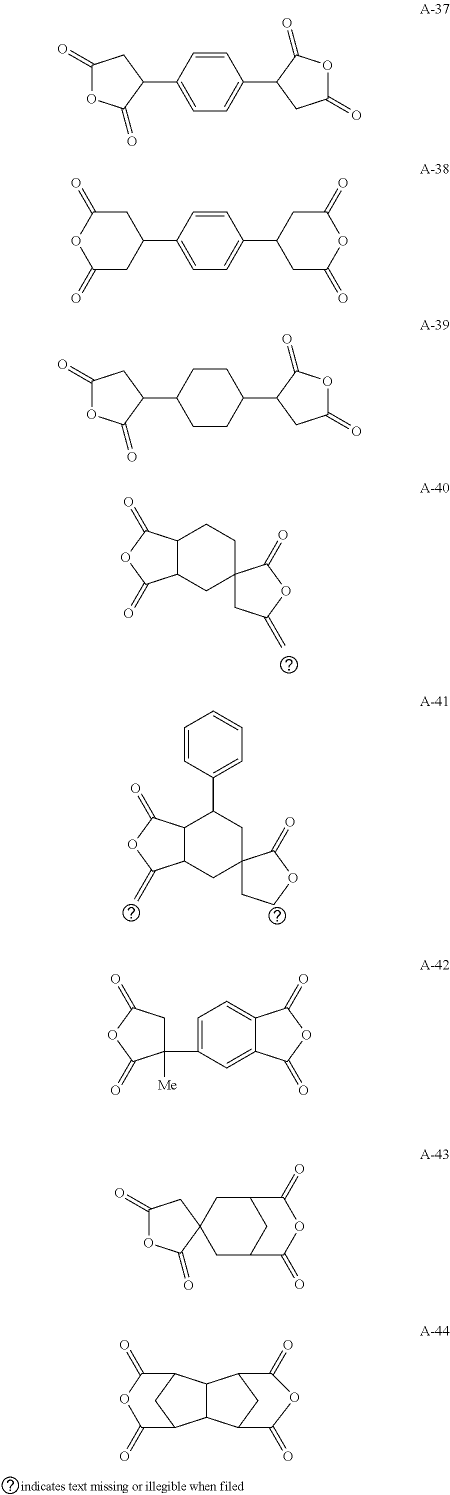

[7] The optically anisotropic substance according to item [6], wherein the tetracarboxylic acid dianhydride is at least one compound selected from the group of tetracarboxylic acid dianhydrides represented by formula (A-1), formula (A-2), formula (A-5) to formula (A-7), formula (A-9), formula (A-14) to formula (A-22), formula (A-24) to formula (A-26) and formula (A-28) to formula (A-44).
[8] The optically anisotropic substance according to any one of item [2] to item [7], wherein the polymerizable liquid crystal composition includes at least one compound selected from the group of compounds represented by formula (M1), formula (M2-1) to formula (M2-3), formula (M3) and formula (M4),

Sp is a single bond or alkylene having 1 to 12 carbons; in this alkylene, when the number of carbon is two or more, one or two nonadjacent —CH₂— may be replaced by —O—;

Z is a single bond, —O—, —COO—, —OCO— or —O—COO—;

A¹ and A² are each independently 1,4-cyclohexylene or 1,4-phenylene; in these rings, arbitrary hydrogen may be replaced by fluorine, —C≡N, alkyl having 1 to 5 carbons or fluoroalkyl having 1 to 5 carbons;

Z¹ is independently a single bond or alkylene having 1 to 10 carbons; in this alkylene, arbitrary —CH₂— may be replaced by —O—, —COO—, —OCO— or —CH═CH—;

L¹ is independently hydrogen, fluorine or methyl;

L² is independently hydrogen, fluorine, methyl or trifluoromethyl; and

P is a group represented by formula (2-4) or formula (2-5), where R^{a} is hydrogen, methyl or ethyl.

[9] The optically anisotropic substance according to item [8], wherein the polymerizable liquid crystal composition includes at least one compound selected from the group of compounds represented by formula (M1-A), formula (M1-B), formula (M3-A), formula (M3-B) and formula (M4-A):

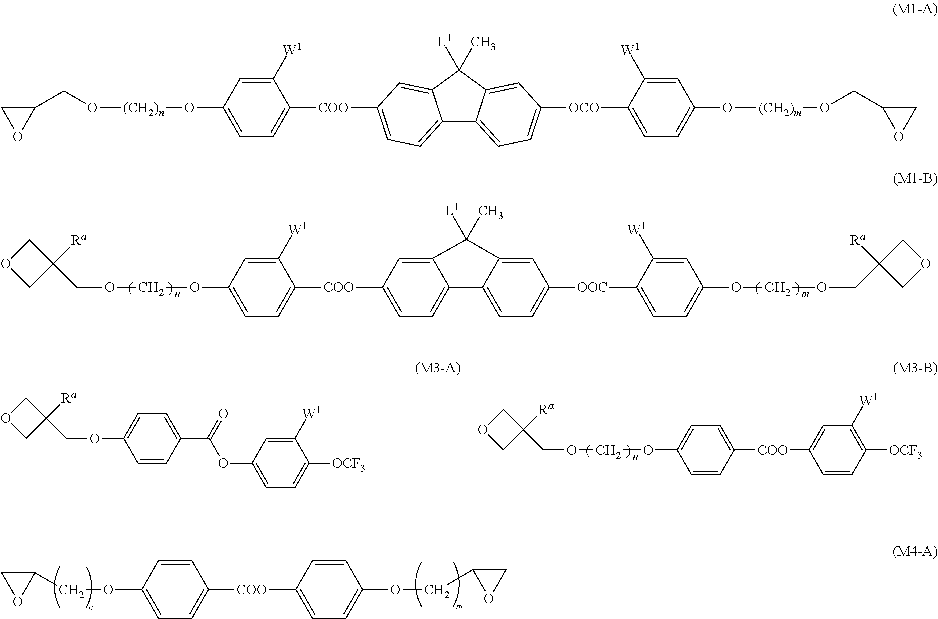

wherein L¹ is hydrogen or methyl; W¹ is hydrogen or fluorine; R^{a} is hydrogen, methyl or ethyl; and n and m are each independently an integer of 2 to 12.
[10] The optically anisotropic substance according to item [9], wherein, in the polymerizable liquid crystal composition,

the ratio of a compound represented by formula (M1-A) is in the range of approximately 0% to approximately 40% by weight;

the ratio of a compound represented by formula (M1-B) is in the range of approximately 0% to approximately 30% by weight;

the ratio of a compound selected from the group of compounds represented by formula (M3-A) and formula (M3-B) is in the range of approximately 0% to approximately 25% by weight;

the ratio of a compound selected from the group of compounds represented by formula (M1-A), formula (M1-B), formula (M3-A) and formula (M3-B) is in the range of approximately 5% to approximately 95% by weight; and

the ratio of a compound represented by formula (M4-A) is in the range of approximately 5% to approximately 95% by weight,

based on the total amount of compounds represented by formula (M1-A), formula (M1-B), formula (M3-A), formula (M3-B) and formula (M4-A).

[11] The optically anisotropic substance according to item [9], wherein, in the polymerizable liquid crystal composition,

the ratio of a compound represented by formula (M1-A) is in the range of approximately 0% to approximately 30% by weight;

the ratio of a compound represented by formula (M1-B) is in the range of approximately 0% to approximately 20% by weight;

the ratio of a compound selected from the group of compounds represented by formula (M3-A) and formula (M3-B) is in the range of approximately 0% to approximately 20% by weight;

the ratio of a compound selected from the group of compounds represented by formula (M1-A), formula (M1-B), formula (M3-A) and formula (M3-B) is in the range of approximately 5% to approximately 70% by weight; and

the ratio of a compound represented by formula (M4-A) is in the range of approximately 30% to approximately 95% by weight,

based on the total amount of the compounds represented by formula (M1-A), formula (M1-B), formula (M3-A), formula (M3-B) and formula (M4-A).

[12] The optically anisotropic substance according to any one of item [2] to item [7], wherein the polymerizable liquid crystal composition includes at least one compound selected from the group of compounds represented by formula (M1), formula (M2-1), formula (M2-2), formula (M2-3), formula (M3) and formula (M4),

Sp is a single bond or alkylene having 1 to 12 carbons; in this alkylene, when the number of carbon is two or more, one or two nonadjacent —CH₂ may be replaced by —O—;

Z is a single bond, —O—, —COO—, —OCO— or —OCOO—;

A¹ and A² are each independently 1,4-cyclohexylene or 1,4-phenylene; in these rings, arbitrary hydrogen may be replaced by fluorine, —C≡N, alkyl having 1 to 5 carbons or fluoroalkyl having 1 to 5 carbons;

Z¹ is independently a single bond or alkylene having 1 to 10 carbons; in this alkylene, arbitrary —CH₂— may be replaced by —O—, —COO—, —OCO— or —CH═CH—;

L¹ is independently hydrogen, fluorine or methyl;

L² is independently hydrogen, fluorine, methyl or trifluoromethyl; and

P is a group represented by formula (2-6), where R^{a} is hydrogen, methyl or ethyl.

[13] The optically anisotropic substance according to item [12], wherein the polymerizable liquid crystal composition includes at least one compound selected from the group of compounds represented by formula (M1-C), formula (M1-D), formula (M2-1-A), formula (M2-1-B), formula (M2-2-A), formula (M2-3-A), formula (M3-C), formula (M3-D) and formula (M3-E):

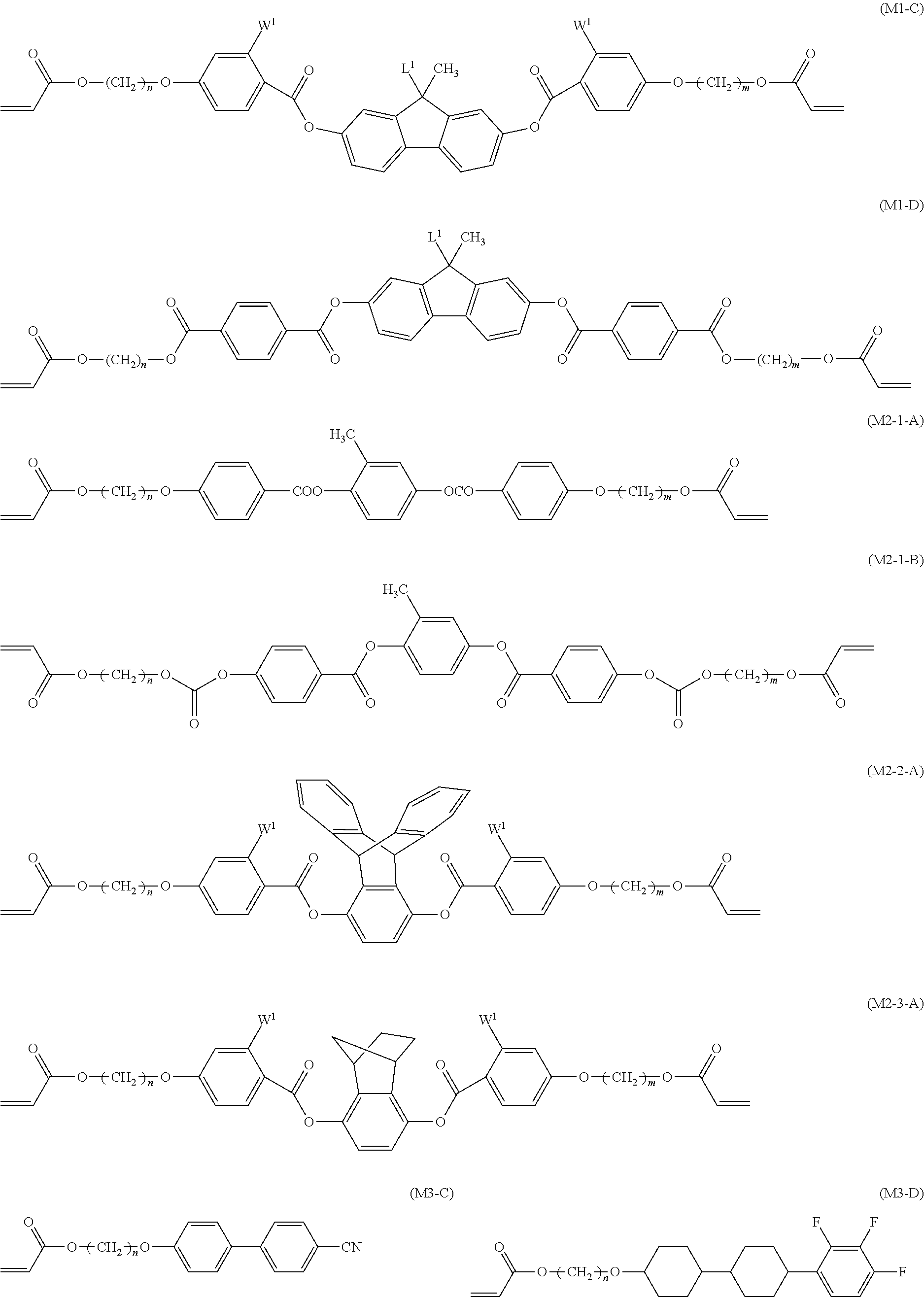

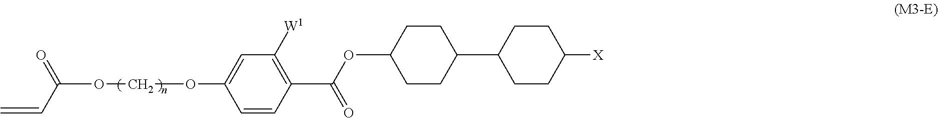

wherein L¹ is hydrogen or methyl; W¹ is hydrogen or fluorine; X is alkyl having 1 to 20 carbons; and n and m are each independently an integer of 2 to 12.
[14] The optically anisotropic substance according to item [13], wherein, in the polymerizable liquid crystal composition,

the ratio of a compound represented by formula (M1-C) is in the range of approximately 0% to approximately 85% by weight;

the ratio of a compound represented by formula (M1-D) is in the range of approximately 0% to approximately 50% by weight;

the ratio of a compound represented by formula (M2-1-A) is in the range of approximately 0% to approximately 70% by weight;

the ratio of a compound represented by formula (M2-1-B) is in the range of approximately 0% to approximately 70% by weight;

the ratio of a compound represented by formula (M2-2-A) is in the range of approximately 0% to approximately 70% by weight;

the ratio of a compound represented by formula (M2-3-A) is in the range of approximately 0% to approximately 70% by weight;

the ratio of a compound represented by formula (M3-C) is in the range of approximately 0% to approximately 45% by weight;

the ratio of a compound represented by formula (M3-D) is in the range of approximately 0% to approximately 30% by weight;

the ratio of a compound represented by formula (M3-E) is in the range of approximately 0% to approximately 70% by weight;

the ratio of a compound selected from the group of compounds represented by formula (M2-2-A), formula (M2-3-A), formula (M3-C), formula (M3-D) and formula (M3-E) is in the range of approximately 3% to approximately 97% by weight; and

the ratio of a compound selected from the group of compounds represented by formula (M1-C), formula (M1-D), formula (M2-1-A) and formula (M2-1-B) is in the range of approximately 3% to approximately 97% by weight,

based on the total amount of compounds represented by formula (M1-C), formula (M1-D), formula (M2-1-A), formula (M2-1-B), formula (M2-2-A), formula (M2-3-A), formula (M3-C), formula (M3-D) and formula (M3-E).

[15] The optically anisotropic substance according to any one of item [12] to item [14], wherein the polymerizable liquid crystal composition further includes the polymerizable compound represented by formula (M5):

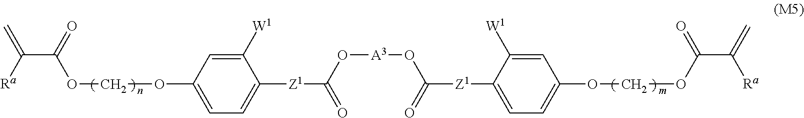

wherein R^{a} is independently hydrogen or methyl; W¹ is independently hydrogen or fluorine; Z¹ is independently a single bond, —CH₂CH₂— or —CH═CH—; n and m are each independently an integer of 2 to 12; and A³ is a group represented by any one of formula (A3-1) to formula (A3-18).

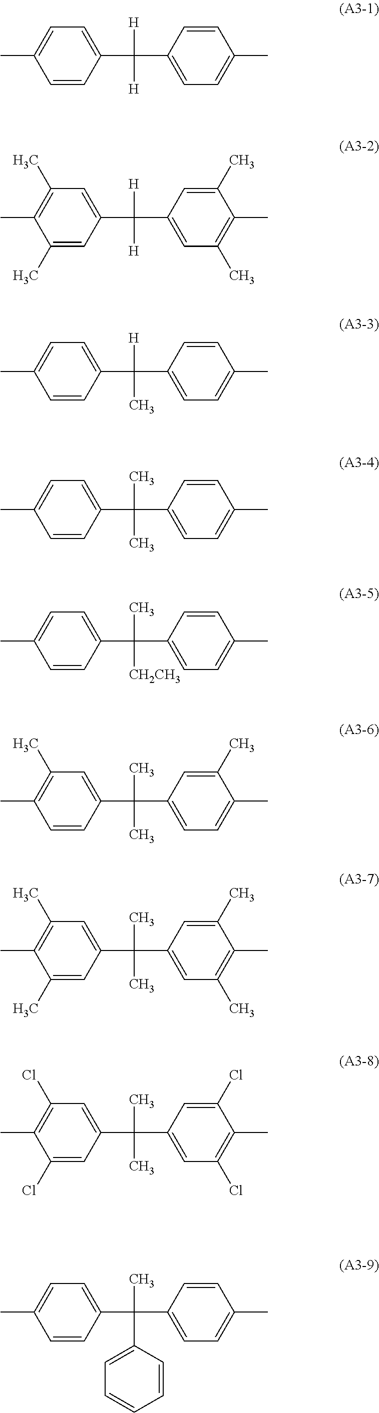

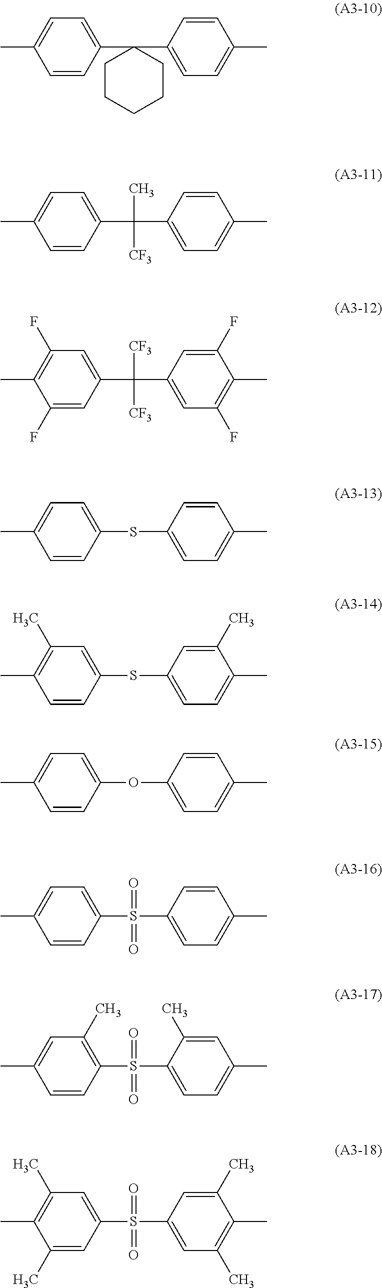

[16] The optically anisotropic substance according to item [15], wherein, in formula (M5), R^{a} is hydrogen; W¹ is independently hydrogen or fluorine; Z¹ is independently a single bond, —CH₂CH₂— or —CH═CH—; n and m are each independently an integer of 2 to 12; and A³ is a group represented by any one of formula (A3-3), formula (A3-11), formula (A3-12), formula (A3-16), formula (A3-17) and formula (A3-18).
[17] The optically anisotropic substance according to any one of item [8] to item [16], wherein the polymerizable liquid crystal composition further includes an optically active compound.
[18] The optically anisotropic substance according to any one of item [1] to item [17], wherein the light irradiation for orientation treatment is carried out by irradiation with linearly polarized light at an arbitrary angle to the supporting substrate.
[19] The optically anisotropic substance according to any one of item [1] to item [17], wherein the light irradiation for orientation treatment is carried out by a combination of irradiation with linearly polarized light in the perpendicular direction and irradiation with unpolarized light at an arbitrary angle.
[20] The optically anisotropic substance according to any one of item [1] to item [19], wherein liquid crystal molecules are oriented in a pattern of two or more different directions by carrying out orientation treatment by irradiation with light.
[21] The optically anisotropic substance according to any one of item [1] to item [20], wherein the supporting substrate is a glass substrate.
[22] The optically anisotropic substance according to any one of item [1] to item [20], wherein the supporting substrate is a plastic substrate composed of a plastic film.
[23] The optically anisotropic substance according to item [22], wherein material of the plastic film is any one selected from polyimide, polyamidoimide, polyamide, polyetherimide, polyetheretherketone, polyetherketone, polyketone sulfide, polyether sulfone, polysulfone, polyphenylene sulfide, polyphenylene oxide, polyethylene terephthalate, polybutylene terephthalate, polyethylene naphthalate, polyacetal, polycarbonate, polyarylate, acrylic resins, polyvinyl alcohol, polypropylene, cellulose, triacetyl cellulose, partially saponified triacetyl cellulose, epoxy resins, phenol resins and cycloolefin-based resins.
[24] The optically anisotropic substance according to item [22], wherein material of the plastic film is any one selected from polyimide, polyvinyl alcohol, triacetyl cellulose, partially saponified triacetyl cellulose and cycloolefin-based resins.
[25] An optical retardation film having the optically anisotropic substance according to anyone of item [1] to item [24].
[26] A liquid crystal display device having the optical retardation film according to item [25].
[27] A liquid crystal display apparatus having the liquid crystal display device according to item [26].

In the invention, a polyamic acid varnish which is a composition including a polyamic acid having a divalent azobenzene group in the principal chain is used as a polymer component. In this case, a mixture of this polyamic acid and other polyamic acids may also be used. In the invention, a derivative of the polyamic acid may be used instead of the polyamic acid. An example of a derivative of the polyamic acid includes a polyimide obtained by complete ring-closing dehydration of the polyamic acid, a partially imidized polyamic acid obtained by partial ring-closing dehydration of the polyamic acid, a polyamic acid ester, a polyamic acid-polyamide copolymer obtained by replacing part of a tetracarboxylic acid dianhydride by a dicarboxylic acid, and a polyamidoimide obtained by partial or complete ring-closing dehydration of this polyamic acid-polyamide copolymer. Among these, the polyimide and the partially imidized polyamic acid are desirable, and the polyimide is more desirable. In the following description excluding Examples, “a polyamic acid” is used as a generic term of a polyamic acid and its derivative unless otherwise indicated.

The polyamic acid having a divalent azobenzene group in the principal chain is obtained by the reaction of a tetracarboxylic acid dianhydride with a diamine having a divalent azobenzene group, preferably an azobenzene-4,4′-diyl group. The polyamic acid having a divalent azobenzene group in the principal chain is also obtained by the reaction of a diamine with a tetracarboxylic acid dianhydride having a divalent azobenzene group, for example, the acid anhydride (1-8) described below. In the invention, photo-alignment treatment is carried out utilizing the photoisomerization of this azobenzene group.

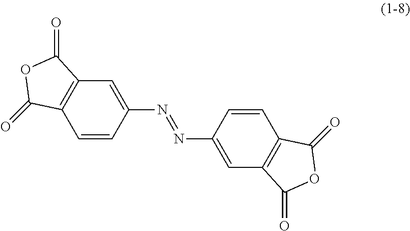

A desirable example of diamines having azobenzene-4,4′-diyl is the diamine (1-1) to the diamine (1-7).

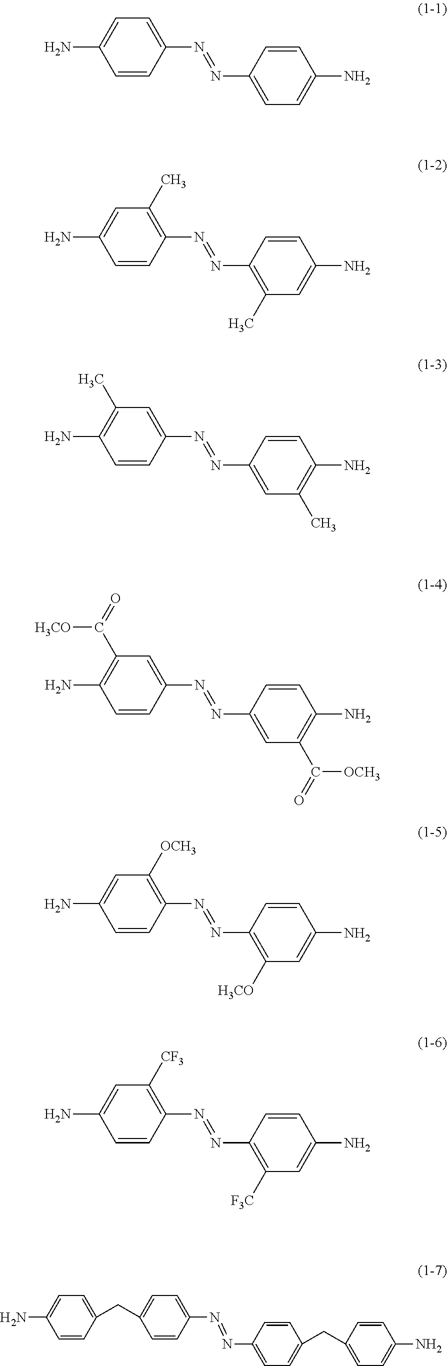

The ratio of the diamine component having a divalent azobenzene group or the tetracarboxylic acid dianhydride component described above is in the range of approximately 10 mol % to approximately 100 mol %, more preferably in the range of approximately 20 mol % to approximately 100 mol %, and even more preferably in the range of approximately 25 mol % to approximately 100 mol % based on the total amount of diamines or tetracarboxylic acid dianhydrides, respectively, which is used for the production of the polyamic acid.

In the invention, other diamines having no divalent azobenzene group can be used in combination with the diamine having a divalent azobenzene group in accordance with required characteristics of a photo-alignment layer. For example, when the photo-alignment layer is used as an application to an optical retardation film for liquid crystal displays, well-known diamines having an excellent alignment characteristic, such as characteristic decreasing coloration and maintaining ability to align liquid crystals, can be used.

A desirable example of such other diamines includes the diamine (3).

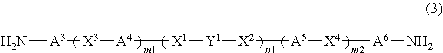

In formula (3), A³, A⁴, A⁵ and A⁶ are each independently 1,3-cyclohexylene, 1,4-cyclohexylene, 1,3-phenylene or 1,4-phenylene, and arbitrary hydrogen of these rings may be replaced by alkyl having 1 to 4 carbons or benzyl. Desirable examples of A³ to A⁶ are 1,3-phenylene, and 1,4-phenylene in which arbitrary hydrogen may be replaced by alkyl having 1 to 4 carbons. Methyl is the most desirable among the alkyl having 1 to 4 carbons. X¹ and X² are each independently a single bond, —O— or —S—. X³ and X⁴ are each independently a single bond, —CH₂—, —CH₂CH₂—, —O—, —S— or —C(R¹¹)(R¹²)—, and desirable X³ and X⁴ are each independently a single bond, —CH₂—, —CH₂CH₂—, —O— or —C(R¹¹)(R¹²)—. Y¹ is alkylene having 1 to 12 carbons, —C(R¹¹)(R¹²)—, —CO— or —SO₂—. A desirable example of Y¹ is alkylene having 1 to 8 carbons, —C(R¹¹)(R¹²)— and —CO—, and a more desirable number of carbon of this alkylene is 1 to 6. R¹¹ and R¹² are each independently alkyl having 1 to 6 carbons or perfluoroalkyl having 1 to 6 carbons, and desirable R¹¹ and R¹² are each independently alkyl having 1 to 3 carbons or perfluoroalkyl having 1 to 3 carbons, and more desirable R¹¹ and R¹² are methyl or trifluoromethyl simultaneously. Further, m1, m2 and n1 are each independently 0 or 1.

A desirable example of the diamine (3) is shown below.

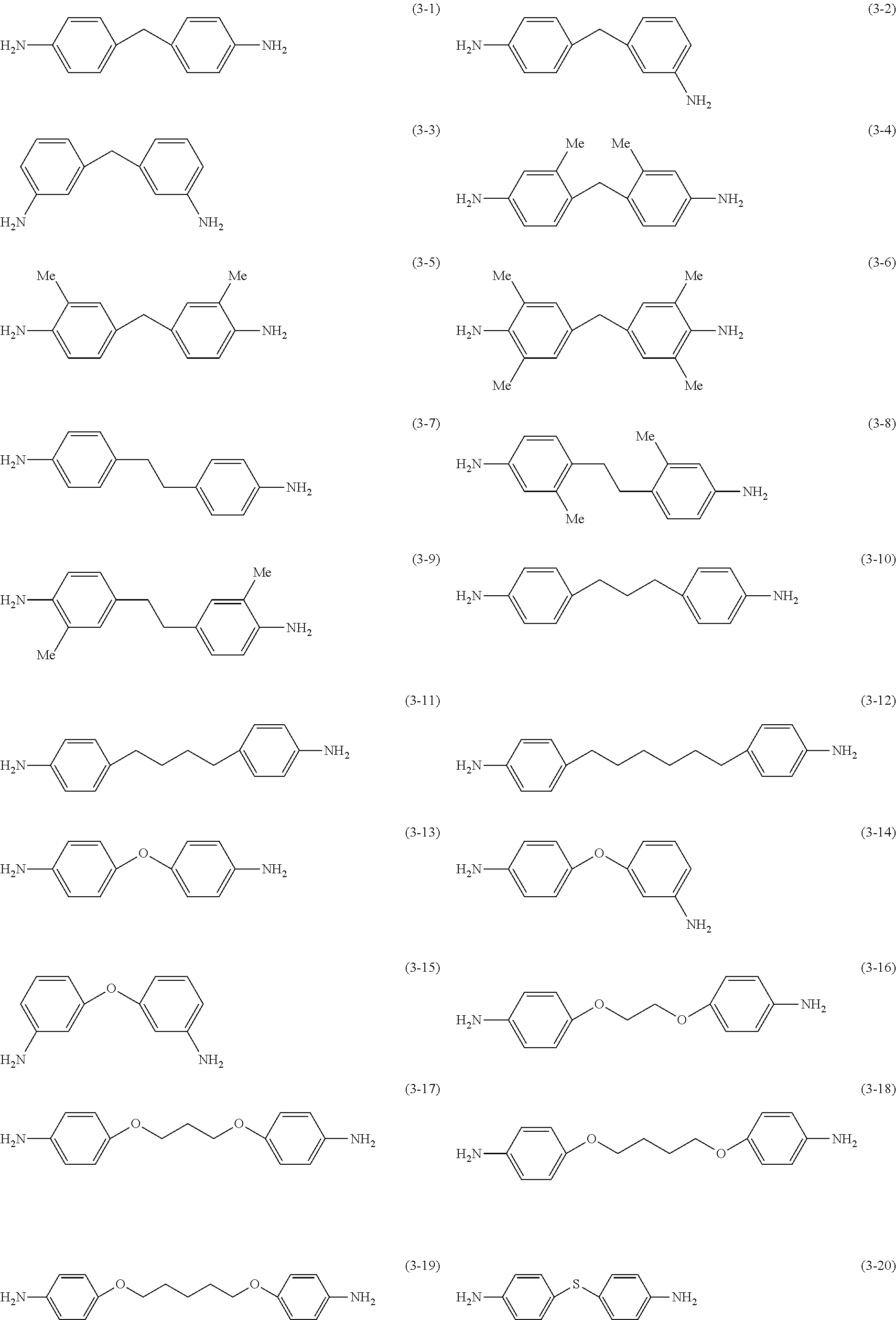

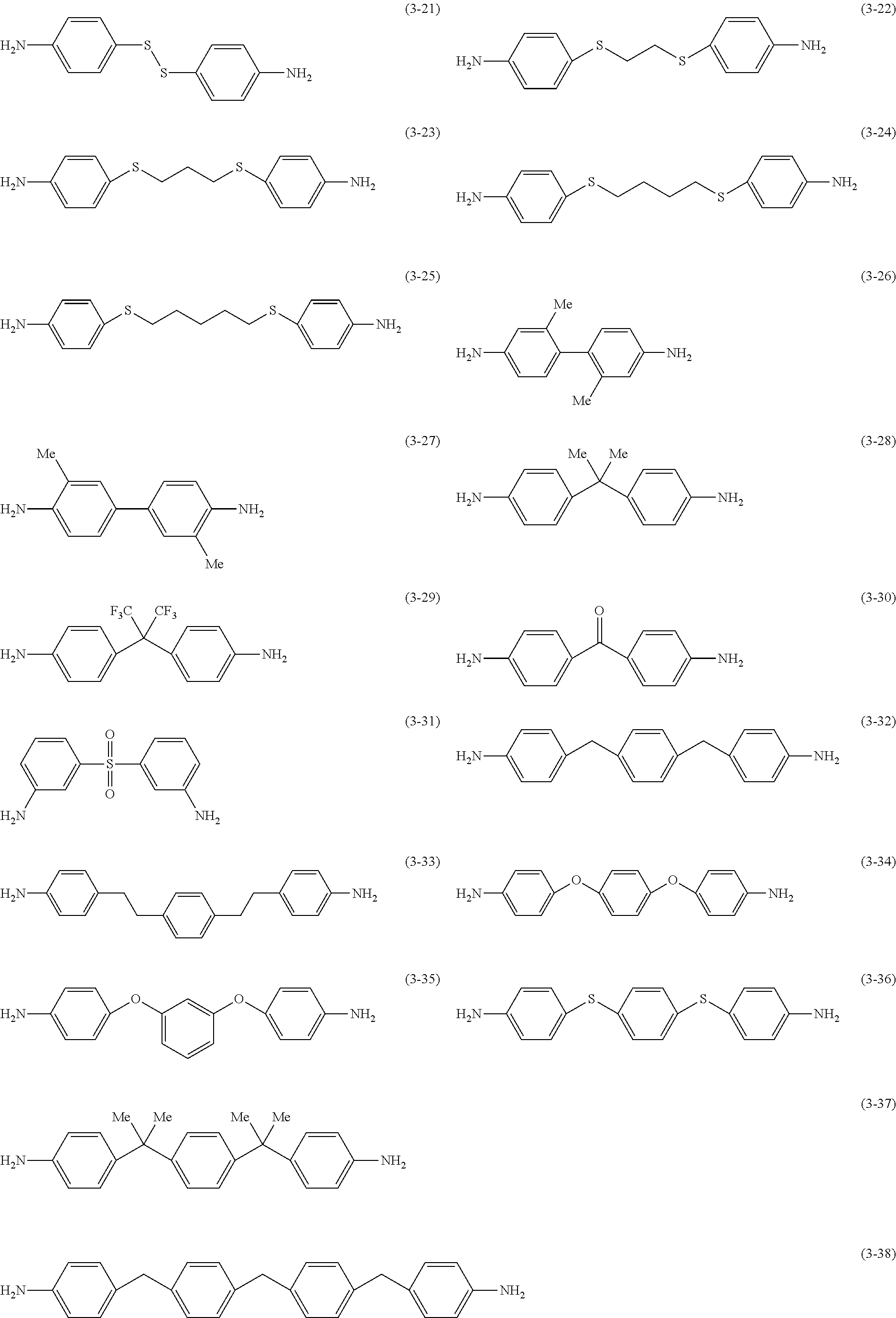

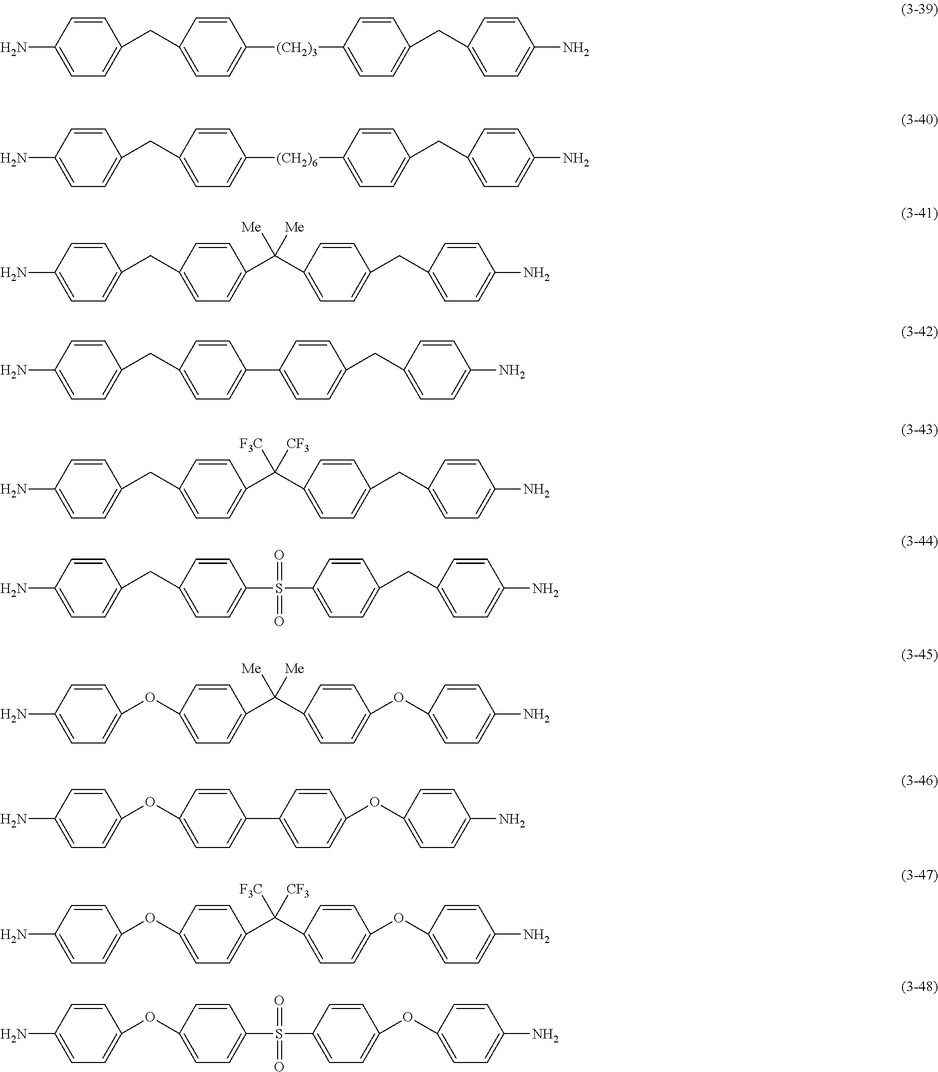

Among these diamines, the diamine (3-1), the diamine (3-3) to the diamine (3-13), the diamine (3-16) to the diamine (3-29), the diamine (3-32) to the diamine (3-34), the diamine (3-36) to the diamine (3-43) and the diamine (3-45) to the diamine (3-47) are desirable in view of the alignment characteristic, and the diamine (3-1), the diamine (3-3) to the diamine (3-13) and the diamine (3-16) to the diamine (3-29) are more desirable.

The ratio of the diamine (3) described above can be arbitrarily determined according to objective alignment characteristics and coloring property. The ratio of this diamine is preferably in the range of approximately 0 mol % to approximately 90 mol %, more preferably in the range of approximately 0 mol % to approximately 80 mol %, and even more preferably in the range of approximately 0 mol % to approximately 75 mol % based on the total amount of the diamine used for the production of the polyamic acid.

In the invention, at least one of siloxane-based diamines may be used as a diamine having no divalent azobenzene group. The siloxane-based diamine may be used together with the diamine (3). A desirable example of this siloxane-based diamine is the diamine (4).

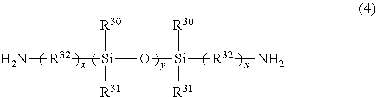

In formula (4), R³⁰ and R³¹ are each independently alkyl having 1 to 3 carbons or phenyl, and R³² is methylene, phenylene or alkyl-substituted phenylene. x is an integer of 1 to 6 and y is an integer of 1 to 10.

A specific example of the diamine (4) includes the compound and the polymer described below:

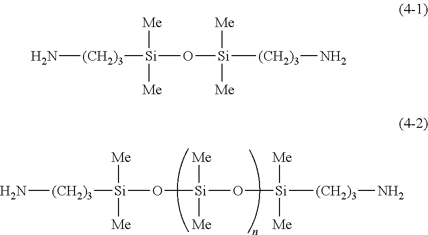

wherein the molecular weight of the diamine (4-2) is in the range of approximately 850 to approximately 3000.

These siloxane-based diamines are used in order to achieve the effect of the invention and to ensure adhesion to a supporting substrate. The ratio of the diamine (3) for such a purpose is preferably in the range of approximately 0.5 mol % to approximately 15 mol %, and more preferably in the range of approximately 1 mol % to approximately 10 mol % based on the total amount of diamines used for producing the polyamic acid.

A diamine that can be used in the invention is not limited to these described above, and other known diamines may be used as far as the purpose of the invention is attained. Moreover, it is also possible to use a monoamine for forming a terminal group in combination with the diamine.

The tetracarboxylic acid dianhydride, which is another raw material for producing the polyamic acid, may be a dianhydride that belongs to an aromatic-based acid anhydride (including heterocyclic aromatic-based acid anhydride) in which four carboxyl groups combine directly with an aromatic ring are transformed to a dianhydride, or any other acid anhydrides.

An example of the tetracarboxylic acid dianhydride includes the following acid anhydride (A-1) to acid anhydride (A-44).

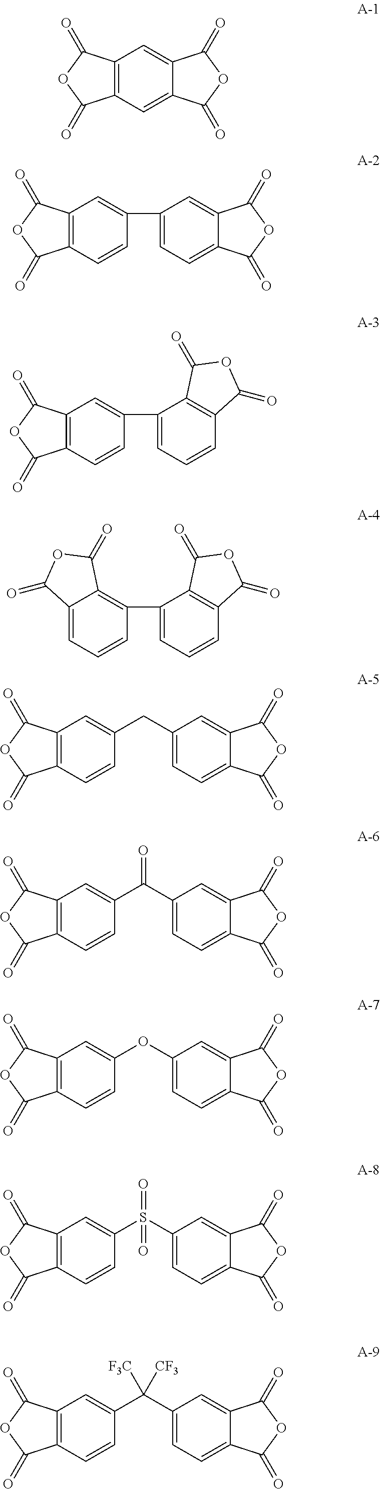

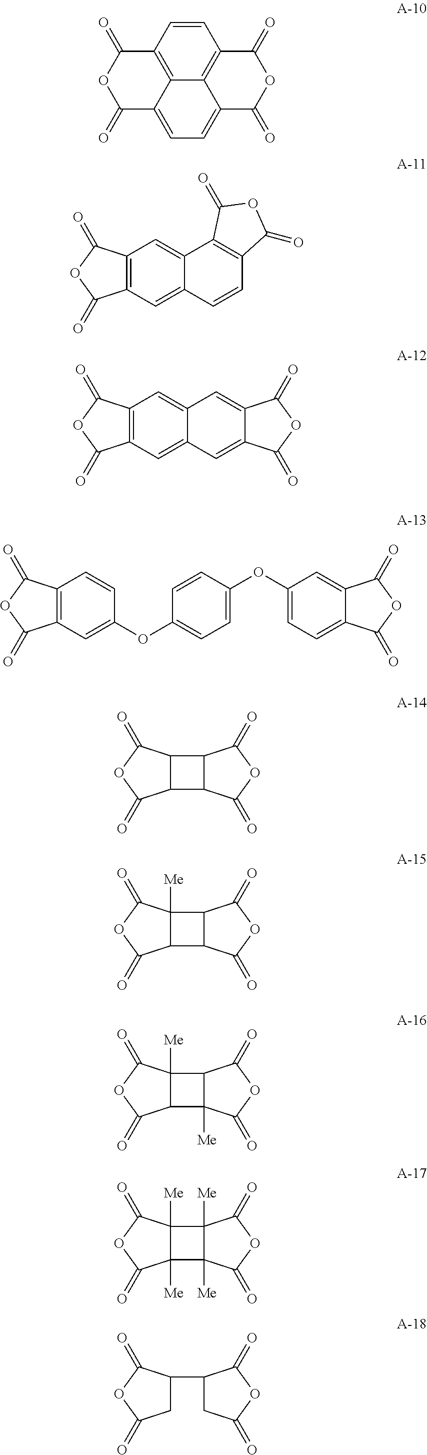

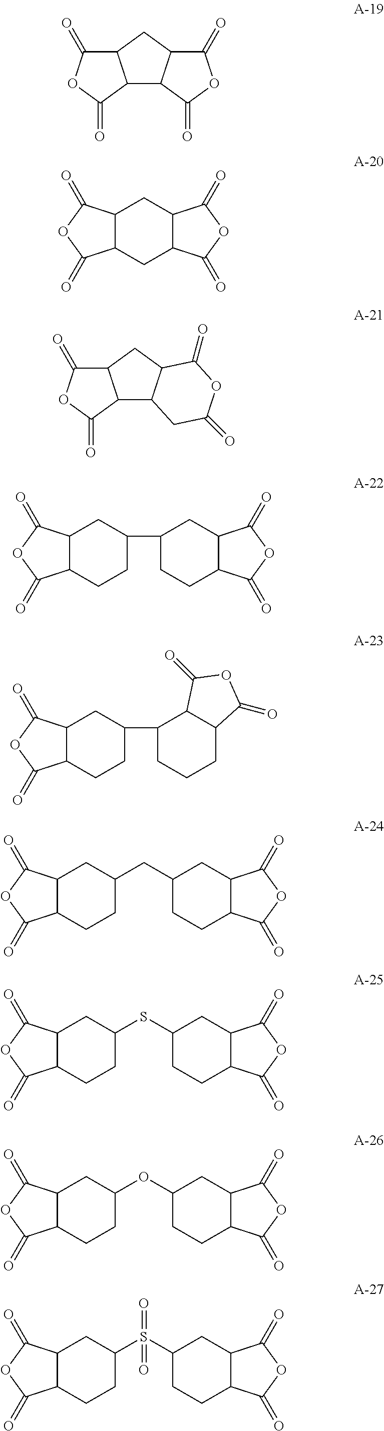

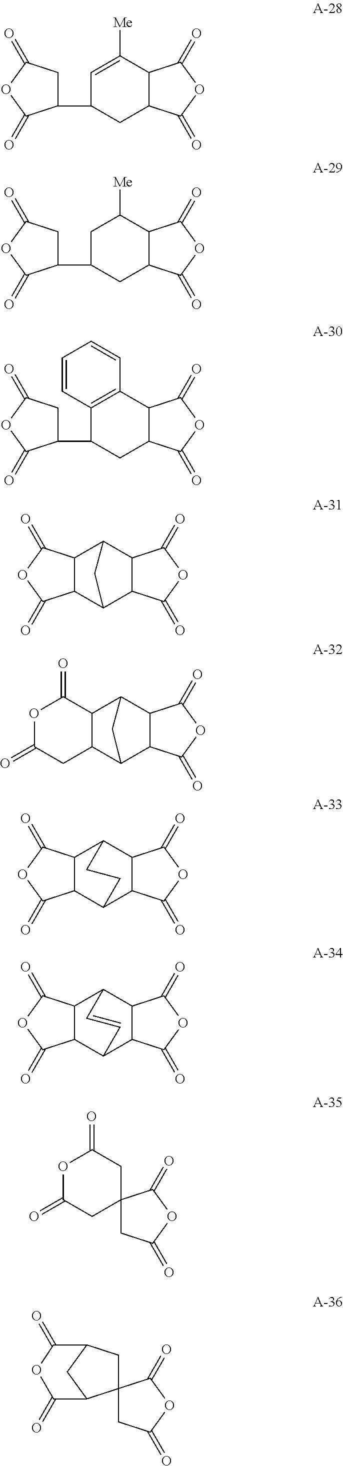

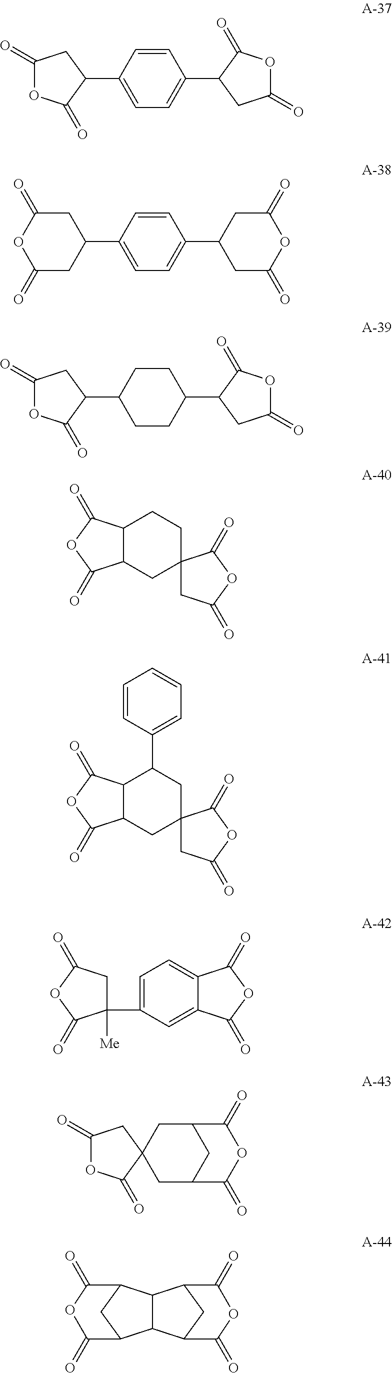

Among these acid anhydrides, the acid anhydride (A-1), the acid anhydride (A-2), the acid anhydride (A-5) to the acid anhydride (A-7), the acid anhydride (A-9), the acid anhydride (A-14) to the acid anhydride (A-22), the acid anhydride (A-24) to the acid anhydride (A-26) and the acid anhydride (A-28) to the acid anhydride (A-44) are desirable in view of improving ability to align liquid crystals of a liquid crystal alignment film.

These acid anhydrides (A-1) to (A-44) can be used solely or in combination of two or more of them. The acid anhydride is not limited to the acid anhydride (A-1) to the acid anhydride (A-44), and other known acid anhydrides may be used as far as the purpose of the invention is attained. Moreover, it is also possible to use a dicarboxylic acid anhydride in combination with the tetracarboxylic acid dianhydride for forming a terminal group.

Although it is desirable that the polymer component included in the polyamic acid varnish used in the invention is composed only of the above polyamic acid having a divalent azobenzene group in the principal chain, other polyamic acids can be used together as far as an adverse effect of the invention is not produced.

The following diamine and tetracarboxylic acid dianhydride are chosen for maintaining the alignment characteristic of the polyamic acid. A desirable diamine is the diamine (3-1), the diamine (3-3) to the diamine (3-13), the diamine (3-16) to the diamine (3-29), the diamine (3-32) to the diamine (3-34), the diamine (3-36) to the diamine (3-43) and the diamine (3-45) to the diamine (3-47), and a more desirable diamine is the diamine (3-1), the diamine (3-3) to the diamine (3-13) and the diamine (3-16) to the diamine (3-29). A desirable tetracarboxylic acid dianhydride is the acid anhydride (A-1), the acid anhydride (A-2), the acid anhydride (A-5) to the acid anhydride (A-7), the acid anhydride (A-9), the acid anhydride (A-14) to the acid anhydride (A-22), the acid anhydride (A-24) to the acid anhydride (A-26) and the acid anhydride (A-28) to the acid anhydride (A-44). Incidentally, the acid anhydride is not limited to the acid anhydride (A-1) to the acid anhydride (A-44), and other known acid anhydrides may be used as far as the purpose of the invention is attained. Moreover, it is also possible to use the dicarboxylic acid anhydride in combination with the tetracarboxylic acid dianhydride for forming a terminal group.

A known silane coupling agent and silicone oil may be added to this polyamic acid varnish in view of adjusting adhesion to a supporting substrate, for example a glass substrate, of a photo-alignment layer. The ratio of this silane coupling agent or the like to the polyamic acid varnish is not limited as far as the effect of the invention is attained. However, a large content ratio may give a poor orientation of the polymerizable liquid crystals when a photo-alignment layer is prepared. Thus, the ratio of the silane coupling agent or the like is preferably in the range of approximately 0.0001 to approximately 0.05 by weight, and more preferably in the range of approximately 0.001 to approximately 0.03 at the weight ratio based on the total amount of the polymer component included in the polyamic acid varnish.

This polyamic acid varnish may further include a compound, what is called a cross linking agent, having two or more functional groups that react with the carboxylic acid moiety of the polyamic acid, in view of preventing time-dependent deterioration of characteristics or deterioration due to environment. An example of such a cross linking agent includes polyfunctional epoxy materials and isocyanate materials which are described in JP 3,049,699 B (2000), JP 2005-275360 A (2005), JP H10-212484 (1998) A or the like.

A cross linking agent which itself reacts to give a polymer having network structure and improves the strength of the polyamic acid film can also be used for a purpose similar to that described above. An example of such a cross linking agent includes poly-functional vinyl ethers, maleimides and bisallylnadimide derivatives, which are described in JP H10-310608 A (1998), JP 2004-341030 A (2004), or the like. A desirable ratio of the cross linking agent is in the range of approximately 0 to approximately 0.30, and a more desirable ratio is in the range of approximately 0 to approximately 0.15 at the weight ratio based on the total amount of the polymer component.

This polyamic acid varnish includes a solvent. A desirable example of the solvent includes a solvent that is usually used in the production and the use of a polyamic acid. An example of an aprotic polar organic solvent having an excellent solubility for the polyamic acid includes N-methyl-2-pyrrolidone (NMP), dimethylimidazolidinone, N-methylcaprolactam, N-methylpropionamide, N,N-dimethylacetamide, dimethyl sulfoxide, N,N-dimethylformamide (DMF), N,N-diethylformamide, N,N-diethylacetamide (DMAc) and γ-butyrolactone (GBL).

An example of the solvent other than solvents described above, for the purpose of improving coating properties or something includes alkyl lactates, 3-methyl-3-methoxybutanol, tetralin, isophorone, ethylene glycol monoalkyl ethers such as ethylene glycol monobutyl ether (BCS), diethylene glycol monoalkyl ethers such as diethylene glycol monoethyl ether, ethylene glycol monoalkyl acetate, ethylene glycol phenyl acetate, triethylene glycol monoalkyl ethers, propylene glycol monoalkyl ethers such as propylene glycol monobutyl ether, dialkyl malonates such as diethyl malonate, dipropylene glycol monoalkyl ethers such as dipropylene glycol monomethyl ether and ester compounds of these glycol monoethers or the like. In the invention, NMP, dimethylimidazolidinone, GBL, BCS, diethylene glycol monoethyl ether, propylene glycol monobutyl ether and dipropylene glycol monomethyl ether can be most preferably used among these.

The concentration of the polyamic acid in polyamic acid varnish is preferably in the range of approximately 0.1% to approximately 40% by weight. When this polyamic acid varnish is applied to a substrate, dilution of the polyamic acid with a solvent may sometimes be necessary in advance for adjusting the thickness of the layer. In this case, the concentration of solid components in the polyamic acid varnish is not limited, and an optimum value may be chosen according to various application methods described below. Usually, the concentration of this solid component is preferably in the range of approximately 0.1% to approximately 30% by weight, and more preferably in the range of approximately 1% to approximately 10% by weight based on the total weight of the varnish, for suppressing unevenness, pinholes or the like at the time of application.

The photo-alignment layer in the invention which is formed by applying the above-mentioned polyamic acid varnish to a supporting substrate gains anisotropy by irradiation of a layer with light. In this case, it is desirable to produce the photo-alignment layer in the following steps (1) to (3) in view of a complete alignment. The step (4) may be added if needed.

(1) The polyamic acid varnish described above is applied to a supporting substrate by a method such as brush application, dip coating, a spinner method, a spray method and a printing method.
(2) The solvent is evaporated by heating a layer formed on the supporting substrate at a temperature range of approximately 50° C. to approximately 120° C., and preferably at a temperature range of approximately 80° C. to approximately 100° C.
(3) The polyamic acid is subjected to alignment treatment by irradiating the layer with polarized ultraviolet light for photo-isomerization of azobenzene groups in the layer.
(4) The photo-alignment layer is heated at a temperature range of approximately 80° C. to approximately 140° C., only when a complete removal of the solvent, realignment of the polyamic acid or the like is necessary .

When it is desired to generate a predetermined pretilt angle in the optically anisotropic substance prepared by using this photo-alignment layer, a method of irradiation of the layer with linearly polarized light at an arbitrary angle to a supporting substrate or a method for combining irradiation with linearly-polarized light at the direction perpendicular to a substrate and irradiation with unpolarized light at an arbitrary angle may be employed.

Linearly polarized light is used for the alignment of the polyamic acid in the production of this photo-alignment layer. The principal chain of the polyamic acid is oriented in the direction perpendicular to the polarization direction of linearly polarized light by irradiation with the linearly polarized light. The linearly polarized light is not limited if the light is capable of aligning the polyamic acid in the layer. This alignment layer is aligned by low energy light irradiation. Then, the amount of the linearly polarized light irradiation in the photo-alignment treatment of the polyamic acid is preferably in the range of approximately 0.5 J/cm² to approximately 10 J/cm². The wavelength of the linearly polarized light is preferably in the range of approximately 300 nm to approximately 400 nm. The irradiation angle of the linearly polarized light to the layer surface is not limited, and it is desirable that the light is as perpendicular as possible to the layer surface in view of reducing the time for alignment treatment, when a strong driving force to align liquid crystal molecules is desired.

Light for irradiating the layer to generate a pretilt angle may be polarized light or unpolarized light in the production of this photo-alignment layer. The amount of light for irradiating the layer to generate a pretilt angle is preferably in the range of approximately 0.5 J/cm² to approximately 10 J/cm², and the wavelength is preferably in the range of approximately 300 nm to approximately 400 nm. The angle of light for irradiating the layer to the layer surface is not limited when it is desired to generate a pretilt angle, and it is preferably in the range of approximately 30 degrees to approximately 60 degrees in view of reducing the time for alignment treatment.

This photo-alignment layer is characterized by an especially large alignment anisotropy. The magnitude of such anisotropy can be evaluated by a method using polarized infrared light, which is described in JP 2005-275364 A or the like, and also by means of ellipsometry, as shown in the following Examples.

The polymerizable liquid crystal composition used in the invention includes a polymerizable liquid crystal compound, solvent, and a polymerization initiator as essential components, and includes a compound selected from the group of a polymerizable compound that is not liquid crystalline, a chain-transfer agent, a surfactant and a silane coupling agent as an arbitrary component. This polymerizable liquid crystal composition may further include other additives. A desirable example of the polymerizable liquid crystal compound is at least one compound selected from the group of the compound (M1), the compound (M2-1), the compound (M2-2), the compound (M2-3), the compound (M3) and the compound (M4).

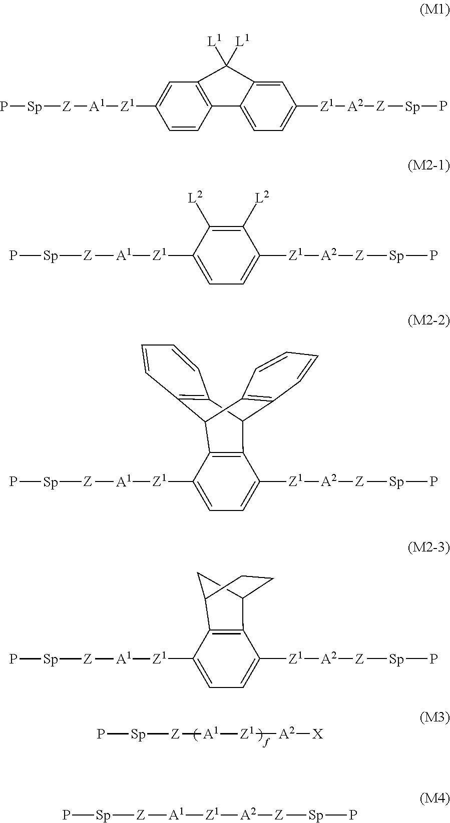

The meaning of symbols in formula (M1), formula (M2-1), formula (M2-2), formula (M2-3), formula (M3) and formula (M4) is as follows. In the following description, formula (M) may be used as a generic term of formula (M1), formula (M2-1), formula (M2-2), formula (M2-3), formula (M3) and formula (M4). Thus, the compound (M) is a generic term of the compound (M1), the compound (M2-1), the compound (M2-2), the compound (M2-3), the compound (M3) and the compound (M4).

Sp is a single bond or alkylene having 1 to 20 carbons. A desirable number of carbon of this alkylene is 1 to 12. When the number of carbon is two or more in this alkylene, one or two nonadjacent —CH₂— may be replaced by —O—.

Z is independently a single bond, —O—, —COO—, —OCO— or —O—COO—. A¹ and A² are each independently 1,4-cyclohexylene or 1,4-phenylene, and in these rings, one or two nonadjacent —CH₂— may be replaced by —O—, arbitrary —CH═ may be replaced by —N═, arbitrary hydrogen may be replaced by fluorine, —C≡N, alkyl having 1 to 5 carbons or halogenated alkyl having 1 to 5 carbons. A desirable example of A¹ is 1,4-cyclohexylene having no substituent and 1,4-phenylene in which arbitrary hydrogen may be replaced by fluorine. A desirable example of A² is the same.

Z¹ is independently a single bond or alkylene having 1 to 10 carbons, and in this alkylene, arbitrary —CH₂— may be replaced by —O—, —CO—, —COO—, —OCO—, —CH═CH— or —C≡C—, and arbitrary hydrogen may be replaced by halogen.

L¹ is independently hydrogen, fluorine or methyl, and L² is independently hydrogen, fluorine, methyl or trifluoromethyl.

f is an integer of 0 to 3. When f is 2 or 3, a plurality of A¹ of formula (M3) may be the same groups or may be consisting of at least two different groups, and a plurality of Z¹ of formula (M3) may also be the same groups or may be consisting of at least two different groups.

X is hydrogen, halogen, —C≡N, alkyl having 1 to 20 carbons or alkoxy having 1 to 20 carbons, and arbitrary hydrogen of the alkyl and alkoxy may be replaced by halogen.

P is any one of groups represented by formula (2-1) to formula (2-6):

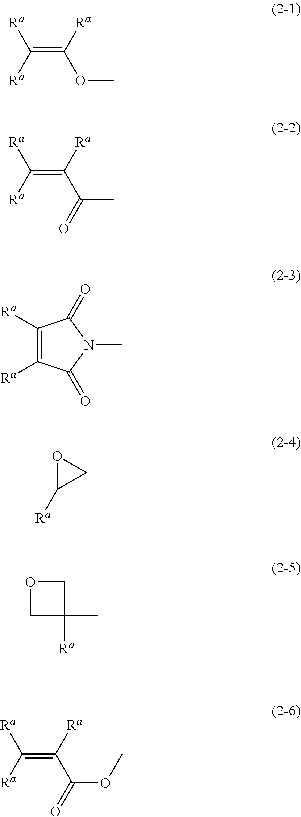

wherein R^{a} is independently hydrogen, halogen or alkyl having 1 to 5 carbons, and arbitrary hydrogen in this alkyl may be replaced by halogen.

The compound (M) has a liquid crystal phase over a wide temperature range, and can form a three-dimensional network structure because it has two polymerizable groups in its structure. Thus, the formation of a polymer which has high mechanical strength is possible. In particular, the compound (M2-2) increases the internal free volume because it has a triptycence ring in its structure, and the birefringence is decreased when the compound (M2-2) is used together with the compound (M1), the compound (M2-1), the compound (M3) and the compound (M4). The compound (M2-3) has also the same characteristics as the compound (M2-2). The compound (M3) is monofunctional, and the adjustment of orientation in a liquid crystal state can be accomplished, because a substituent such as a polar group can be introduced at the opposite side of the polymerizable group in the major axis direction of the molecules. Thus, a composition having a high refractive index anisotropy (Δn) can be prepared when A¹ is 1,4-phenylene, and a composition having a low refractive index anisotropy can be prepared when A¹ is 1,4-cyclohexylene, by use of any of the compounds (M).

A desirable example of the compound (M1) is as follows.

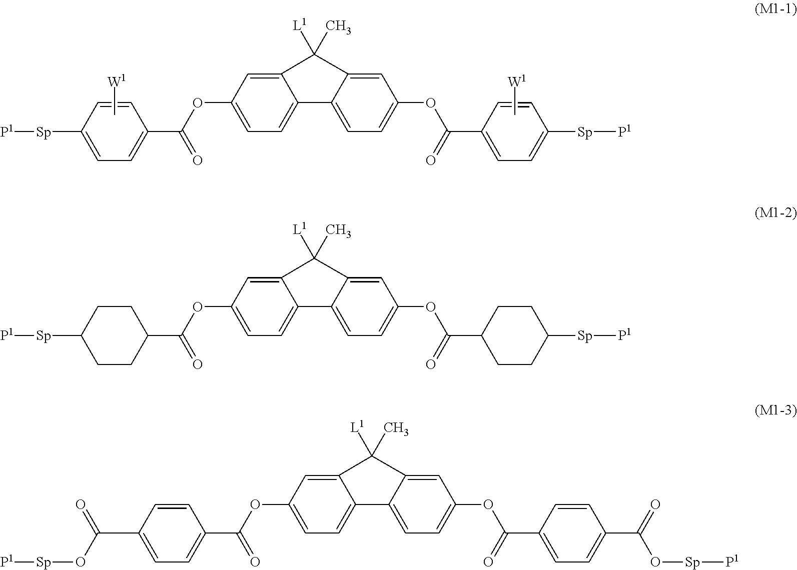

In the above formula (M1-1) to formula (M1-3), Sp is alkylene having 2 to 12 carbons, and one or two nonadjacent —CH₂— in this alkylene may be replaced by —O—, W¹ is hydrogen or fluorine, L¹ is hydrogen or methyl, and P¹ is a group represented by formula (2-4-1), formula (2-5-2) or formula (2-6-1).

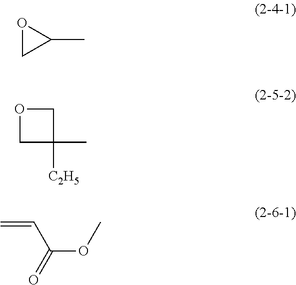

A specific example of the compound (M1-1) is as follows. In the following specific examples, n and m are each independently an integer of 2 to 12.

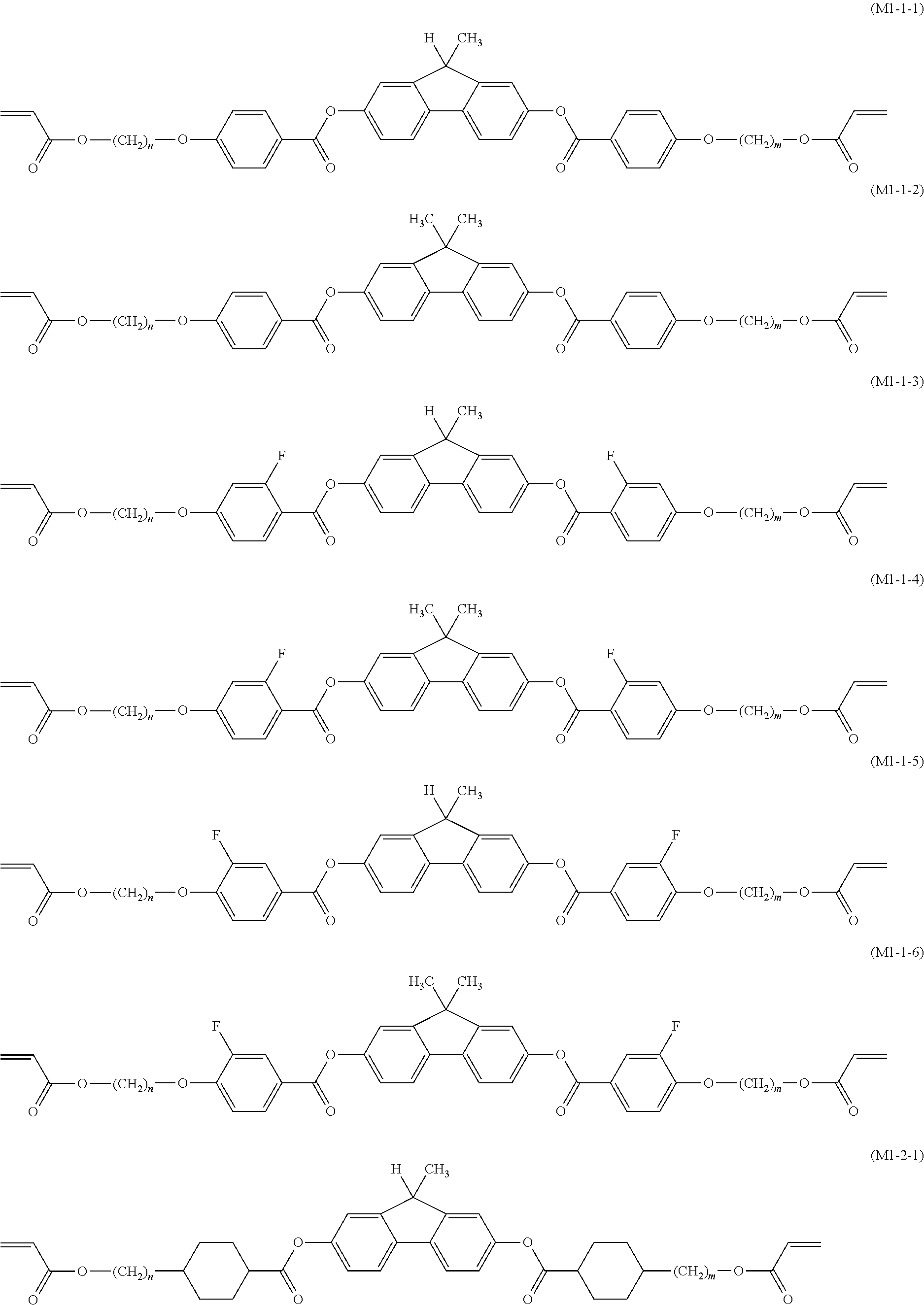

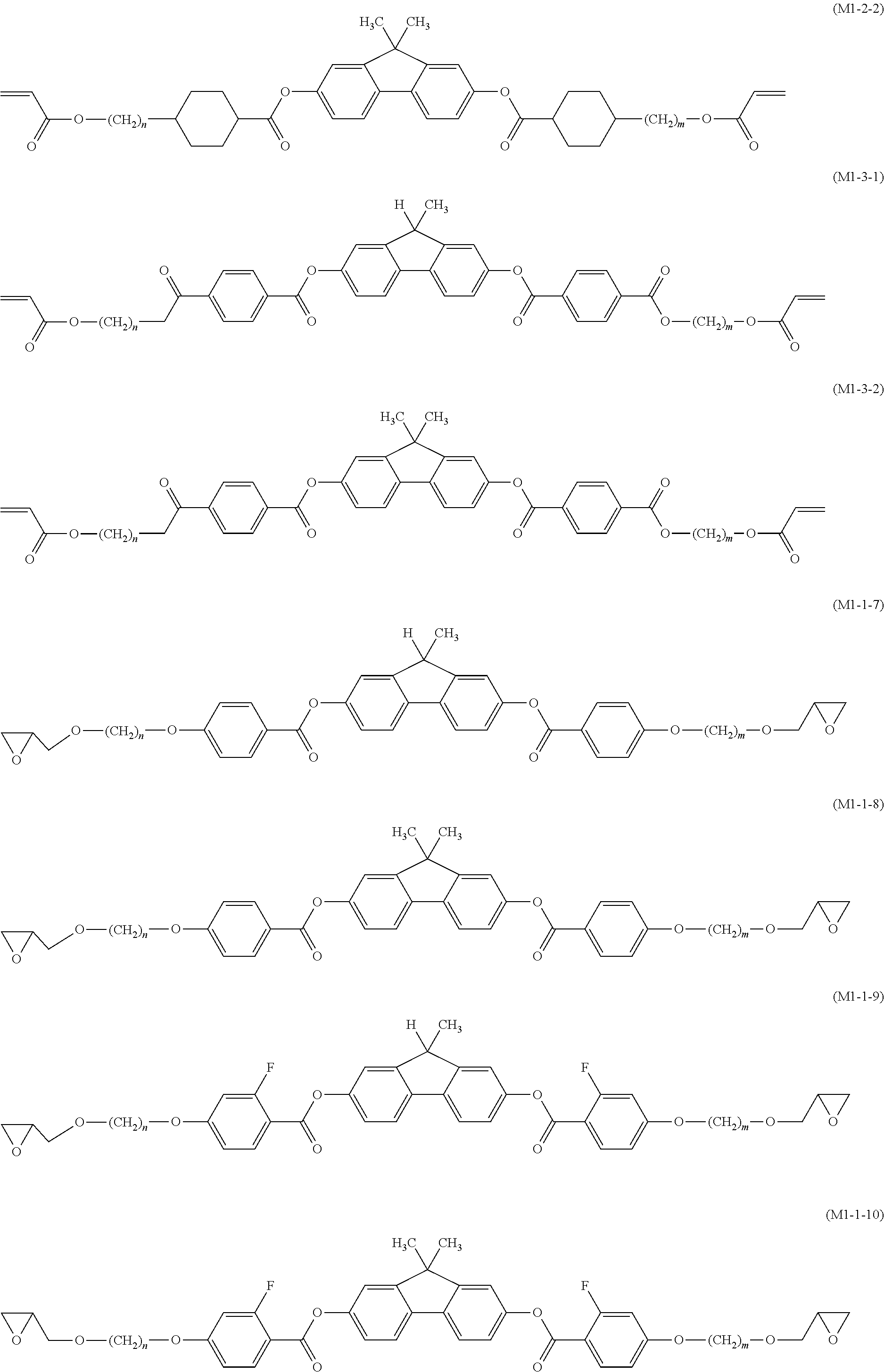

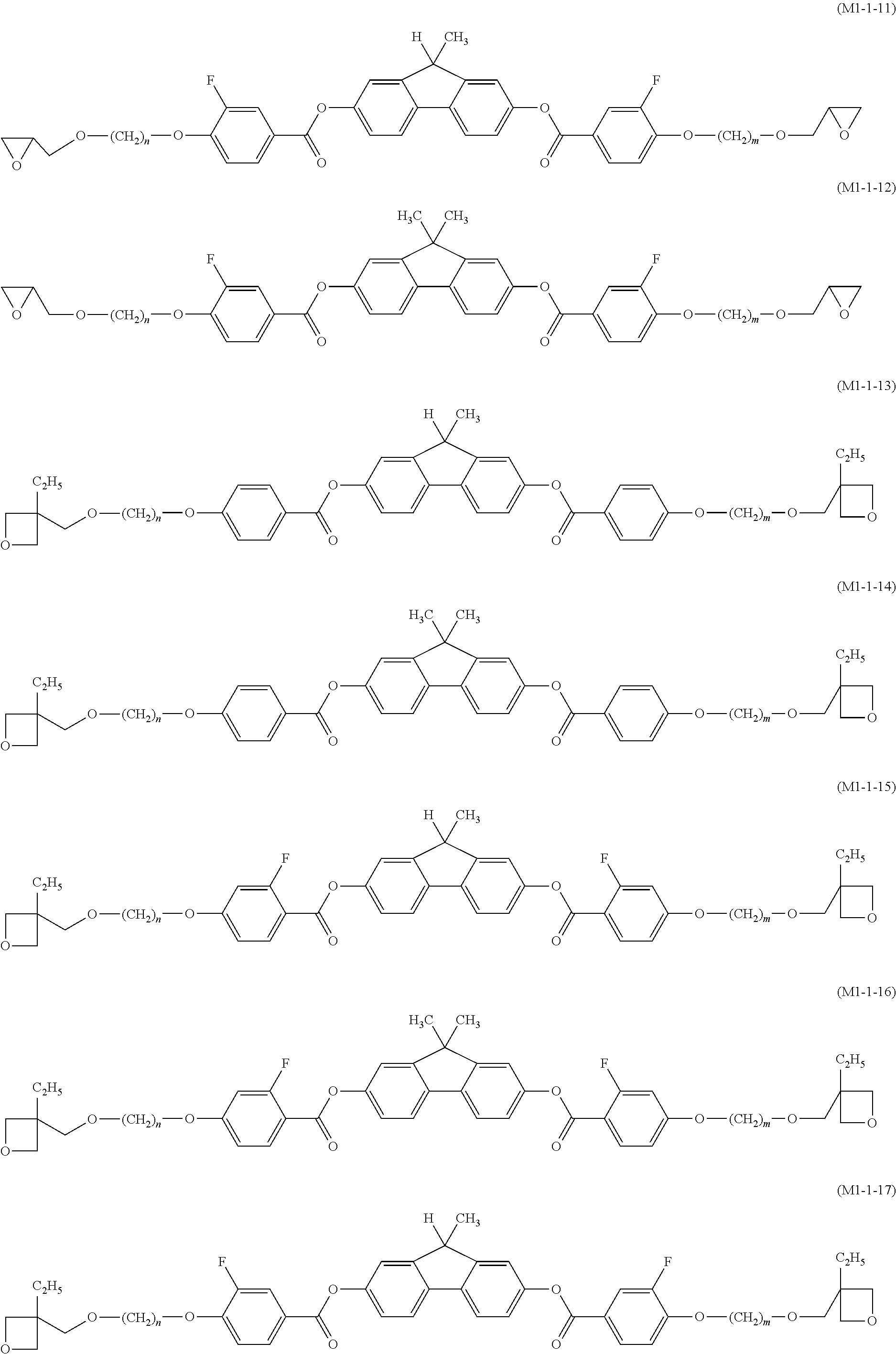

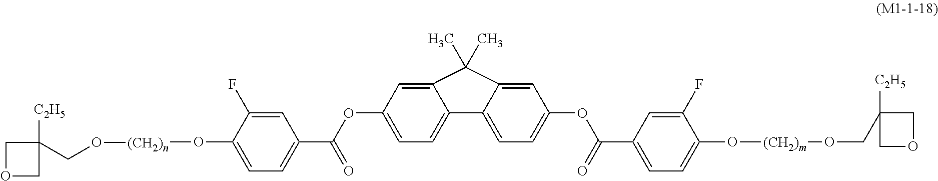

A desirable example of the compound (M2-1) is as follows.

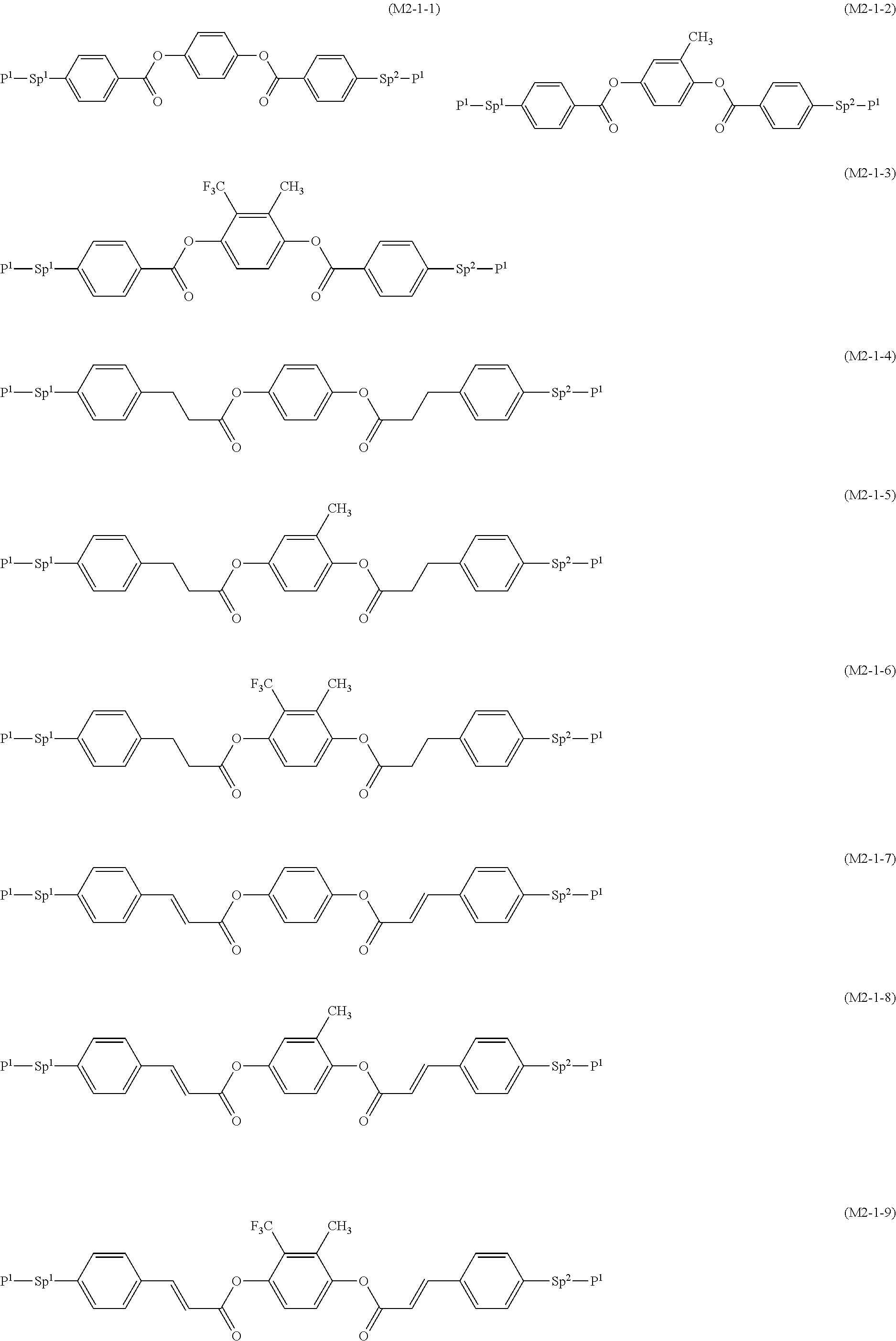

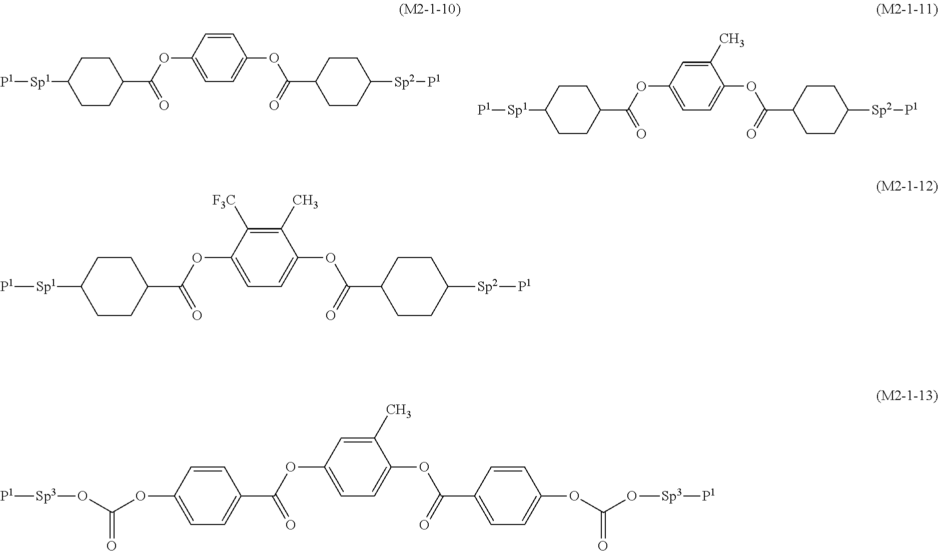

In the above formula (M2-1-1) to formula (M2-1-13), Sp¹ is alkylene having 2 to 12 carbons or alkyleneoxy having 2 to 12 carbons, Sp² is alkylene having 2 to 12 carbons or oxyalkylene having 2 to 12 carbons, Sp^{a} is alkylene having 2 to 12 carbons, W¹ is hydrogen or fluorine, L¹ is hydrogen or methyl, and P¹ is a group represented by the formula (2-6-1) described above.

Specific examples of the compound (M2-1-1) to the compound (M2-1-13) are as follows. In the following specific examples, n and m are each independently an integer of 2 to 12.

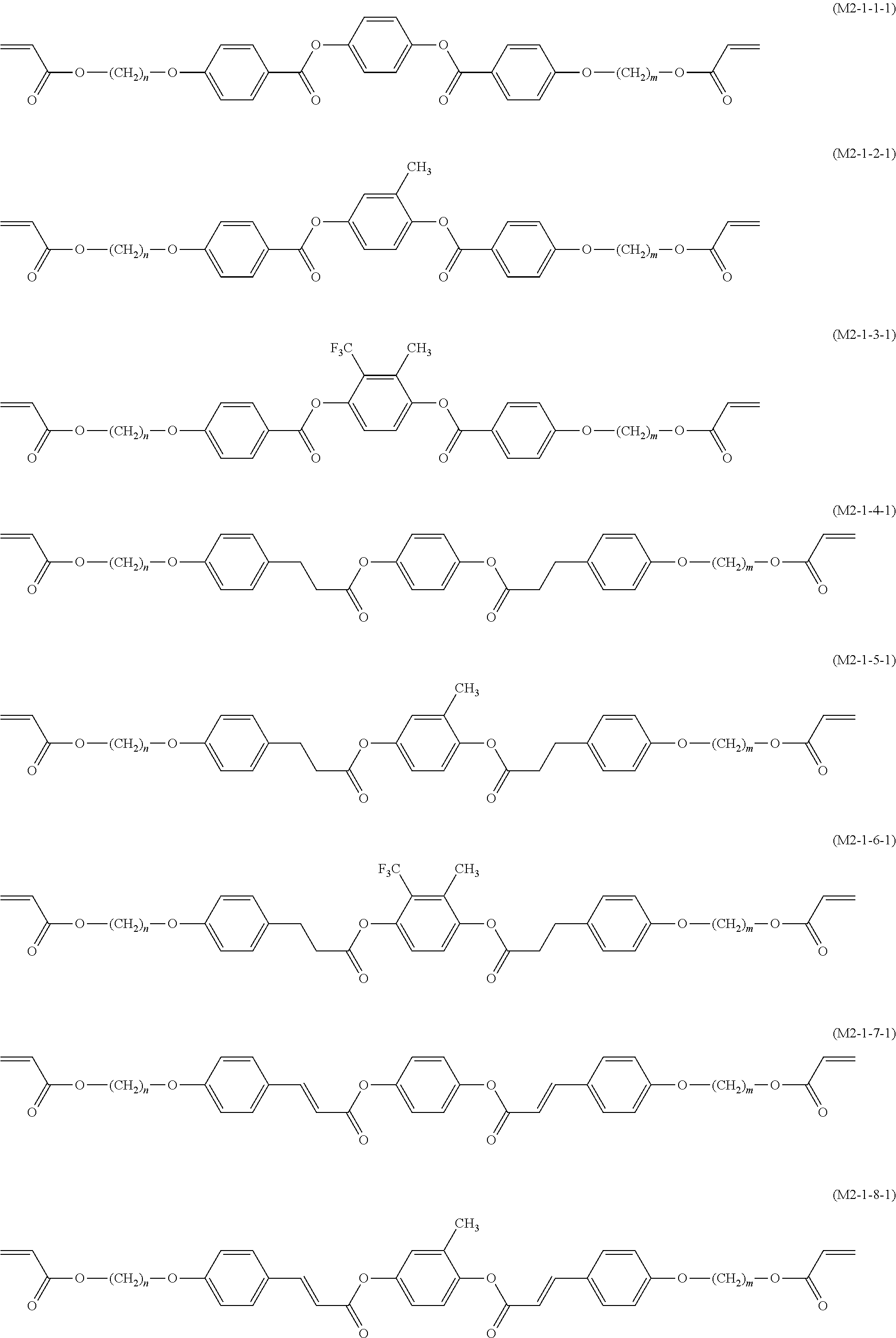

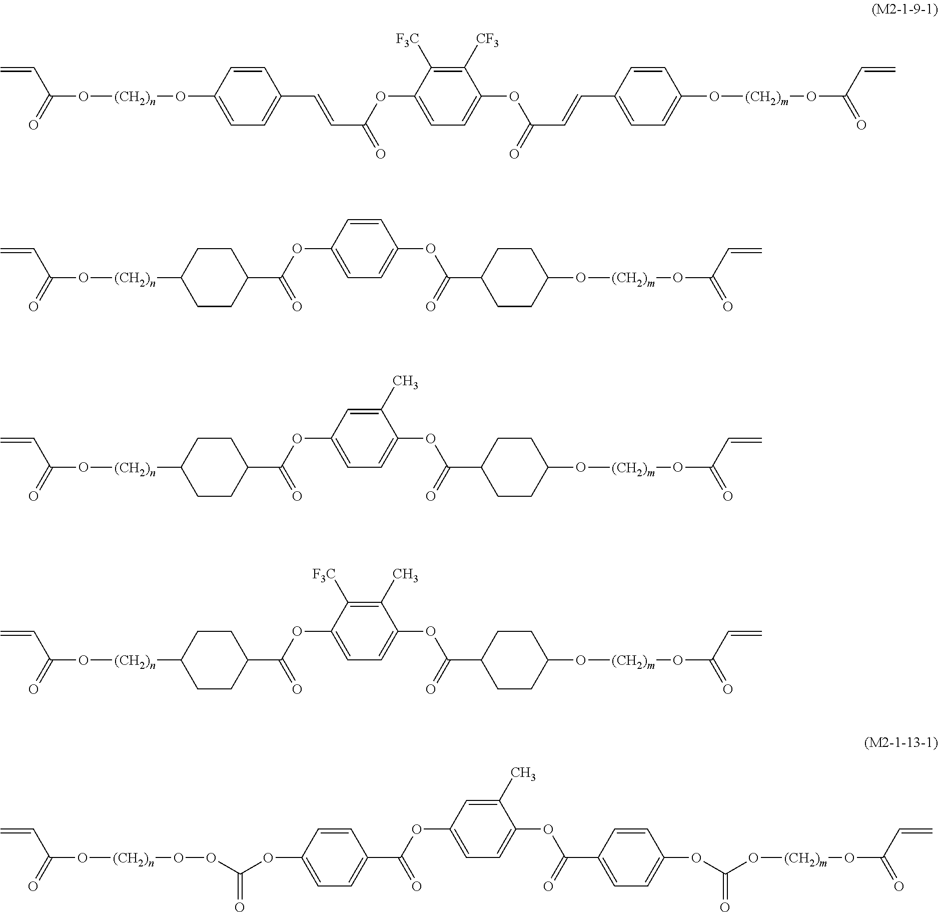

A desirable example of the compound (M2-2) is as follows.

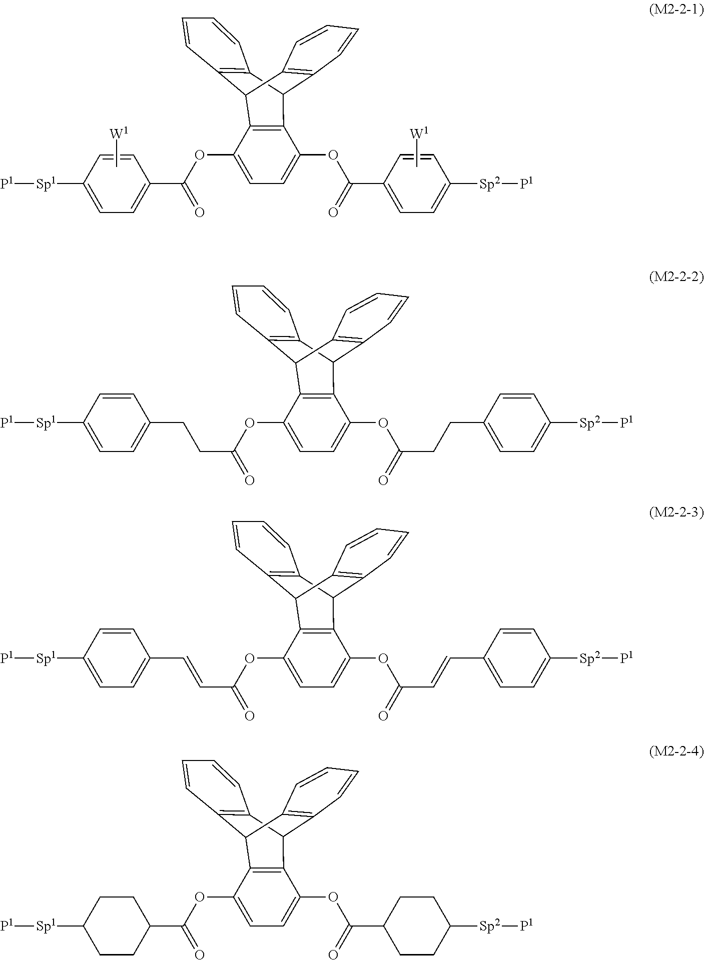

In these formulas, Sp¹ is alkylene having 2 to 12 carbons or alkyleneoxy having 2 to 12 carbons, Sp² is alkylene having 2 to 12 carbons or oxyalkylene having 2 to 12 carbons, W¹ is hydrogen or fluorine, and P¹ is a group represented by the formula (2-6-1) described above.

Specific examples of the compound (M2-2-1) to the compound (M2-2-4) are as follows. In the following specific examples, n and m are each independently an integer of 2 to 12.

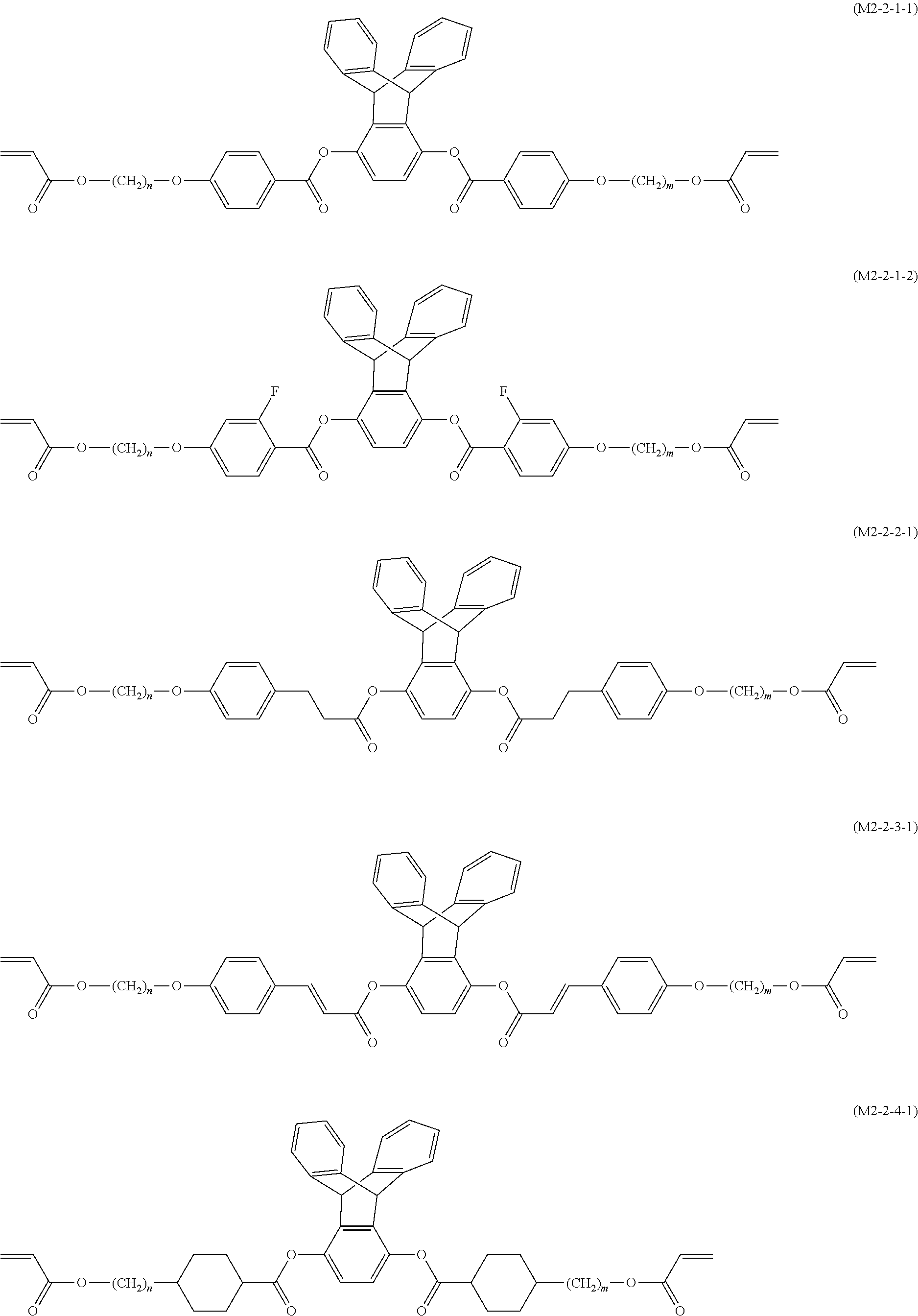

A desirable example of the compound (M2-3) is as follows.

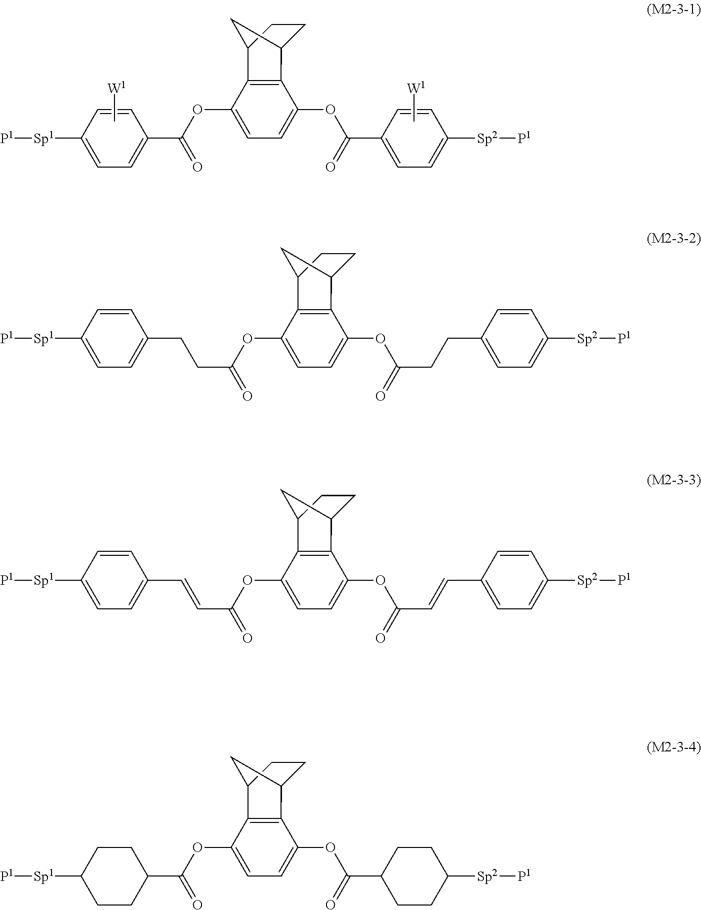

In these formulas, Sp¹ is alkylene having 2 to 12 carbons or alkyleneoxy having 2 to 12 carbons, Sp² is alkylene having 2 to 12 carbons or oxyalkylene having 2 to 12 carbons, W¹ is hydrogen or fluorine, and P¹ is a group represented by the formula (2-6-1) described above.

Specific examples of the compound (M2-3-1) to the compound (M2-3-4) are as follows. In the following specific examples, n and m are each independently an integer of 2 to 12.

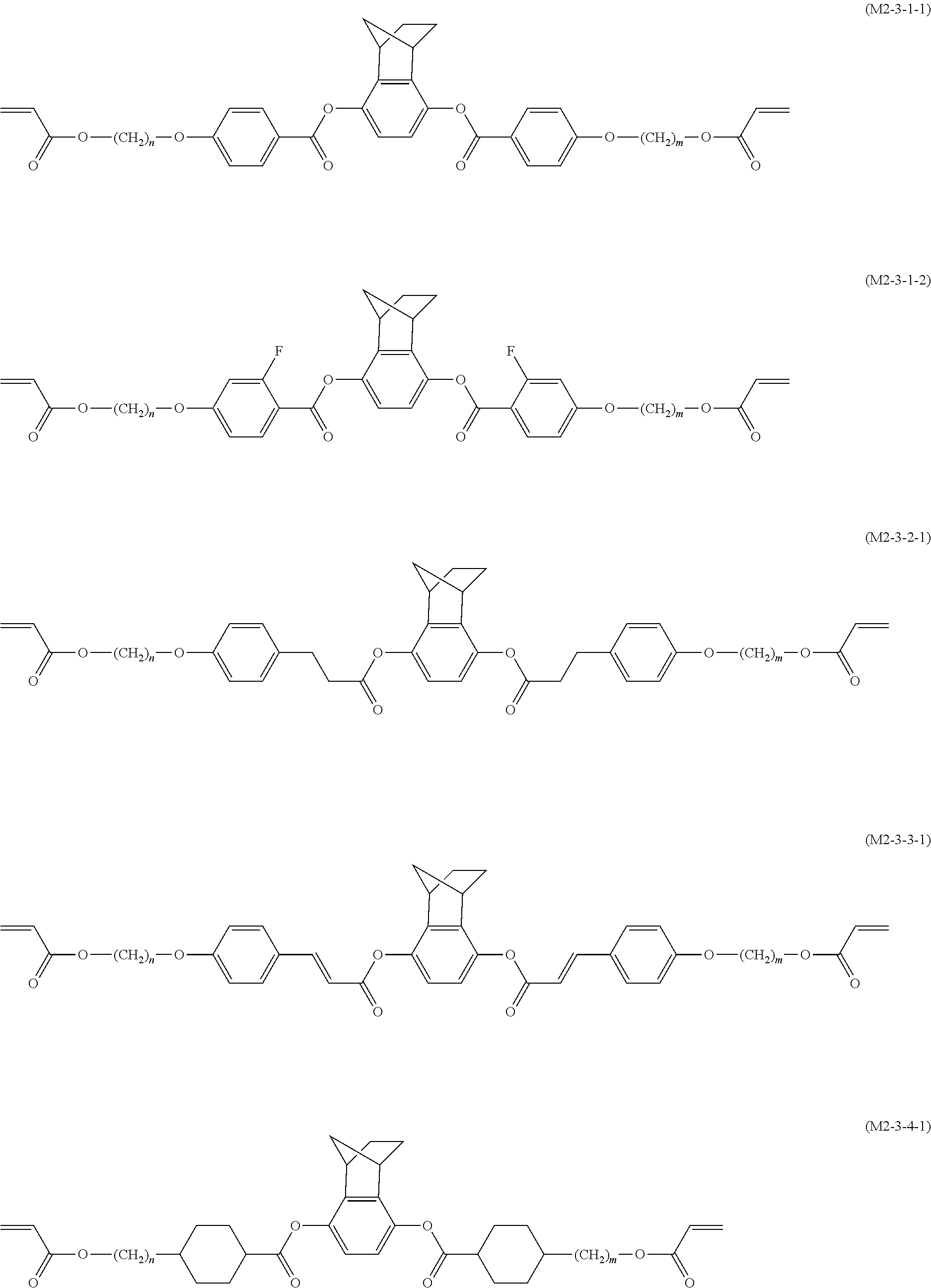

A desirable example of the compound (M3) is as follows.

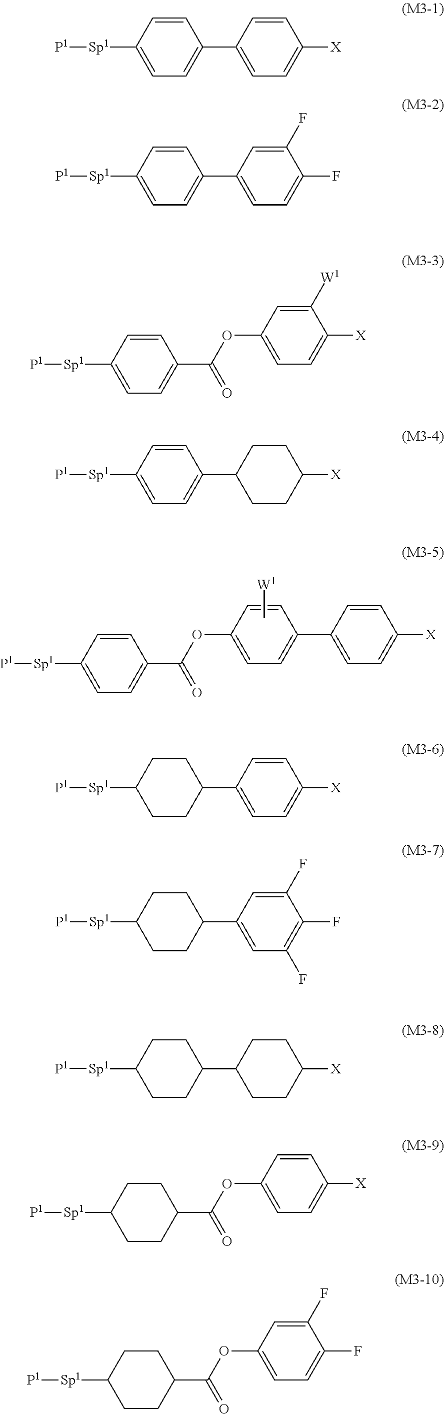

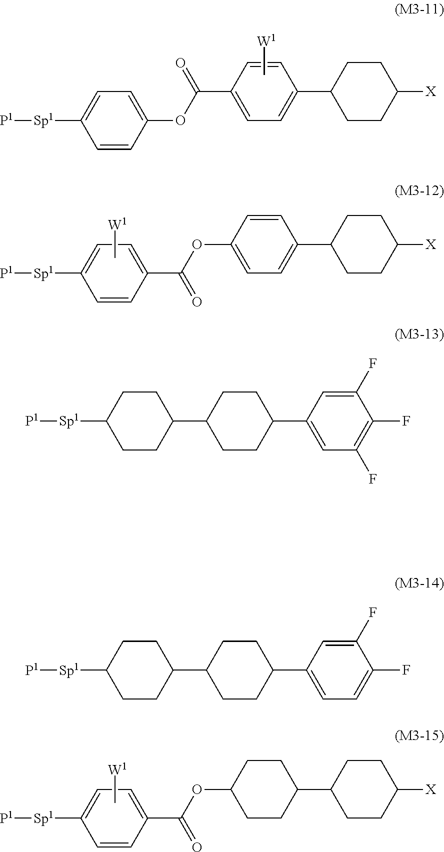

In these formulas, X is hydrogen, halogen, —C≡N, alkyl having 1 to 20 carbons or alkoxy having 1 to 20 carbons, and arbitrary hydrogen in these alkyl and alkoxy may be replaced by halogen; W¹ is hydrogen or fluorine; P¹ is a group represented by formula (2-6-1); and Sp¹ is alkylene having 2 to 12 carbons or alkyleneoxy having 2 to 12 carbons; with proviso that P¹ in formula (M3-3) may be a group represented by formula (2-5-2), where Sp¹ is alkylene having 2 to 12 carbons, and one or two nonadjacent —CH₂— in this alkylene may be replaced by —O—.

In the compound (M3-1) to the compound (M3-15), a specific example in the case where P¹ is a group represented by formula (2-6-1) is as follows. In the following specific examples, n is independently an integer of 2 to 12.

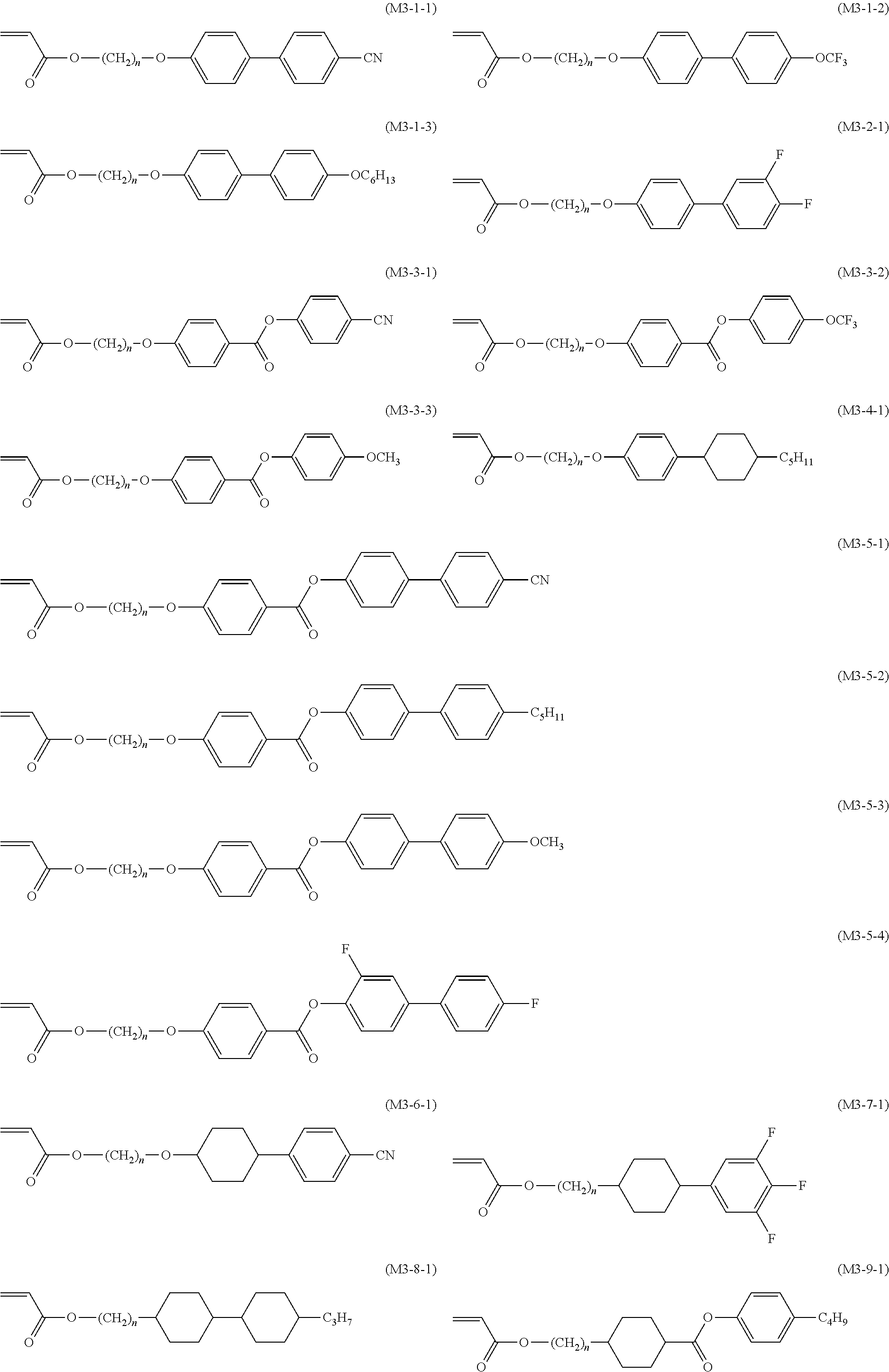

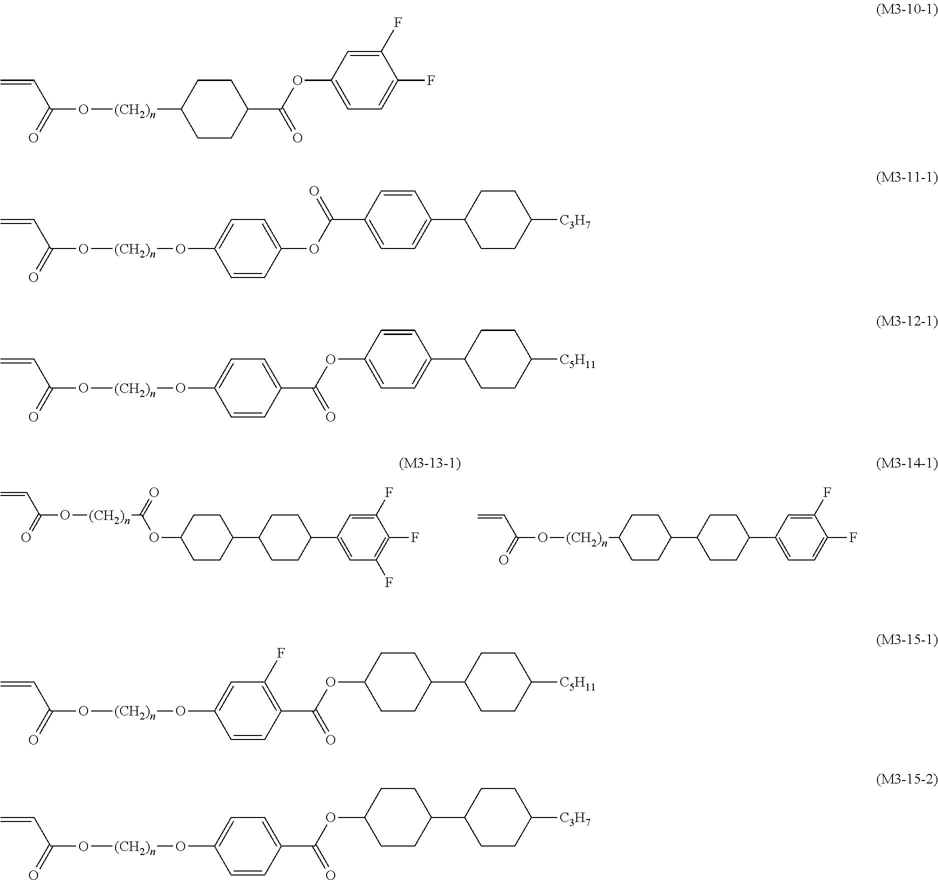

In the compound (M3-3), a specific example in the case where P¹ is represented by formula (2-5-2) is as follows. In the following specific examples, n is independently an integer of 2 to 12.

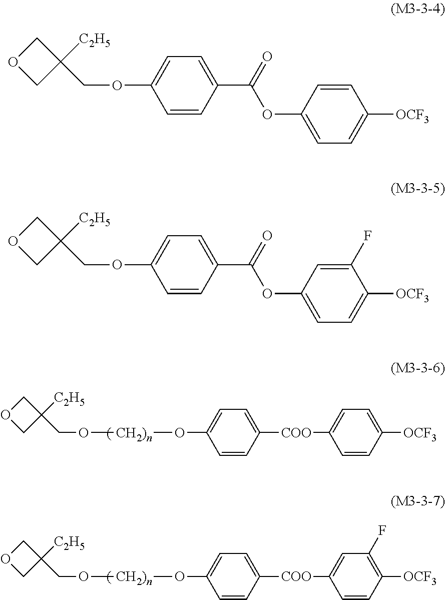

A desirable example of the compound (M4) is as follows.

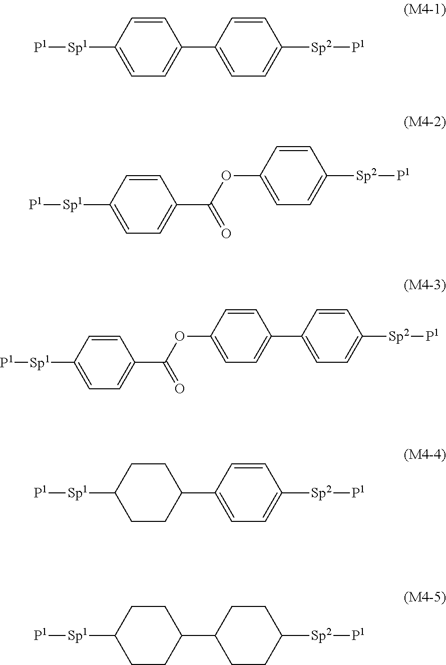

In these formulas, P¹ is a group represented by formula (2-6-1); Sp¹ is alkylene having 2 to 12 carbons or alkyleneoxy having 2 to 12 carbons; and Sp² is alkylene having 2 to 12 carbons or oxyalkylene having 2 to 12 carbons; with proviso that P¹ in formula (M4-2) may be a group represented by formula (2-4-1), where Sp¹ is alkylene having 2 to 12 carbons or alkyleneoxy having 2 to 12 carbons, and Sp² is alkylene having 2 to 12 carbons or oxyalkylene having 2 to 12 carbons.

In the compound (M4-1) to the compound (M4-5), a specific example in the case where P¹ is a group represented by formula (2-6-1) is as follows. In the following specific examples, n and m are each independently an integer of 2 to 12.

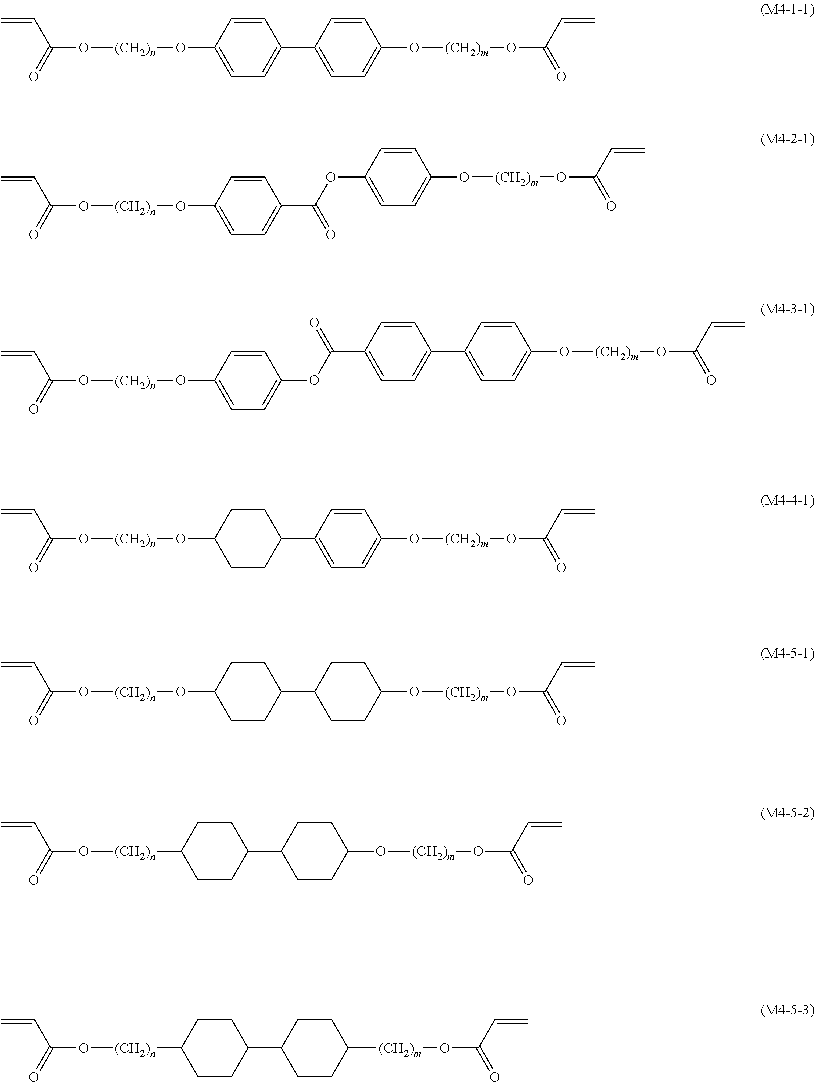

In the compound (M4-2), a specific example in the case where P¹ is a group represented by formula (2-4-1) is as follows. In the following specific examples, n and m are each independently an integer of 2 to 12.

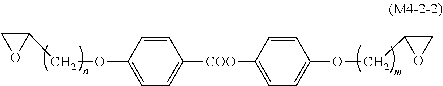

The compound (M) can be synthesized by combining techniques in synthetic organic chemistry. Methods for introducing objective terminal groups, rings and bonding groups into starting materials are described in the books of Houben-Wyle, METHODS OF ORGANIC CHEMISTRY (Georg Thieme Verlag, Stuttgart), ORGANIC SYNTHESES (John Wiley & Sons, Inc), ORGANIC REACTIONS (John Wiley & Sons, Inc), COMPREHENSIVE ORGANIC SYNTHESIS (Pergamon Press), NEW EXPERIMENTAL CHEMISTRY COURSE (Shin Jikken Kagaku Kouza, in Japanese title) (Maruzen Co., LTD.), and so forth. Specific methods for the synthesis of the compound (M) are described in the following references:

the compounds (M1-1-1) to (M1-1-6): JP 2003-238491 A and JP 2006-307150 A;

the compounds (M1-3-1) to (M1-3-2): WO 2008/136265 A;

the compounds (M1-1-7) to (M1-1-12) and the compounds (M1-1-13) to (M1-1-18): JP 2005-60373 A;

the compounds (M2-1-1-1) and (M2-1-2-1): Makromol. Chem.; 190, 3201-3215 (1998);

the compounds (M2-1-3-1) and (M2-1-9-1): JP 2004-231638 A;

the compound (M2-1-13-1): WO 97/00600 A;

the compound (M2-2-1-1): JP 2006-117564 A;

the compounds (M3-3-4) to (M3-3-7): JP 2005-320317 A;

the compound (M3-14-1): JP 2005-179557 A;

the compound (M3-15-1): synthesized by combining a method described in JP 2006-307150 A and a method described in WO 97/34862 A;

the compound (M3-15-2): WO 97/34862 A;

the compound (M4-2-2): Macromolecules, 26, 1244-1247 (1993); and

the compounds (M5-A3-11-1) to (M5-A3-11-3), the compound (M5-A3-12-1) and the compounds (M5-A3-16-1) to (M5-A3-16-3): JP 2007-16213 A and JP 2008-133344 A.

One of more desirable examples of the polymerizable liquid crystal composition including the compound (M) described above is a composition including at least one compound selected from the group of the compound (M1-A), the compound (M1-B), the compound (M3-A), the compound (M3-B) and the compound (M4-A):

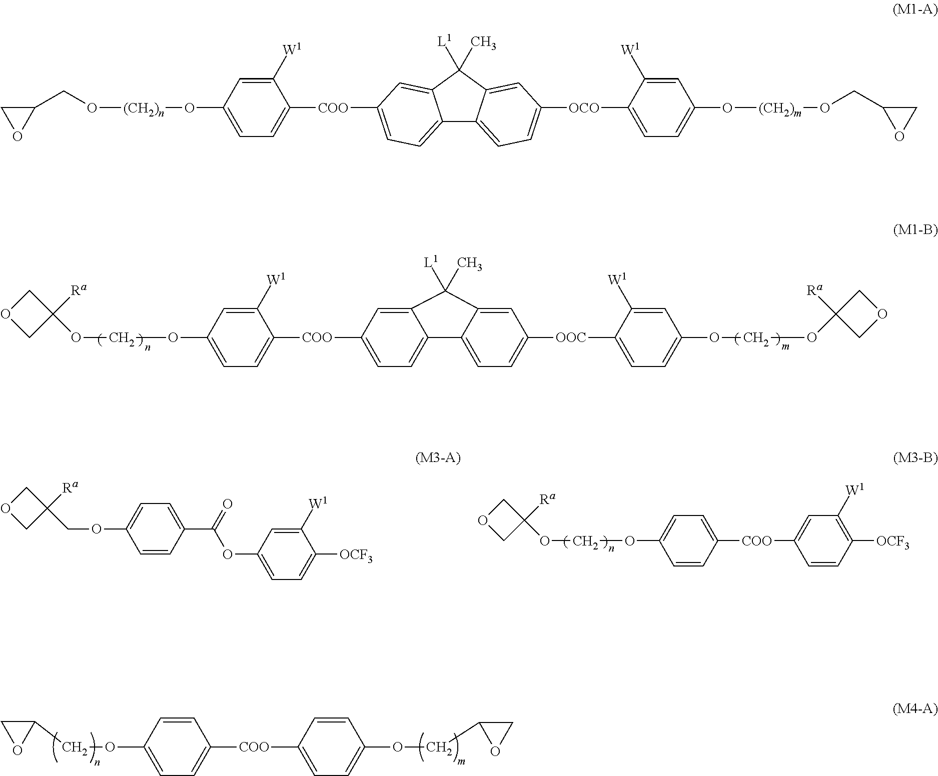

wherein L¹ is hydrogen or methyl; W¹ is hydrogen or fluorine; R^{a} is hydrogen, methyl or ethyl; and n and m are each independently an integer of 2 to 10.

Desirable ratios of the above-mentioned compounds in the composition are in the range of

approximately 0% to approximately 40% by weight for the compound (M1-A);

approximately 0% to approximately 30% by weight for the compound (M1-B);

approximately 0% to approximately 25% by weight for the compound (M3-A) and the compound (M3-B);

approximately 5% to approximately 95% by weight for the compound (M1-A), the compound (M1-B), the compound (M3-A) and the compound (M3-B); and

approximately 5% to approximately 95% by weight for the compound (M4-A),

based on the total amount of the compound (M1-A), the compound (M1-B), the compound (M3-A), the compound (M3-B) and the compound (M4-A).

More desirable ranges of the ratios described above are in the range of

approximately 0% to approximately 30% by weight for the compound (M1-A);

approximately 0% to approximately 20% by weight for the compound (M1-B);

approximately 0% to approximately 20% by weight for the compound (M3-A) and the compound (M3-B);

approximately 5% to approximately 70% by weight for the compound (M1-A), the compound (M1-B), the compound (M3-A) and the compound (M3-B); and

approximately 30% to approximately 95% by weight for the compound (M4-A),

based on the total amount of the compound (M1-A), the compound (M1-B), the compound (M3-A), the compound (M3-B) and the compound (M4-A).

A specific example of the compound (M1-A) is the compound (M1-1-7) to the compound (M1-1-12) described above. A specific example of the compound (M1-B) is the compound (M1-1-13) to the compound (M1-1-18) described above. A specific example of the compound (M3-A) is the compound (M3-3-4) and the compound (M3-3-5) described above. A specific example of the compound (M3-B) is the compound (M3-3-6) and compound (M3-3-7) described above. A specific example of the compound (M4-A) is the compound (M4-2-2) described above.

Another more desirable example of the polymerizable liquid crystal composition including the compound (M) is a composition including at least one compound selected from the group of the compound (M1-C), the compound (M1-D), the compound (M2-1-A), the compound (M2-1-B), the compound (M2-2-A), the compound (M2-3-A), the compound (M3-C), the compound (M3-D) and the compound (M3-E), each of which has a polymerizable group represented by formula (2-6-1):

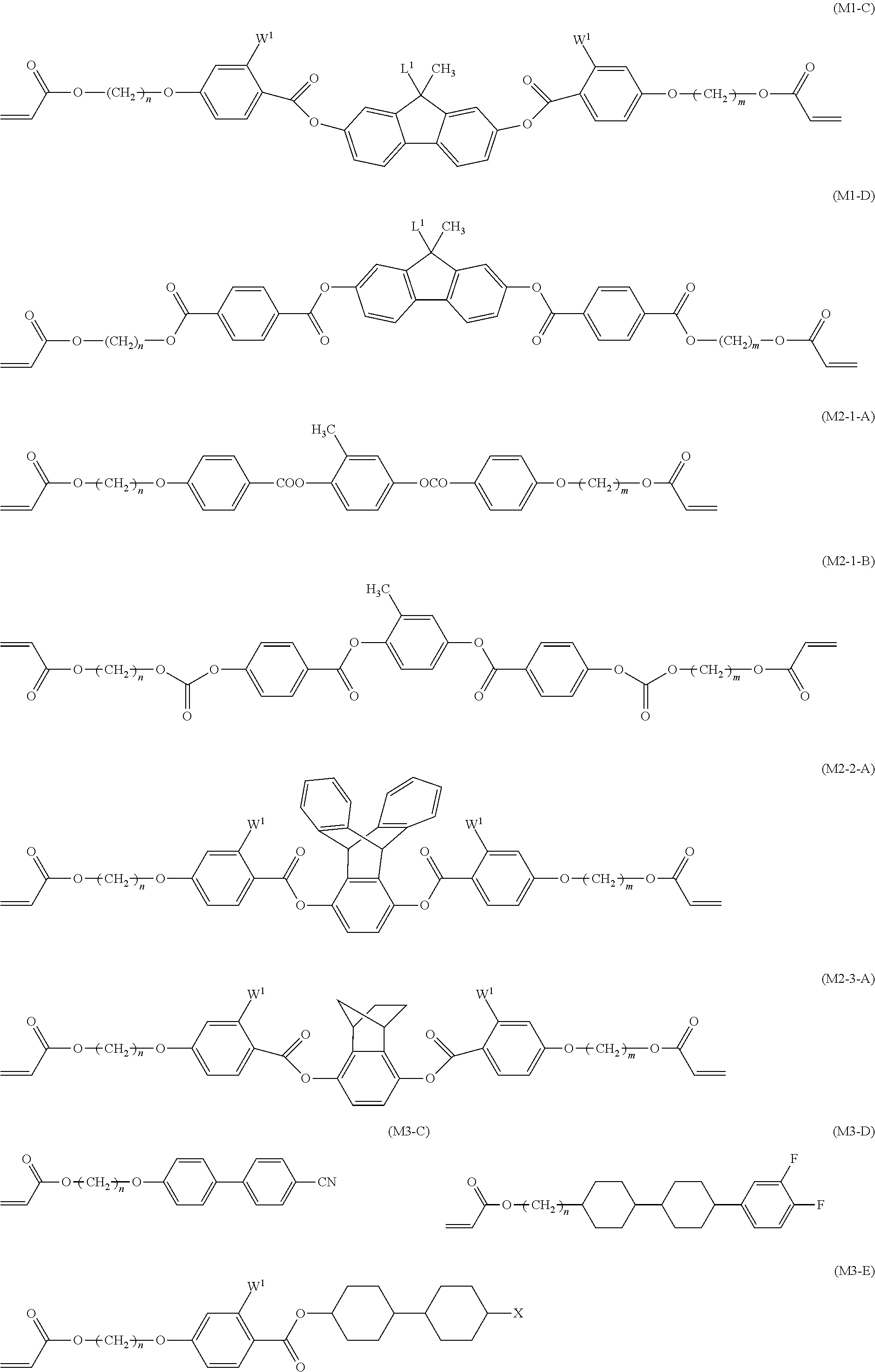

wherein L¹ is hydrogen or methyl; W¹ is hydrogen or fluorine; X is alkyl having 1 to 20 carbons; and n and m are each independently an integer of 2 to 12.

The desirable ratio of the above-mentioned compounds in this composition is in the range of

approximately 0% to approximately 85% by weight for the compound (M1-C);

approximately 0% to approximately 50% by weight for the compound (M1-D);

approximately 0% to approximately 70% by weight for the compound (M2-1-A);

approximately % to approximately 70% by weight for the compound (M2-1-B);

approximately 0% to approximately 70% by weight for the compound (M2-2-A);

approximately 0% to approximately 70% by weight for the compound (M2-3-A);

approximately 0% to approximately 45% by weight for the compound (M3-C);

approximately 0% to approximately 30% by weight for the compound (M3-D);

approximately 3% to approximately 97% by weight for the compound (M2-2-A), the compound (M2-3-A) the compound (M3-C), the compound (M3-D) and the compound (M3-E); and

approximately 3% to approximately 97% by weight for the compound (M1-C), the compound (M1-D), the compound (M2-1-A) and the compound (M2-1-B),

based on the total amount of the compound (M1-C), the compound (M1-D), the compound (M2-1-A), the compound (M2-1-B), the compound (M2-2-A), the compound (M2-3-A), the compound (M3-C), the compound (M3-D) and the compound (M3-E).

The compound (M5) may further be added to a composition including the compound having the polymerizable group represented by formula (2-6-1) described above. The ratio of the compound (M5) is in the range of approximately 0 to approximately 0.20 at the weight ratio based on the total amount of the compound (M1-D), the compound (M2-1-A), the compound (M2-1-B), the compound (M2-2-A), the compound (M2-3-A), the compound (M3-C), the compound (M3-D) and the compound (M3-E).

A specific example of the compound (M1-C) is the compound (M1-1-1) to the compound (M1-1-4) described above. A specific example of the compound (M1-D) is the compound (M1-3-1) and the compound (M1-3-2) described above. Specific examples of the compound (M2-1-A) and the compound (M2-1-B) are the compound (M2-1-2-1) and the compound (M2-1-13-1) described above, respectively. A specific example of the compound (M2-2-A) is the compound (M2-2-1-1) and the compound (M2-2-1-2) described above. A specific example of the compound (M2-3-A) is the compound (M2-3-1-1) and the compound (M2-3-1-2) described above. The compound (M3-C) is identical with the compound (M3-1-1) described above. The compound (M3-D) is identical with the compound (M3-14-1) described above. A specific example of the compound (M3-E) is the compound (M3-15-1-1) and the compound (M3-15-1-2) described above.

A specific example of the compound (M5) is as follows:

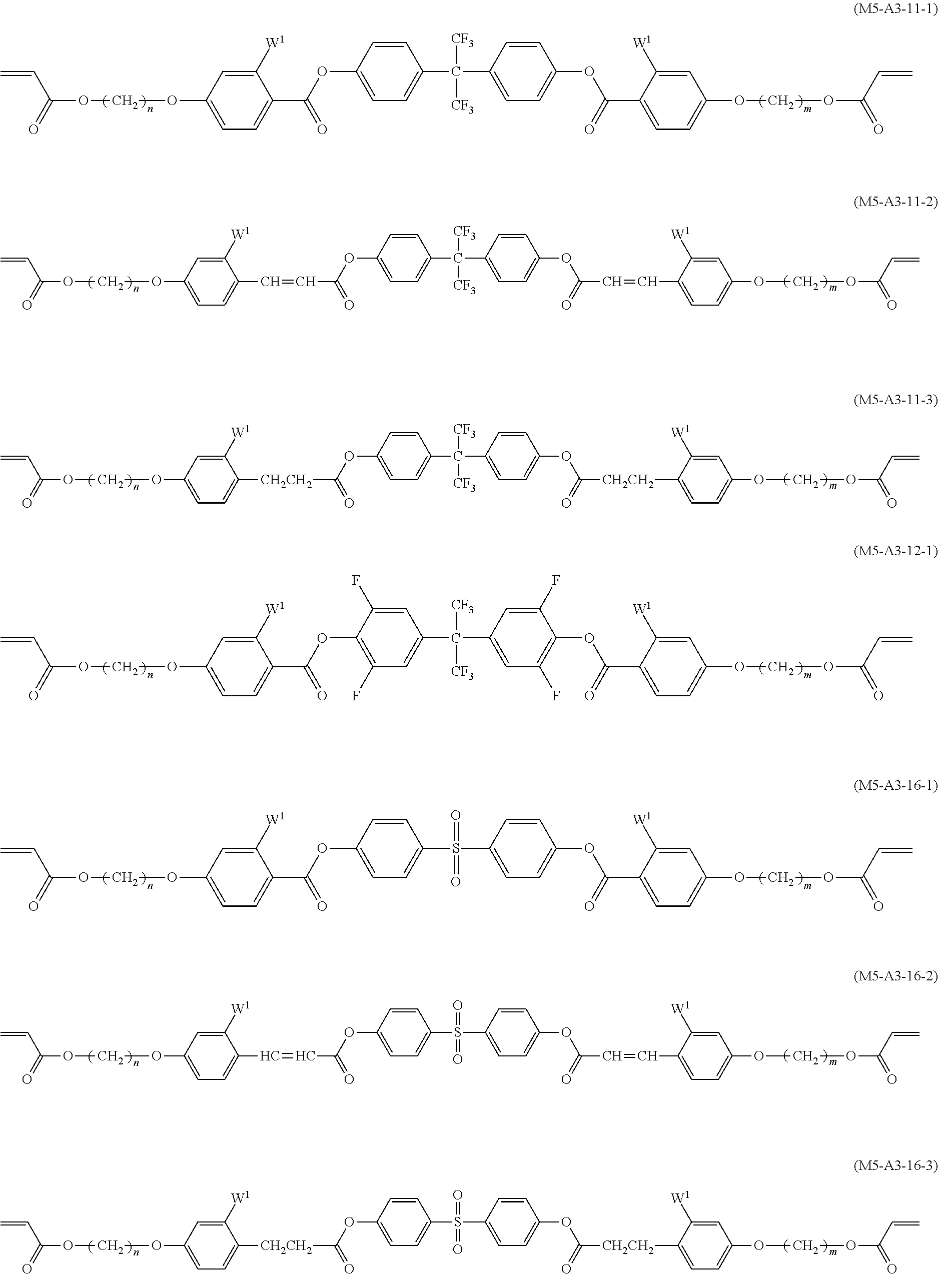

wherein W¹ is independently hydrogen or fluorine, and n and m are each independently an integer of 2 to 12.

The polymerizable liquid crystal composition of the invention may include a polymerizable compound other than the compound (M) and the compound (M5). It is desirable that the other polymerizable compounds do not decrease film-forming properties and mechanical strength. These compounds are classified into compounds having no liquid crystallinity and compounds having liquid crystallinity.

An example of the other polymerizable compounds having no liquid crystallinity includes vinyl derivatives, styrene derivatives, (meth)acrylic acid derivatives, oxirane derivatives, oxetane derivatives, sorbic acid derivatives, fumaric acid derivatives and itaconic acid derivatives. These compounds are suitable for adjusting the viscosity and the orientation of the composition, and when the composition is applied as a film, it has a large effect on uniformization of the thickness.

An example of the other polymerizable compounds having no liquid crystallinity includes a compound having one polymerizable group, a compound having two polymerizable groups and a multifunctional compound having three or more polymerizable groups. An example of the compound having one polymerizable group is described in paragraph 0097 of page 47 of JP 2008-266632 A, and the compound is suitable for adjusting viscosity, a melting point or the like.

An example of the compound having two or more polymerizable groups is described in paragraph 0098 of page 48 of JP 2008-266632 A, and the compound is suitable for adjusting the mechanical strength of a polymer.

The other polymerizable compound may be epoxy acrylate-based resins. Its specific example includes phenolic novolac-type epoxy acrylate resins, cresol novolac-type epoxy acrylate resins, phenol novolac-type acid-modified epoxy acrylate resins, cresol novolac-type acid-modified epoxy acrylate resins and trisphenolmethane-type acid-modified epoxy acrylate resins.

An example of epoxy resins which can be used together includes epoxy resins derived from divalent phenols, such as bisphenol A-type epoxy resins, bisphenol F-type epoxy resins, bisphenol S-type epoxy resins, bisphenol AD-type epoxy resins, resorcinol-type epoxy resins, hydroquinone-type epoxy resins, catechol-type epoxy resins, dihydroxynaphthalene-type epoxy resins, biphenyl-type epoxy resins, and tetramethylbiphenyl-type epoxy resins; epoxy resins derived from trivalent or higher valent phenols, such as phenolic novolac-type epoxy resins, cresol novolac-type epoxy resins, triphenylmethane-type epoxy resins, tetraphenylethane-type epoxy resins, dicyclopentadiene-phenol modified epoxy resins, phenol aralkyl-type epoxy resins, biphenyl aralkyl-type epoxy resins, naphthol novolac-type epoxy resins, naphthol aralkyl-type epoxy resins, naphthol-phenol copolycondensation novolac-type epoxy resin, naphthol-cresol copolycondensation novolac-type epoxy resins, aromatic hydrocarbon-formaldehyde resin-modified phenol resin-type epoxy resins and biphenyl-modified novolac-type epoxy resins; tetrabromobisphenol A-type epoxy resins, brominated phenol novolac-type epoxy resins, polycarboxylic acid glycidyl esters, polyol polyglycidyl ethers, aliphatic acid-based epoxy resins, alicyclic-based epoxy resins, glycidyl amine-type epoxy resins, triphenolmethane-type epoxy resins and dihydroxybenzene-type epoxy resins. These types of epoxy resins may be solely used or two or more kinds thereof may be mixed.

The other polymerizable compound may be an epoxy-based compound. An example of the epoxy-based compound is described in paragraph 0101 of page 49 of JP 2008-266632 A. This compound is suitable for adjusting the mechanical strength of a polymer.

The other polymerizable compound may be a polymerizable compound having a bisphenol structure which is described below. The compound is suitable for assisting an improvement of the film-forming properties of a polymer or the orientation uniformity of polymerizable liquid crystals.

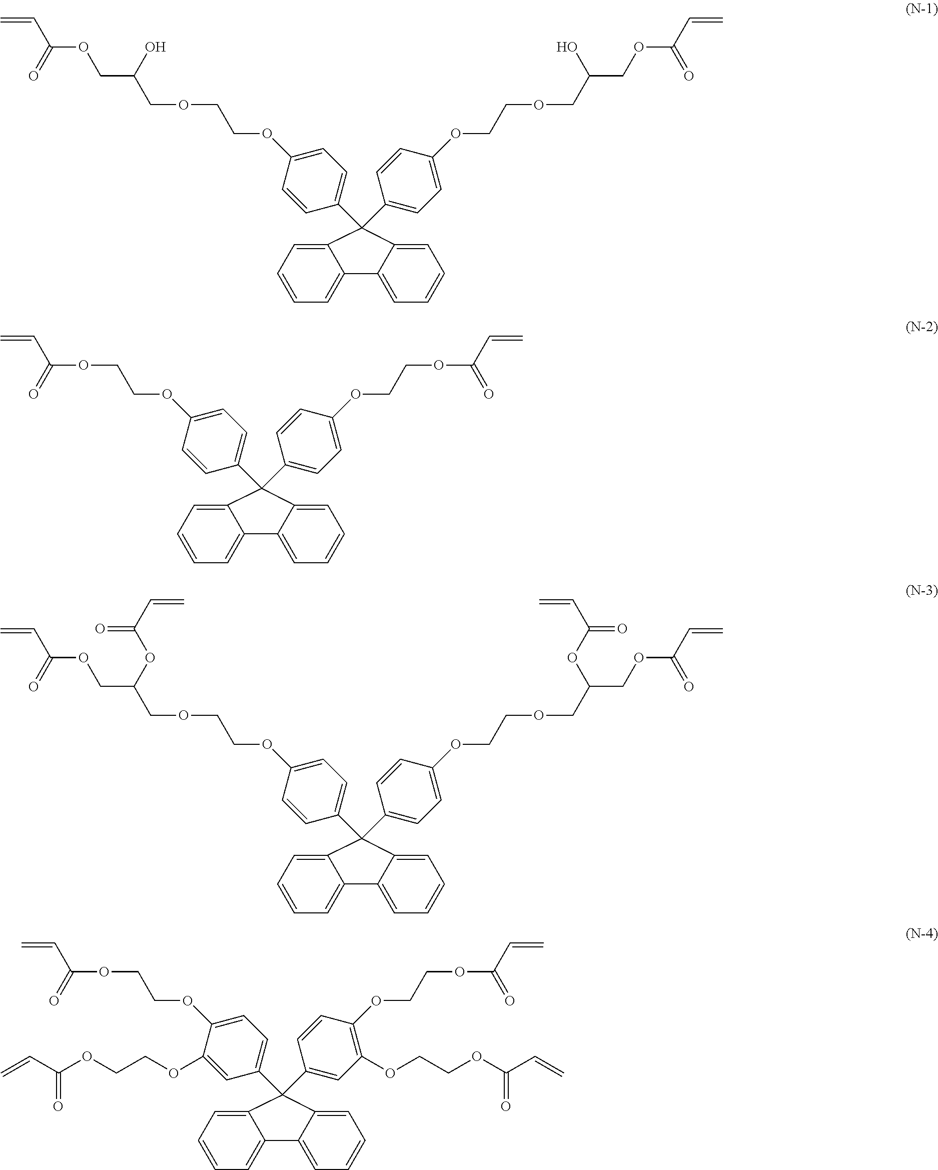

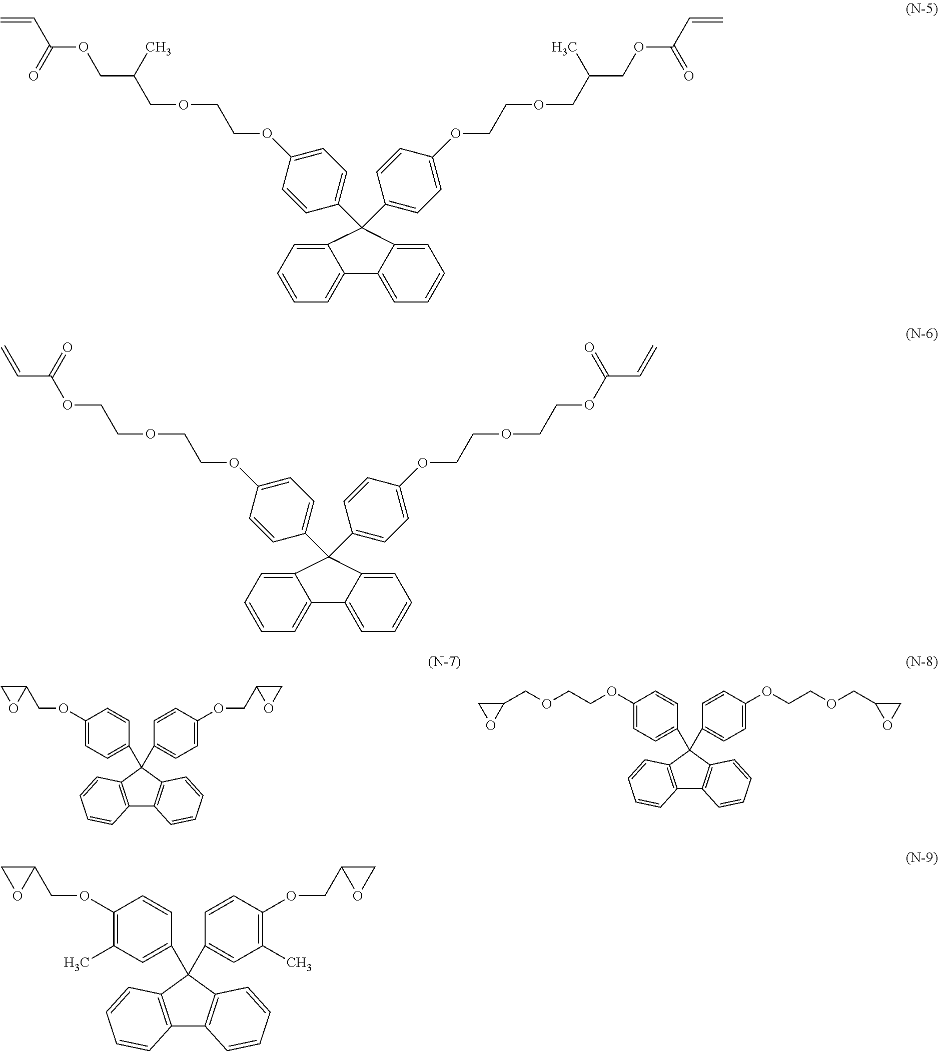

Methods for producing the compounds described above are described in JP 2002-348357 A, JP 2005-41925 A, JP 2005-266739 A or the like. Commercial products including the compound (N-1), the compound (N-7), the compound (N-8) or the compound (N-9) include ONF-1, Oncoat EX-1010, Oncoat EX-1020, Oncoat EX-1040 or the like produced by Osaka Gas Chemicals Co., Ltd. These commercial products may be used.

A more desirable example of the compound (M5) includes compounds described below.

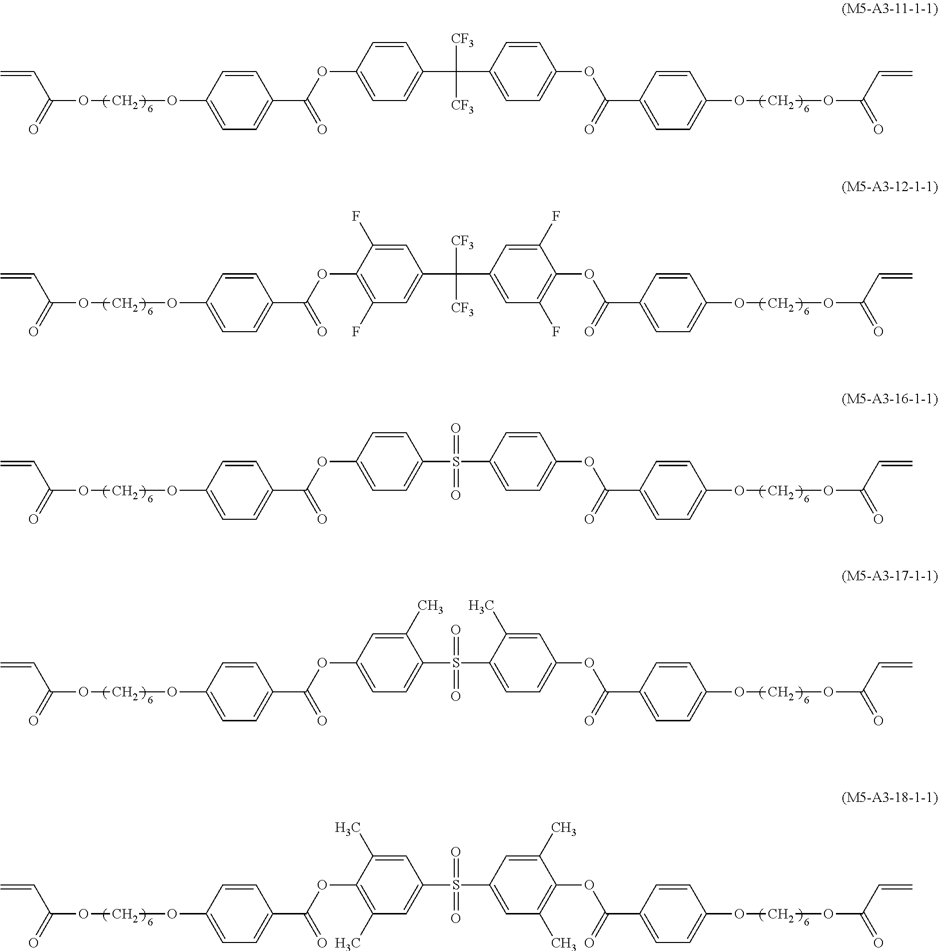

Methods for synthesizing these compounds are described in JP 2007-16213 A and JP 2008-133344 A.

The polymerizable liquid crystal composition may include a liquid crystal compound having no polymerizable group. An example of such a non-polymerizable liquid crystal compound is described in LiqCryst, LCI Publisher GmbH, Hamburg, Germany), which is a database of liquid crystal compounds, or the like. The polymerizable liquid crystal compound (M) has a good compatibility with other liquid crystal compounds. Thus, the polymerizable liquid crystal composition including the liquid crystal compound can be used as a liquid crystal composition sealed in a liquid crystal display device. Such a polymerizable liquid crystal composition may further include an additive, such as a dichroic dye. Composite materials of both the polymer of the polymerizable liquid crystal compound (M) and the liquid crystal compound can be obtained by polymerizing the polymerizable liquid crystal composition including the liquid crystal compound.

The polymerizable liquid crystal composition may include an optically active compound. An optical retardation film having a helical structure (a twist structure) is obtained by applying a polymerizable liquid crystal composition including an appropriate amount of a compound having optical activity or a polymerizable liquid crystal composition including an appropriate amount of a polymerizable compound having optical activity, to a substrate subjected to alignment treatment, and by polymerizing the resulting layer. This helical structure is fixed by polymerization of the polymerizable liquid crystal compound (M). The characteristics of the optically anisotropic substance obtained depend on the helical pitch of the formed helical structure. The length of this helical-pitch can be adjusted by the kind of an optically active compound and the amount added thereof. Only one optically active compound may be added, and two or more optically active compounds may also be used for the purpose of compensating the temperature dependence of the helical pitch. The polymerizable liquid crystal composition may include other polymerizable compounds in addition to the polymerizable liquid crystal compound (M) and the optically active compound.

The selective reflection of visible light, which is the characteristics of the optically anisotropic substance described above, arises from the action of a helical structure on incident light, which leads to the reflection of circularly polarized light or elliptically polarized light. Characteristics of the selective reflection are represented by λ=n·Pitch (λ is the central wavelength of selective reflection, n is an average refractive index and Pitch is a helical pitch). Hence λ and its bandwidth (Δλ) can be suitably adjusted by an amount of n or Pitch. The bandwidth Δλ should be decreased for an improvement of color purity, and Δλ should be increased for a broadband reflection. Furthermore, the selective reflection is greatly affected by polymer thickness. The thickness should not be made too small for maintaining color purity. The thickness should not be made too large for maintaining orientation uniformity. Thus, an appropriate adjustment of the thickness is necessary, and a desirable thickness is in the range of approximately 0.5 μm to approximately 25 μm, and a more desirable thickness is in the range of approximately 0.5 μm to approximately 5 μm.

The negative-type C plate (Negative C plate) described in W. H. de Jeu, PHYSICAL PROPERTIES OF LIQUID CRYSTALLINE MATERIALS, Gordon and Breach, New York (1980) can be prepared by making the helical pitch shorter than the wavelength of visible light. A shorter helical pitch can be achieved by using an optically active compound having a large twisting power (HTP: helical twisting power) and by increasing the amount of the compound added. The negative-type C plate can be prepared specifically when X is approximately 350 nm or less, and preferably approximately 200 nm or less. This negative-type C plate serves as an optical compensation film suitable for a display device of a VAN-type, a VAC-type, an OCB-type or the like, among liquid crystal display devices.

Any optically active compound may be used as the optically active compound described above if the compound can induce a helical structure and can be mixed appropriately with the polymerizable liquid crystal composition used as a base. An optically active compound may be polymerizable or non-polymerizable, and an optimum compound can be added according to a purpose. The polymerizable compound is more suitable when heat resistance and solvent resistance are taken into consideration. An example of a skeleton which exhibits the optical activity includes alkylene and alkenylene having one or more asymmetrical carbons, and compounds having the following structures.

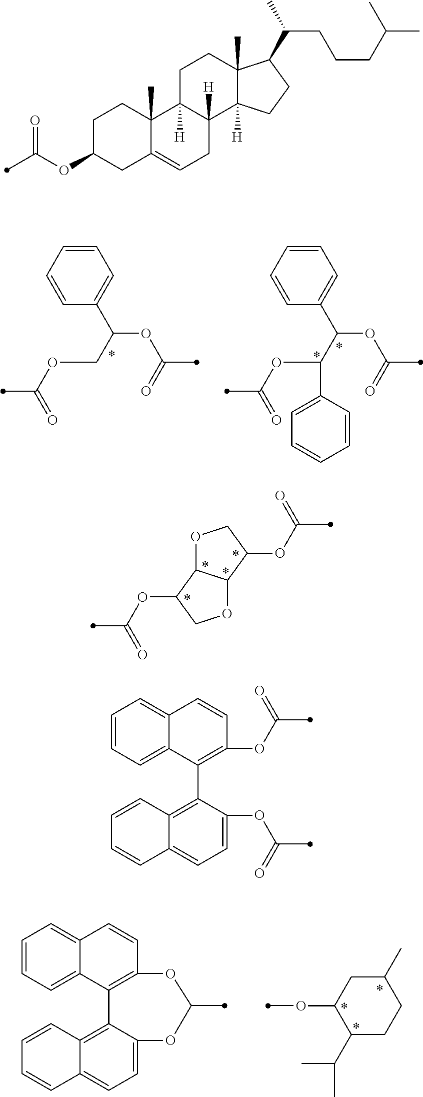

An optically active compounds having a large twisting power (HTP: helical twisting power) among the compounds described above is suitable for shortening the helical pitch. A representative example of a compound having a large twisting power is described in GB 2,298,202 B and DE 10,221,751 B.

A specific example of an optically active polymerizable compound is shown below. In the specific examples, n and m are each independently an integer of 2 to 12.

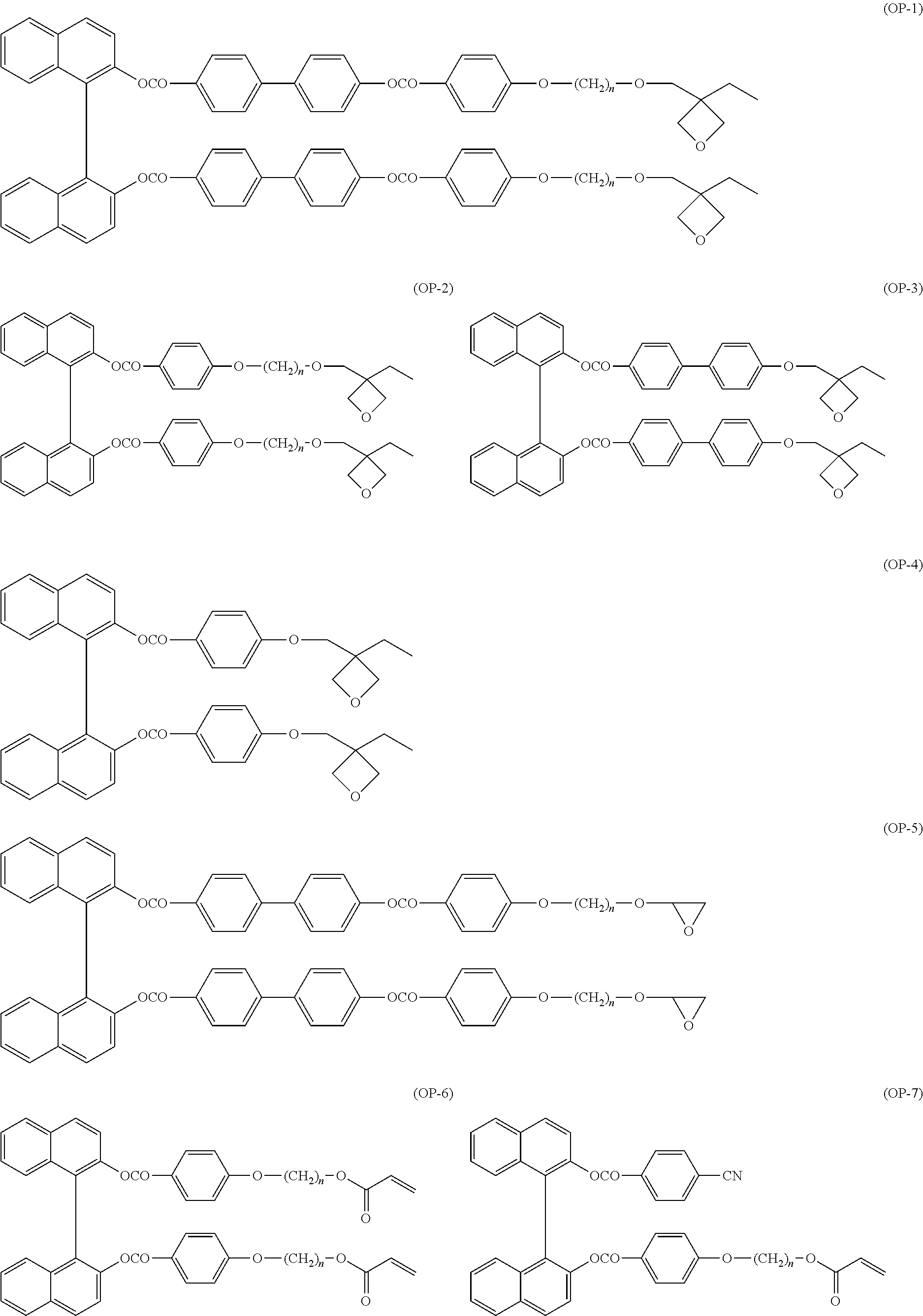

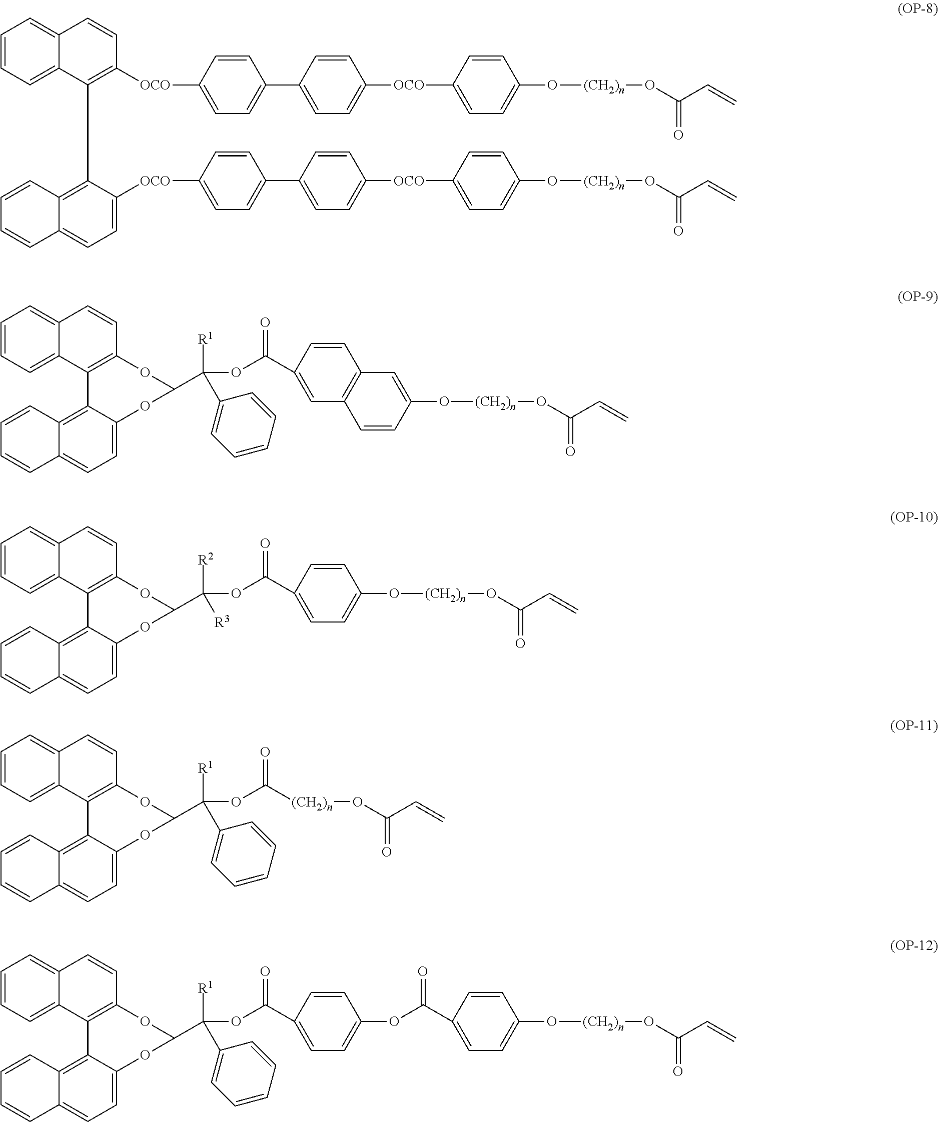

In the formula described above, R¹ is methyl, and R² and R³ are each independently phenyl, alkyl having 1 to 6 carbons or trifluoromethyl.

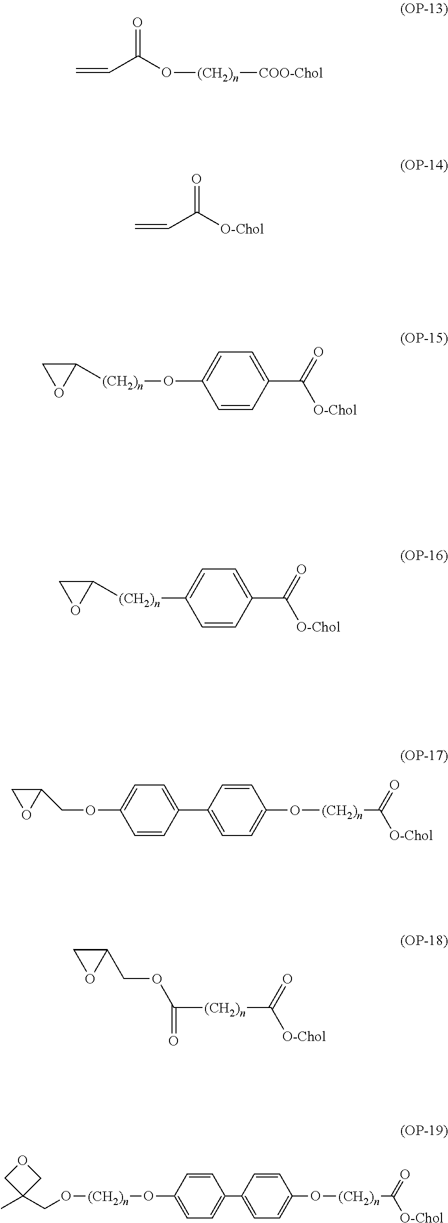

In the formula described above, —COO-Chol means the cholesterol ester group described below.

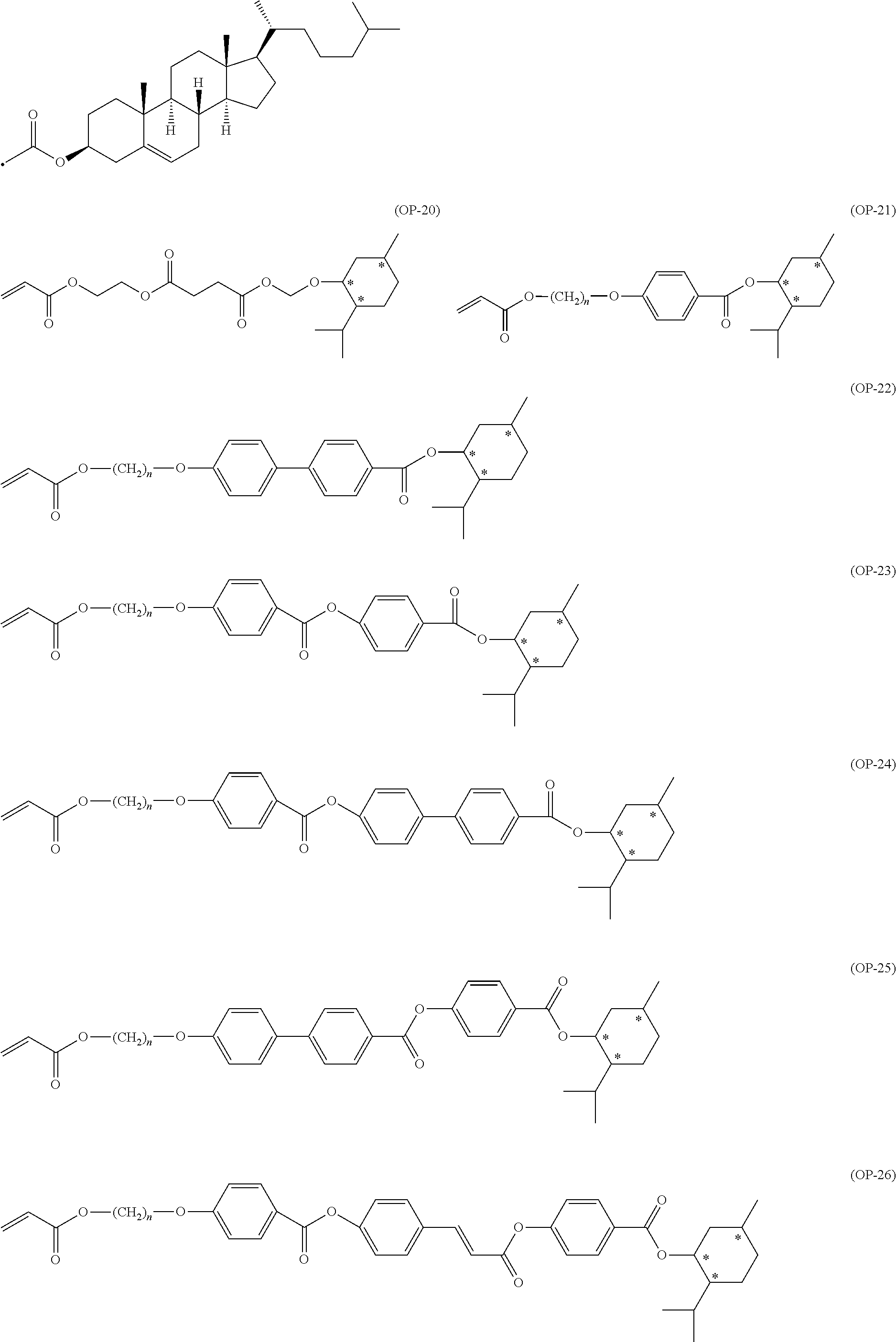

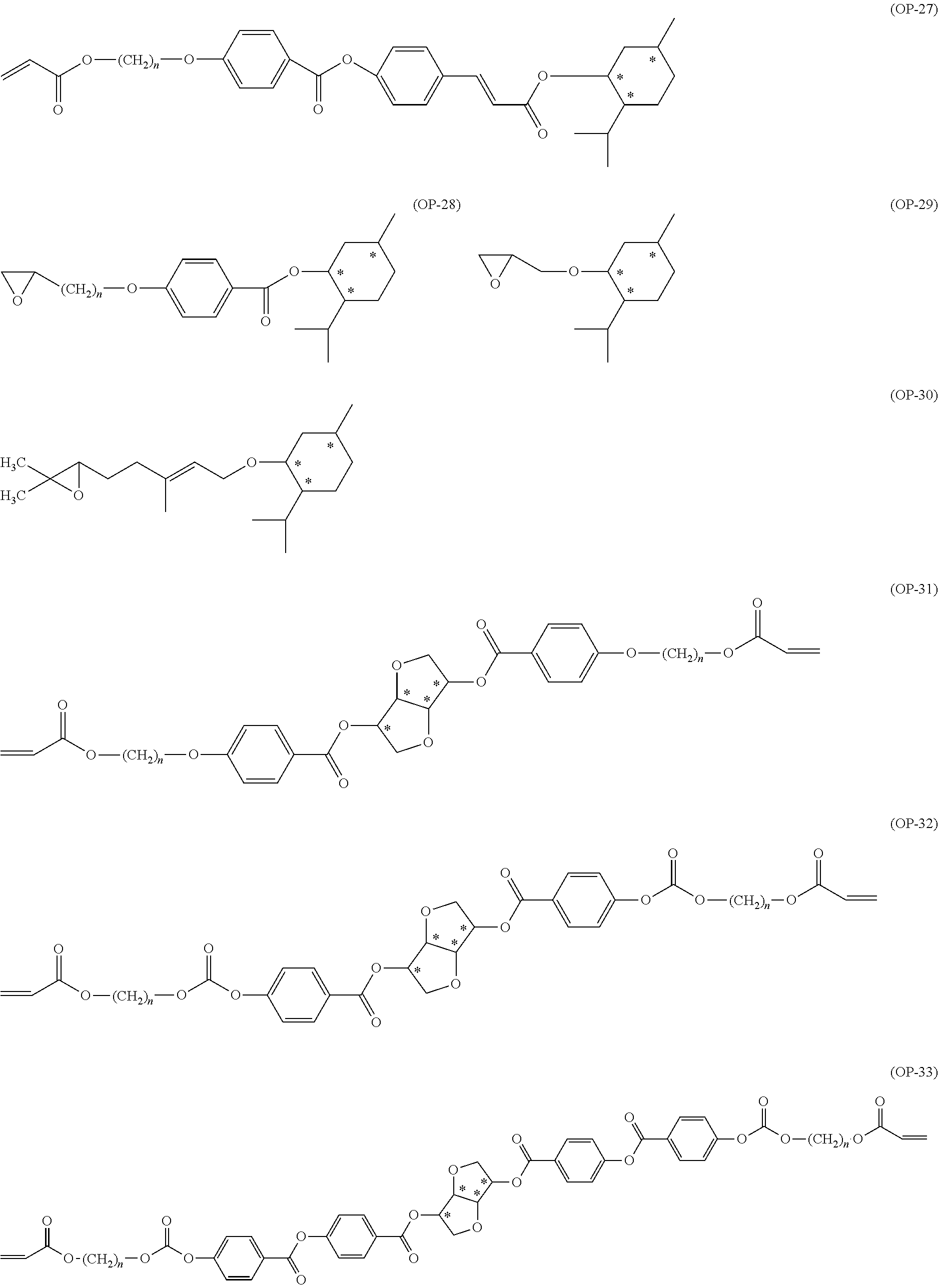

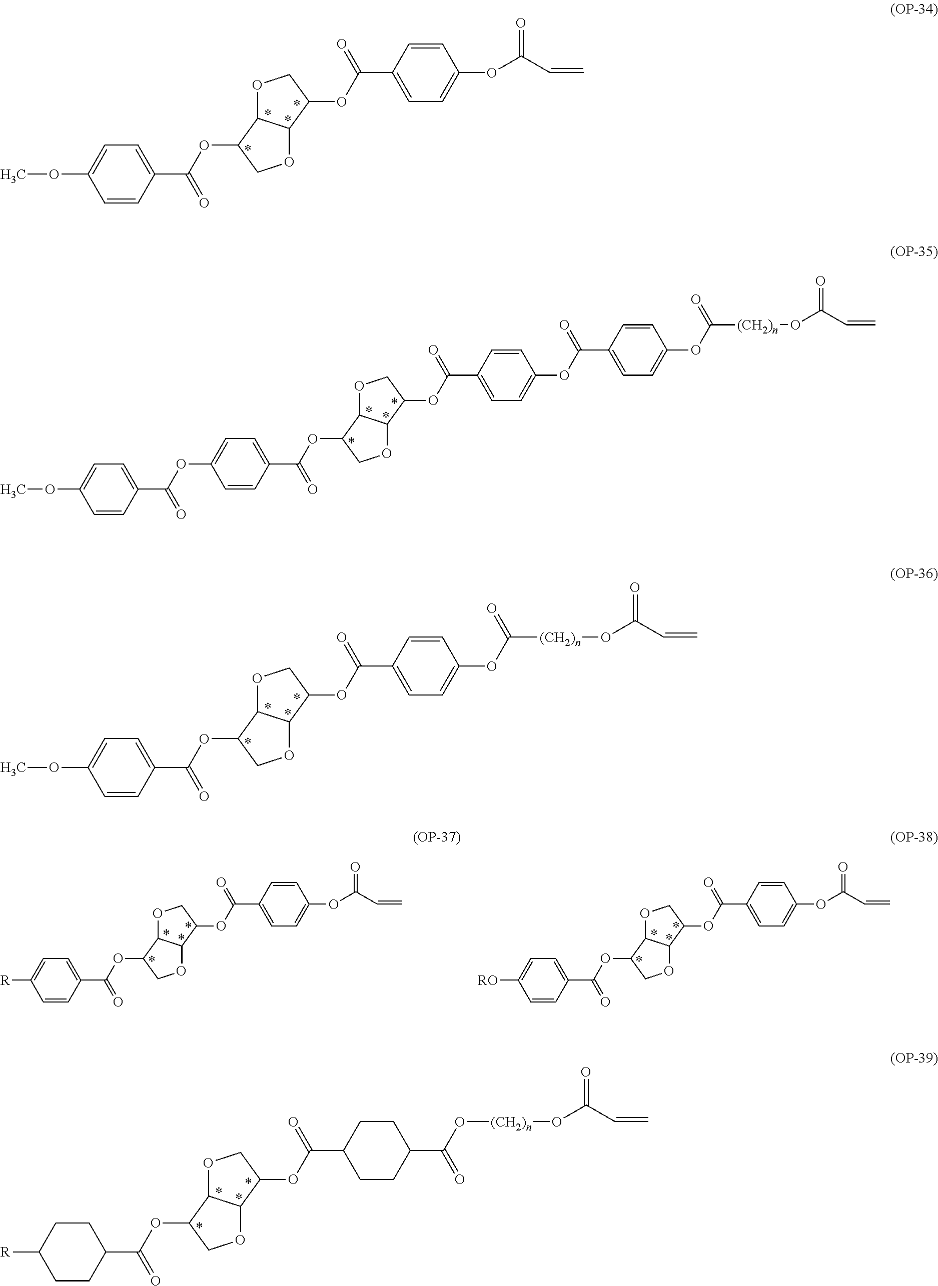

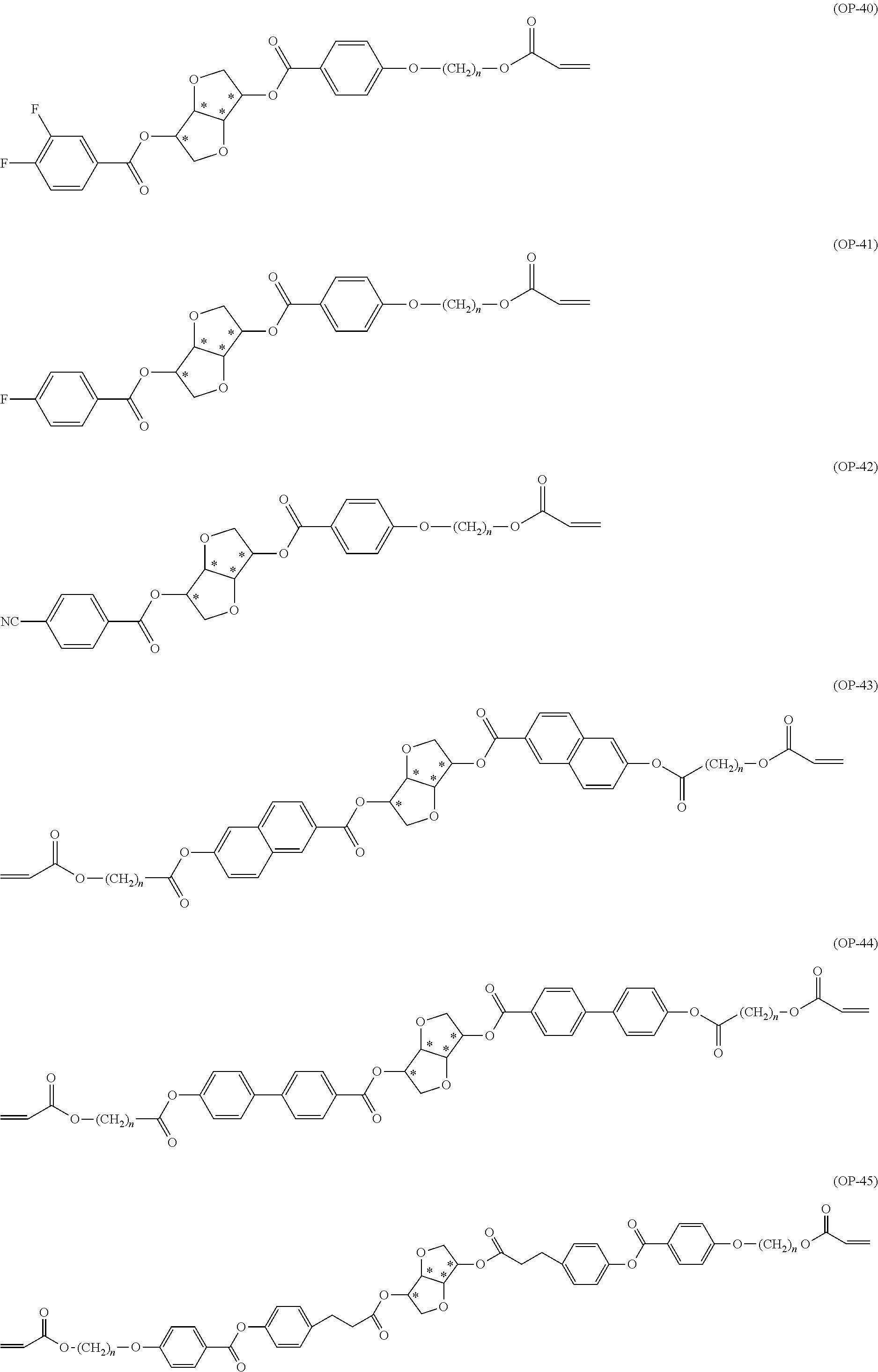

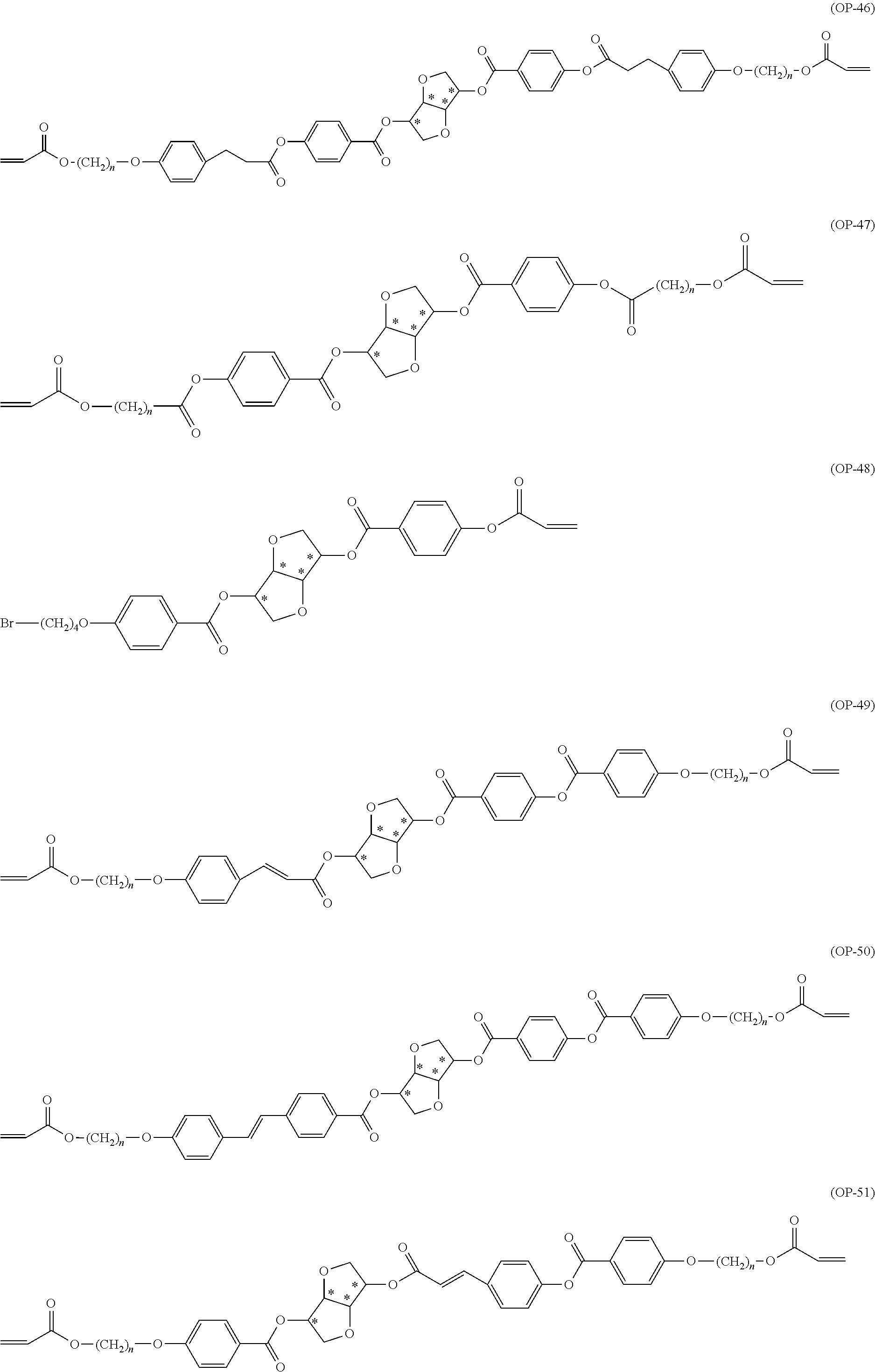

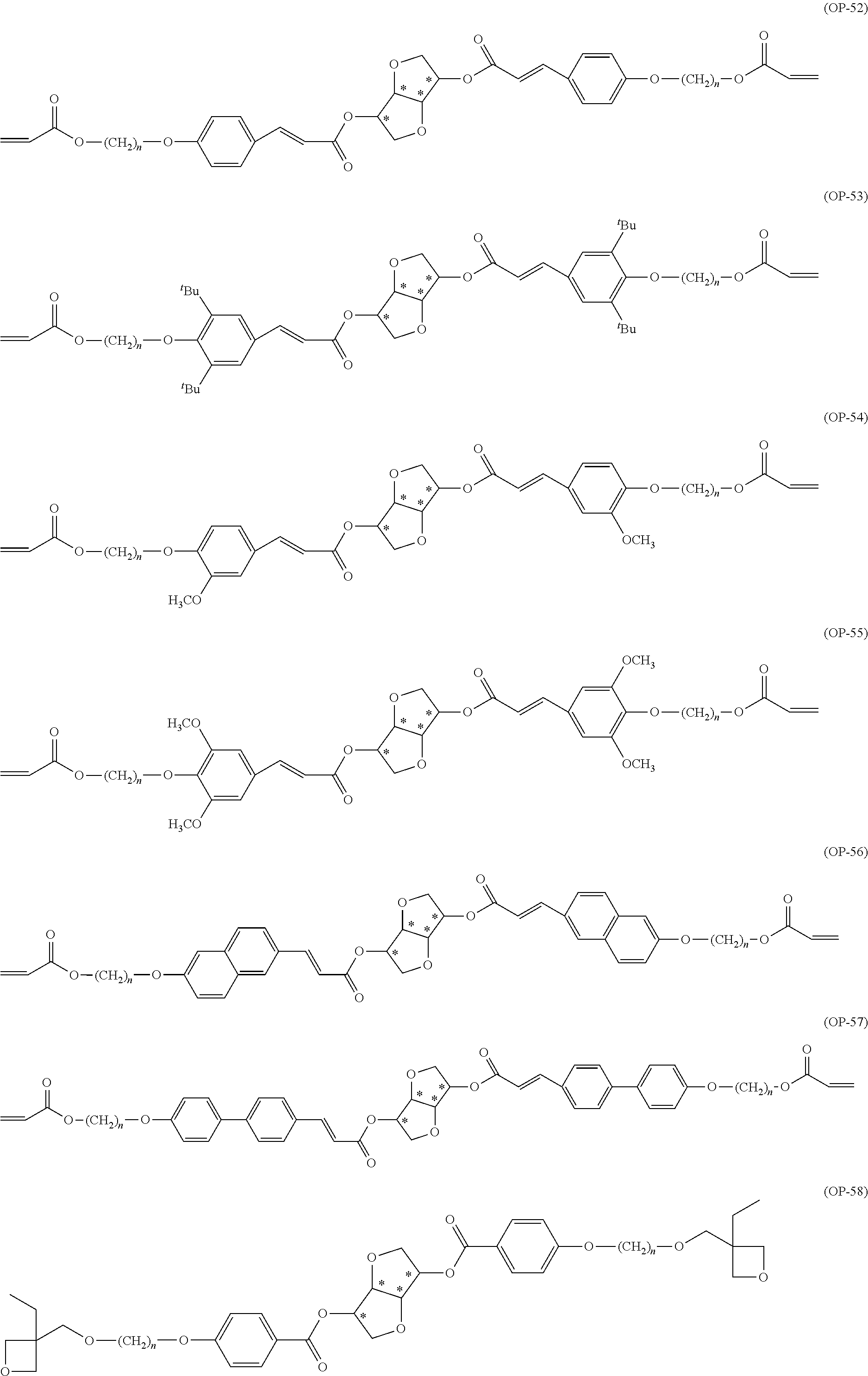

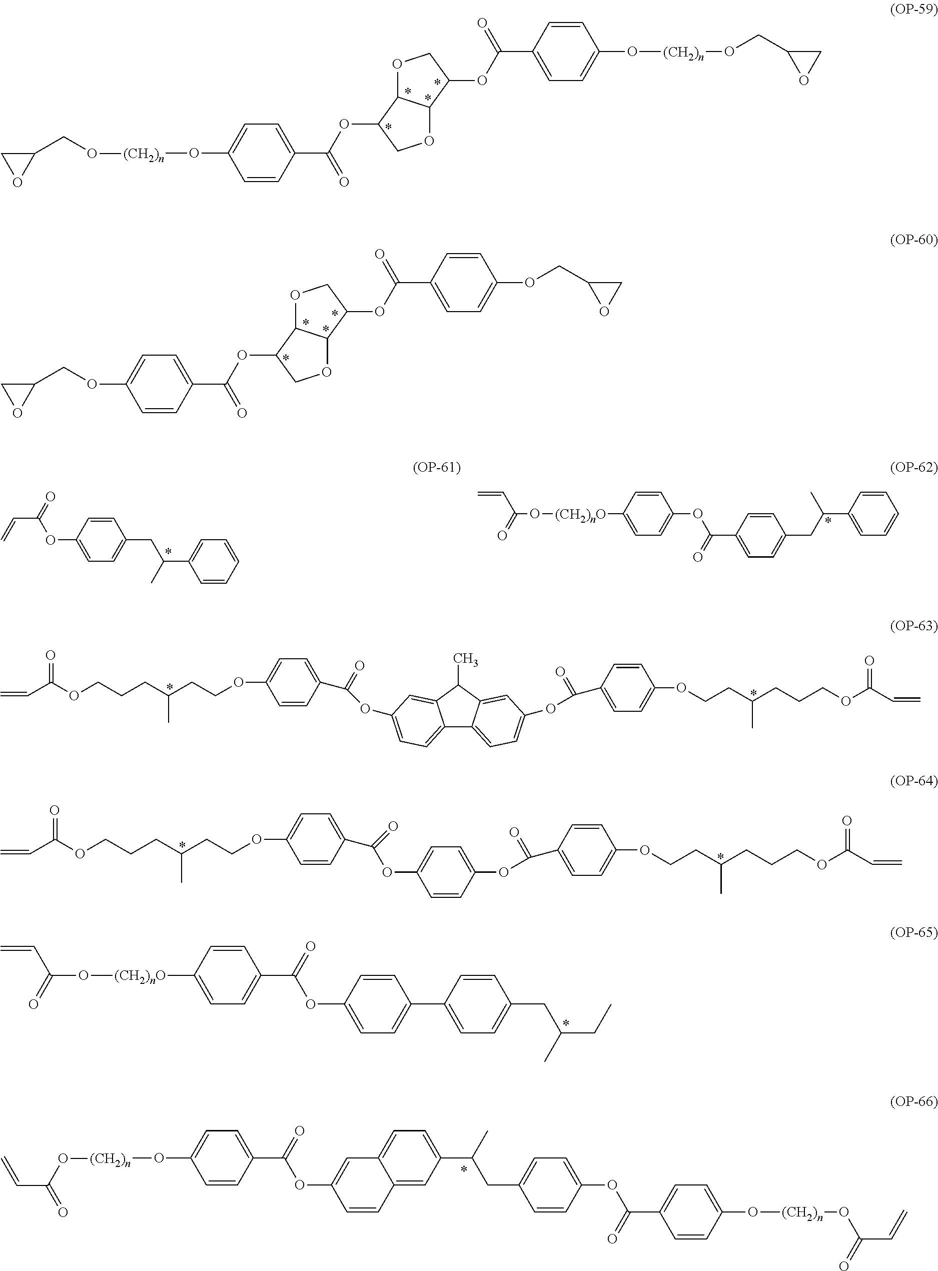

The polymerizable liquid crystal composition may include a polymerization initiator. The polymerization initiator can be selected in accordance with the kind of polymerization. A desirable initiator is shown below.

An example of the initiator used for radical photopolymerization is described in paragraphs 0103 to 0104 of page 50 of JP 2008-266632 A. A known or commercial initiator can be used. A desirable amount of the photopolymerization initiator is in the range of approximately 0.0001 to approximately 0.2 at the weight ratio based on the total weight of the polymerizable compound. A more desirable ratio is in the range of approximately 0.001 to approximately 0.10.

A desirable example of the initiator used for thermal radical polymerization includes benzoyl peroxide, diisopropyl peroxydicarbonate, tert-butylperoxy-2-ethylhexanoate, tert-butyl peroxypivalate, di-tert-butyl peroxide, tert-butyl peroxydiisobutyrate, lauroyl peroxide, 3,3′-bismethoxycarbonyl-4,4′-bis-tert-butyl peroxycarbonyl benzophenone, 3,4′-bismethoxycarbonyl-4,3′-bis-tert-butyl peroxycarbonyl benzophenone, 4,4′-bismethoxycarbonyl-3,3′-bis-tert-butyl peroxycarbonyl benzophenone, 2,2′-azobisisodimethyl butyrate, azobisisobutyronitrile and azobiscyclohexanecarbonitrile. Any known initiator can be used.

An example of a commercial azo-based initiator includes V-70, V-65, V-60, V-59, V-40, V-30, V-501, V-601, VE-073, VA-080, VA-086, VF-096, VAm-110, VAm-111, VA-044, VA-046B, VA-060, VA-061, V-50, VA-057, VA-067, VR-110, VPE-0201, VPE-0401, VPE-0601 and VPS-1001, all made by Wako Pure Chemical Industries, Ltd.

A desirable initiator for cationic photopolymerization includes a diaryl iodonium salt (abbreviated to “DAS” below) and a triaryl sulfonium salt (abbreviated to “TAS” below). An example of DAS is described in paragraph 0106 of page 51 of JP 2008-266632 A. It is also desirable to combine DAS and a photosensitizer. An example of such a photosensitizer includes thioxanthone, phenothiazine, chlorothioxanthone, xanthone, anthracene, diphenylanthracene and rubrene, but any known photosensitizer can be used. An example of TAS is described in paragraph 0108 of page 51 of JP 2008-266632 A.

An example of a commercial initiator used for cationic photopolymerization includes “DTS-102” made by Midori Kagaku Co., Ltd., “Cyracure UVI-6990”, “Cyracure UVI-6974” and “Cyracure UVI-6992” made by UCC, “Adeka Optomer SP-150, SP-152, SP-170 and SP-172” made by Adeka Corporation, “PHOTOINITIATOR 2074” made by Rhodia, “Irgacure 250” made by Ciba Japan K. K. and “UV-9380C” made by GE Silicones. However, any known initiator can be used.

A thermal polymerization initiator may be used together. An example of specific trade names includes San-Aid (main agent) SI-60, SI-80, SI-100, SI-110, SI-145, SI-150, SI-160, SI-180 and San-Aid (auxiliary agent) SI made by Sanshin Chemical Industry Co., Ltd. This agent may be used together with a photo-radical initiator and a cationic photopolymerization initiator, or together with the photo-radical initiator.

Moreover, an amine-based curing agent or the like which is described in “REVIEW; EPDXY RESINS” (edited by the Japan Society of Epoxy Resin Technology) can be added in accordance with characteristics needed.

The polymerizable liquid crystal composition may be applied to a supporting substrate without solvent-dilution. However, the solvent is usually used for facilitating application of the composition. The solvent may be used when each component of the polymerizable liquid crystal composition is mixed. The solvent may be used alone or may be a mixture of two or more solvents. An example of the solvent includes ester-based solvents, amide-based solvents, alcohol-based solvents, ether-based solvents, glycol monoalkyl ether-based solvents, aromatic hydrocarbon-based solvents, halogenated aromatic hydrocarbon-based solvents, aliphatic hydrocarbon-based solvents, halogenated aliphatic hydrocarbon-based solvents, alicyclic hydrocarbon-based solvents, ketone-based solvents and acetate-based solvents. A desirable example of these solvents is described in paragraphs 0117 to 0124 of page 53 of JP 2008-266632 A.

Use of amide-based solvents, aromatic hydrocarbon-based solvents and ketone-based solvents is desirable in view of the solubility of the polymerizable liquid crystal compound, and concomitant use of ester-based solvents, alcohol-based solvents, ether-based solvents and glycol monoalkyl ether-based solvents is also desirable in view of the boiling point of the solvent. Selection of the solvent is not limited. However, it is necessary to decrease drying temperature in order to prevent deformation of a substrate, and to prevent substrate erosion by the solvent when a plastic substrate is used as a supporting substrate. An example of a solvent preferably used in such a case includes aromatic hydrocarbon-based solvents, ketone-based solvents, ester-based solvents, ether-based solvents, alcohol-based solvents, acetate-based solvents and glycol monoalkyl ether-based solvents.

The ratio of the solvent for the polymerizable liquid crystal composition is in the range of approximately 50% to approximately 95% based on the total weight of the composition including the solvent. The lower limit of this range is a value determined in consideration of the solubility of the polymerizable liquid crystal compound and the optimum viscosity at the time of applying the composition. The upper limit is a value determined in consideration of an economic aspect such as a solvent cost, and a period of time and the amount of heat for evaporation of the solvent. A desirable ratio is in the range of approximately 60% to approximately 90%, and a more desirable ratio is in the range of approximately 70% to approximately 85%.

An example of an application method for forming a uniform thickness of the polymerizable liquid crystal composition includes a spin coating method, a micro-gravure coating method, a gravure coating method, a wire-bar coating method, a dip coating method, a spray coating method, a meniscus coating method and a die coating method.

The polymerizable liquid crystal composition may include a surfactant. The surfactant has an effect in which application of the composition with a uniform thickness to a supporting substrate or the like is facilitated and the orientation of a liquid crystal phase is also adjusted. A desirable surfactant includes a cationic surfactant, an anionic surfactant and a nonionic surfactant, and a more desirable surfactant is the nonionic surfactant. A desirable example of the nonionic surfactant is silicone-based, fluorine-based and hydrocarbon-based nonionic surfactants. Among these, an example of the silicone-based nonionic surfactant includes Polyflow ATF-2, Glanol 100, Glanol 115, Glanol 400, Glanol 410, Glanol 435, Glanol 440, Glanol 450, Glanol B-1484, Polyflow KL-250, Polyflow KL-260, Polyflow KL-270, Polyflow KL-280, BYK-300, BYK-302, BYK-306, BYK-307, BYK-310, BYK-315, BYK-320, BYK-322, BYK-323, BYK-325, BYK-330, BYK-331, BYK-333, BYK-337, BYK-341, BYK-344, BYK-345, BYK-346, BYK-347, BYK-348, BYK-370, BYK-375, BYK-377, BYK-378, BYK-3500, BYK-3510 and BYK-3570, and these includes modified silicone as a main component and are made by Kyoeisha Chemical Co., Ltd.

An example of the fluorine-based nonionic surfactant includes BYK-340, Futergent 251, Futergent 221 MH, Futergent 250, FTX-215M, FTX-218M, FTX-233M, FTX-245M, FTX-290M, FTX-209F, FTX-213F, Futergent-222F, FTX-233F, FTX-245F, FTX-208G, FTX-218G, FTX-240G, FTX-206D, Futergent-212D, FTX-218, FTX-220D, FTX-230D, FTX-240D, FTX-720C, FTX-740C, FTX-207S, FTX-211S, FTX-220S, FTX-230S, KB-L82, KB-L85, KB-L97, KB-L109, KB-L110, KB-F2L, KB-F2M, KB-F2S, KB-F3M and KB-FaM.

An example of the hydrocarbon-based nonionic surfactant includes Polyflow No. 3, Polyflow No. 50EHF, Polyflow No. 54N, Polyflow No. 75, Polyflow No. 77, Polyflow No. 85HF, Polyflow No. 90, Polyflow No. 95, BYK-350, BYK-352, BYK-354, BYK-355, BYK-358N, BYK-361N, BYK-380N, BYK-381, BYK-392 and BYK-Silclean3700, and these include an acryl-based polymer as a main component. Both of Polyflow and Glanol are trade names of chemicals sold by Kyoeisha Chemical Co., Ltd. BYK is a trade name of chemicals sold by BYK Japan, KK. Futergent, FTX and KB are trade names of chemicals sold by Neos Co., Ltd. The ratio of the surfactant depends on the kind of the surfactant, the composition ratios of a composition or the like, and it is in the range of approximately 0.0001 to approximately 0.03, and preferably in the range of approximately 0.0003 to approximately 0.02 at the weight ratio based on the total weight of the polymerizable liquid crystal composition (excluding solvent).

The polymerizable liquid crystal composition may include an organosilicon compound in order to adjust orientation. A specific example includes an amine-based compound such as 3-aminopropyltrimethoxysilane, 3-aminopropyltriethoxysilane, 3-aminopropyldimethylethoxysilane, 3-aminopropyldiisopropylethoxysilane, 3-aminopropylmethyldiethoxysilane, 3-aminopropylpentamethyldisiloxane, 3-aminopropylmethylbis(trimethylsiloxy)silane, 3-aminopropyltris(trimethylsiloxy)silane, 3-aminobutyltriethoxysilane, N-(2-aminoethyl)-3-aminopropylmethyldimethoxysilane, N-(2-aminoethyl)-3-aminopropyltrimethoxysilane, N-(6-aminohexyl)-3-aminopropyltrimethoxysilane and (3-trimethoxysilylpropyl)diethylenetriamine, and a ketimine-based compound such as 3-triethoxysilyl-N-(1,3-dimethyl-butylidene). Moreover, an organosilicon compound other than those described above may be included in order to adjust adhesion to a supporting substrate. A specific example includes vinyltrialkoxysilane, 3-isocyanatopropyltriethoxysilane, 3-glycidoxypropyltrialkoxysilane, 3-chlorotrialkoxysilane, 3-acryloxypropyltrimethoxysilane and 3-methacryloxypropyltrialkoxysilane. Another example includes dialkoxymethylsilane which is formed by replacing one of three alkoxy groups of these compounds by methyl. Although the ratio of the organosilicon compound depends on the kind of the organosilicon compound, the composition ratios of the composition or the like, it is in the range of approximately 0.01 to approximately 0.30, and preferably in the range of approximately 0.03 to approximately 0.15 at the weight ratio based on the total weight of the polymerizable liquid crystal composition (1) (excluding solvent).

The mechanical characteristics of a polymer can be adjusted by adding one, two or more kinds of chain-transfer agents to the polymerizable liquid crystal composition. The length of a polymer chain or the length of two polymer chains crosslinked in a polymer film can be adjusted by using a chain-transfer agent. Such lengths can also be adjusted simultaneously. The length of the polymer chain decreases with an increase of the amount of the chain-transfer agent. A desirable chain-transfer agent is a thiol compound. An example of a monofunctional thiol is dodecanethiol and 2-ethylhexyl 3-mercaptopropionate. An example of multifunctional thiols is trimethylolpropane tris(3-mercaptopropionate), pentaerythritol tetrakis(3-mercaptopropionate), 1,4-bis(3-mercaptobutylyloxybutane (Karenz MT BD1), pentaerythritol tetrakis(3-mercaptobutylate) (Karenz MT PE1) and 1,3,5-tris(3-mercaptobutyloxyethyl)-1,3,5-triazine-2,4,6(1H,3H,5H)-trione (Karenz MT NR1). “Karenz” is a trade name of Showa Denko K. K.

A polymerization inhibitor can be added to the polymerizable liquid crystal composition in order to avoid a start of polymerization during preservation. A known polymerization inhibitor can be used and a desirable example includes 2,5-di(t-butyl)hydroxytoluene (BHT), hydroquinone, methyl blue, diphenylpicric acid hydrazide (DPPH), benzothiazine, 4-nitrosodimethylaniline (NIDI), o-hydroxybenzophenone or the like.

An oxygen inhibitor can also be added in order to improve the preservation stability of the polymerizable liquid crystal composition. Radicals generated in the polymerizable liquid crystal composition react with oxygen in an atmosphere, giving peroxide radicals, which promote an undesirable reaction with a polymerizable compound. It is desirable to add the oxygen inhibitor in order to avoid the reaction. An example of the oxygen inhibitor is phosphoric esters.

An ultraviolet absorber, a light stabilizer (a radical scavenger), an antioxidant or the like may be added in order to further improve the weather resistance of the polymerizable liquid crystal composition. An example of the ultraviolet absorber includes Tinuvin PS, Tinuvin P, Tinuvin 99-2, Tinuvin 109, Tinuvin 213, Tinuvin 234, Tinuvin 326, Tinuvin 328, Tinuvin 329, Tinuvin 384-2, Tinuvin 571, Tinuvin 900, Tinuvin 928, Tinuvin 1130, Tinuvin 400, Tinuvin 405, Tinuvin 460, Tinuvin 479, Tinuvin 5236, Adekastab LA-32, Adekastab LA-34, Adekastab LA-36, Adekastab LA-31, Adekastab 1413 and Adekastab LA-51. “Tinuvin” is a trade name of Ciba Japan K. K., and “Adekastab” is a trade name of Adeka Corporation.

An example of the light stabilizer includes Tinuvin 111FDL, Tinuvin 123, Tinuvin 144, Tinuvin 152, Tinuvin 292, Tinuvin 622, Tinuvin 770, Tinuvin 765, Tinuvin 780, Tinuvin 905, Tinuvin 5100, Tinuvins 5050 and 5060, Tinuvin 5151, Chimasorb 119FL, Chimasorb 944FL, Chimasorb 944LD, Adekastab LA-52, Adekastab LA-57, Adekastab LA-62, Adekastab LA-67, Adekastab LA-63P, Adekastab LA-68LD, Adekastab LA-77, Adekastab LA-82, Adekastab LA-87, Cyasorb UV-3346 made by Cytec Industries, Inc., and Goodrite UV-3034 of Goodrich Corporation. “Chimasorb” is a trade name of Ciba Japan K. K.

An example of the antioxidant includes Adekastab AO-20, AO-30, AO-40, AO-50, AO-60 and AO-80 made by Adeka Corporation, Sumilizer BHT, Sumilizer BBM-S and Sumilizer GA-80 sold by Sumitomo Chemical Co., Ltd., and Irganox 1076, Irganox 1010, Irganox 3114 and Irganox 245 sold by Ciba Japan K. K.

In the following explanation, the polymer of the invention obtained by adjusting the orientation of the polymerizable liquid crystal composition and polymerizing the composition is called an optically anisotropic substance. The optically anisotropic substance can be formed as described below. First, the polymerizable liquid crystal composition is applied to a supporting substrate that has been subjected to photo-alignment treatment, and then dried, forming a layer in which liquid crystal molecules are oriented. Next, the polymerizable liquid crystal composition is polymerized by irradiation of the layer with light, and a nematic orientation in which the polymerizable liquid crystal composition has formed in a liquid crystal state is fixed. The supporting substrate which can be used is a glass plate and a plastic film. An example of the plastic film includes films of polyimide, polyamidoimide, polyamide, polyetherimide, polyetheretherketone, polyetherketone, polyketone sulfide, polyether sulfone, polysulfone, polyphenylene sulfide, polyphenylene oxide, polyethylene terephthalate, polybutylene terephthalate, polyethylene naphthalate, polyacetal, polycarbonate, polyarylate, acrylic resins, polyvinyl alcohol, polypropylene, cellulose, triacetyl cellulose, partially saponified triacetyl cellulose, epoxy resins, phenol resins and cycloolefin-based resins.

An example of the cycloolefin-based resins includes, but is not limited to, norbornene-based resins and dicyclopentadiene-based resins. Among these, a resin having no unsaturated bonds or a resin in which unsaturated bonds are hydrogenated is suitably used. The example includes a hydrogenated product of a polymer formed by ring-opening polymerization (or copolymerization) of one, two or more norbornene-based monomers, a polymer formed by addition polymerization (or copolymerization) of one, two or more norbornene-based monomers, a polymer formed by addition copolymerization of a norbornene-based monomer and an olefin-based monomer (ethylene, α-olefin or the like), a polymer formed by addition copolymerization of a norbornene-based monomer and a cycloolefin-based monomer (cyclopentene, cyclooctene, 5,6-dihydrodicyclopentadiene or the like) and modified polymers thereof. A specific example includes ZEONEX, ZEONOR (made by Nippon Zeon Co., Ltd.), ARTON (made by JSR Corporation), TOPAS (made by Ticona GmbH), APEL (made by Mitsui Chemicals, Inc.), S-Sina (made by Sekisui Chemical Co., Ltd.) and OPTOREZ (made by Hitachi Chemical Co., Ltd.).

The plastic film may be an uniaxially stretched film or a biaxially stretched film. The plastic film may be subjected to a surface treatment such as hydrophilization treatment utilizing corona or plasma, or hydrophobization treatment. Although the method for hydrophilization treatment is not limited, the corona treatment or the plasma treatment is desirable, and an especially desirable method is the plasma treatment. A method described in JP 2002-226616 A, JP 2002-121648 A or the like may be used for the plasma treatment. Such hydrophilization treatment can also be used when the polymerizable liquid crystal composition should be oriented homeotropically. The plastic film may be a laminated film. A metal substrate such as aluminum, iron and copper substrates, having slit-like grooves on their surface, and a glass substrate such as alkali glass, borosilicate glass and flint glass substrates, having a surface etched to the shape of slits, and so forth can also be used in place of the plastic film.

A supporting substrate such as a glass plate, plastic film and so forth is subjected to optical orientation treatment described above in advance of the formation of the layer of the polymerizable liquid crystal composition.

When the polymerizable liquid crystal composition of the invention is applied, the solvent is removed after application and a layer of the polymerizable liquid crystal composition having a uniform thickness is formed on a supporting substrate. Conditions permitting the removal of the solvent are not limited. The layer may be dried substantially until most part of the solvent has been removed and the layer of the polymerizable liquid crystal composition has lost its flowability. The solvent can be removed by a method such as air-drying, drying on a hot plate, drying in an oven and blowing of warm air or hot air. The nematic orientation of the polymerizable liquid crystal composition in the layer may be attained in the step of drying the layer in certain cases, depending on the kind of compounds used for the composition and the composition ratio. Thus, after the drying step, the layer can be transferred to a polymerization step without a thermal treatment step described later.

Desirable ranges of time and temperature for the thermal treatment of the layer, wavelengths of light used for light irradiation, the amount of light arrived from a light source or the like could vary with factors such as the kind of compounds and the composition ratio used for the polymerizable liquid crystal composition, the presence or absence of a photopolymerization initiator added and its amount added. Thus, conditions such as time and temperature for a thermal treatment of the layer, wavelengths of light used for light irradiation, and the amount of light arrived from a light source, which will be explained below, could indicate approximate ranges tentatively.

It is desirable that thermal treatment of the layer is carried out under conditions that the solvent is removed and a homogeneous orientation in the composition is attained. The treatment may be carried out at a temperature above the transition temperature of the liquid crystal phase of the polymerizable liquid crystal composition. One of examples of the thermal treatment is a method in which the layer is heated until the polymerizable liquid crystal composition exhibits a nematic liquid crystal phase and nematic orientation is formed in the composition of the layer. The nematic orientation may also be formed by varying the temperature of the layer within the temperature range in which the polymerizable liquid crystal composition exhibits a nematic liquid crystal phase. In this method, the nematic orientation is roughly completed, and then more ordered-orientation is formed by decreasing the temperature. The thermal treatment temperature in either method described above is in the range of around room temperature to approximately 120° C. A desirable temperature is in the range of around room temperature to approximately 100° C. A more desirable temperature is in the range of around room temperature to approximately 90° C., and even more desirable temperature is in the range of around room temperature to approximately 85° C. The thermal treatment time is in the range of 5 seconds to 2 hours. A desirable time is in the range 10 seconds to 40 minutes, and more desirable time is in the range 20 seconds to 20 minutes. The thermal treatment time is preferably longer than 5 seconds in order to increase the temperature of the layer composed of the polymerizable liquid crystal composition to a designated value. The thermal treatment time is preferably within 2 hours in order to avoid a decrease of productivity. Thus, the layer of the polymerizable liquid crystals of the invention is obtained.

The nematic orientation state of the polymerizable liquid crystal compound formed in the polymerizable liquid crystal layer is fixed by polymerizing this polymerizable liquid crystal compound on irradiation with light. The light wavelength used for the light irradiation is not limited. Electron beams, ultraviolet light, visible light, infrared light (heat wave) or the like can be used. Usually, ultraviolet light or visible light is used. The range of wavelength is approximately 150 nm to approximately 500 nm. A desirable range is approximately 250 nm to approximately 450 nm, and a more desirable range is approximately 300 nm to approximately 400 nm. An example of a light source includes a low-pressure mercury lamp (a germicidal lamp, a chemical fluorescent lamp, and a black light), a high-intensity discharge lamp (a high-pressure mercury lamp and a metal halide lamp) and a short-arc lamp (an ultra high-pressure mercury lamp, a xenon lamp, and a mercury-xenon lamp). A desirable example of the light source is a metal halide lamp, a xenon lamp, an ultra high-pressure mercury lamp, and a high-pressure mercury lamp. The wavelength region of the radiation source may be selected by using a filter or the like arranged between the radiation source and the polymerizable liquid crystal layer and by passing light only with a particular wavelength region. The amount of light arrived from a light source is in the range of approximately 2 mJ/cm² to approximately 5000 mJ/cm². The amount of light is preferably in the range of approximately 10 mJ/cm² to approximately 3000 mJ/cm², and more preferably in the range of approximately 100 mJ/cm² to approximately 2000 mJ/cm². It is desirable that conditions of temperature during light irradiation are set up in a similar manner to those of thermal treatment described above. Any one of a nitrogen atmosphere, an inert gas atmosphere and an air atmosphere may be used in polymerization. The nitrogen atmosphere or the inert gas atmosphere is desirable in view of increasing curability.

When the optically anisotropic substance formed by polymerizing the polymerizable liquid crystal composition of the invention by means of light, heat or the like is used for various optical elements or is applied as an optical compensation element used for a liquid crystal display device, an adjustment of the tilt angle distribution in the thickness direction is very important.

One of methods for adjusting a tilt angle includes an adjustment of the kind of the liquid crystal compound, the composition ratio or the like used for the polymerizable liquid crystal composition. The tilt angle can be adjusted by adding a surfactant to this polymerizable liquid crystal compound. The tilt angle of the optically anisotropic substance can also be adjusted by the kind of the solvent and concentration of the solute, the kind and the amount of the surfactant or the like in the polymerizable liquid crystal composition. The tilt angle of the liquid crystal film can also be adjusted by the kind of a supporting substrate, conditions of photo-alignment treatment, conditions for drying and heat-treating the layer of the polymerizable liquid crystal composition, or the like. Furthermore, the irradiation atmosphere and the temperature in the photopolymerization step that comes after the alignment step affect the tilt angle of the optically anisotropic substance. That is, almost all the conditions in the process of manufacturing the optically anisotropic substance more or less affect the tilt angle. Therefore, the objective tilt angle is achieved by optimizing the polymerizable liquid crystal composition and suitably selecting the conditions of the process of manufacturing the optically anisotropic substance.

In the state of a homogeneous orientation, the tilt angles are distributed among values close to 0 degrees, especially in the range of approximately 0 degrees to approximately 5 degrees in the area from a substrate interface to a free interface. This orientation state is attained using the compound (M1), the compound (M2-1), the compound (M2-2), the compound (M2-3), the compound (M4) and a nonionic surfactant. When the compound (M3) is used for an adjustment of physical properties or the like, only the least amount thereof should be used. A desirable example of the nonionic surfactant is fluorine-based, silicone-based and hydrocarbon-based nonionic surfactants, and the fluorine-based nonionic surfactant is desirable. The amount added is in the range of approximately 0.0001% to approximately 0.03% by weight, and preferably in the range of approximately 0.0003% to approximately 0.02% by weight, based on the total weight of the composition (1) (excluding solvent).

A suitable thickness of the optically anisotropic substance varies with retardation according to an objective element or with the birefringence of the optically anisotropic substance. Thus, the range of the thickness cannot be precisely determined, but a desirable thickness of the optically anisotropic substance is roughly in the range of approximately 0.05 μm to approximately 50 μm. A more desirable range is approximately 0.5 μm to approximately and even more desirable range is approximately 1 μm to approximately 10 μm. A desirable haze value of the optically anisotropic substance is approximately 1.5% or less, and a desirable transmittance is approximately 80% or more. A more desirable haze value is approximately 1.0% or less, and a more desirable transmittance is approximately 95% or more. Transmittance preferably satisfies these conditions in the visible light region.

The optically anisotropic substance is effective in applying to a liquid crystal display device (especially to a liquid crystal display device with an active-matrix type or a passive matrix type) as an optical compensation element. An example of the type of the liquid crystal display device suitable for use of this optically anisotropic substance as the optical compensation film includes a VA type (Vertically Aligned), an IPS type (In-Plain Switching), an OCB type (Optically Compensated Birefringence), a TN type (Twisted Nematic), a STN type (Super-Twisted Nematic), an ECB type (Electrically Controlled Birefringence), a DAP type (Deformation of vertical Aligned Phase), a CSH type (Color Super Homeotropic), a VAN/VAC type (Vertically Aligned Nematic/Cholesteric), a HAN type (Hybrid Aligned Nematic), an OMI type (Optical-Mode Interference) and a SBE type (Super Birefringence Effect). Further, the optically anisotropic substance can also be used as a phase retarder for a guest host type, a ferroelectric type, an antiferroelectric type, a transmission type, a reflection type, semi-transmission type or the like of a display device. Since the optimum values of parameters such as distribution of the tilt angles in the thickness direction and the thickness which are required for the optically anisotropic substance depend greatly on the kind and the optical parameter of the liquid crystal display device to be compensated, they vary with the kind of a device.

The optically anisotropic substance can also be used as an optical element integrated with a polarizing plate or the like, and in this case it is arranged outside the liquid crystal cell. On the other hand, since the optically anisotropic substance as an optical compensation element elutes no or little impurities to the liquid crystals filled in the cell, it can be arranged inside the liquid crystal cell. For example, an application of a method disclosed in JP 2006-350294 A makes it possible to further improve the function of a color filter by forming the polymerizable liquid crystal layer of the invention on the color filter.

When the polymerizable liquid crystal composition includes a polymerizable or a non-polymerizable optically active compound, the optically anisotropic substance has a fixed helical structure.

The optically anisotropic substance having a fixed helical structure is suitable for an optical retardation film, a polarizing element, a circularly polarizing element, an elliptically polarizing element, an antireflection film, a selective reflection film, a color compensation film and a viewing angle compensation film.

Thermal polymerization and photopolymerization are suitable for fixing the helical structure. The thermal polymerization is preferably carried out in the presence of a cationic initiator. The photopolymerization is preferably carried out in the presence of a cationic photopolymerization initiator. For example, a polymer in which molecules are oriented in the direction of polarized light direction is obtained by a method for polymerization using irradiation with ultraviolet light, electron beams or the like in the presence of the cationic photopolymerization initiator.

The optical retardation film having the helical structure is obtained by polymerizing the polymerizable liquid crystal composition including the optically active compound. This polymerizable liquid crystal composition is optically active, and hence has a helical structure. When such a polymerizable liquid crystal composition is polymerized on an optically oriented supporting substrate, an optically anisotropic substance having a fixed helical structure is obtained. The characteristics of the optically anisotropic substance having the helical structure depend on the pitch in the helical structure. This helical pitch can be adjusted with the kind and the amount of the optically active compound. The amount of this optically active compound is usually in the range of approximately 0.0001 to approximately 0.5 at the weight ratio, and preferably in the range of approximately 0.01 to approximately 0.3 at the weight ratio based on total weight of the polymerizable liquid crystal composition (excluding solvent). Only one optically active compound may be added, and a plurality of optically active compounds may also be added for the purpose of compensating the temperature dependence of the helical pitch.

It will be apparent to those skilled in the art that various modifications and variations can be made in the invention and specific examples provided herein without departing from the spirit or scope of the invention. Thus, it is intended that the invention covers the modifications and variations of this invention that come within the scope of any claims and their equivalents.

The following examples are for illustrative purposes only and are not intended, nor should they be interpreted to, limit the scope of the invention.

### EXAMPLES

Hereinafter, the invention will be explained in more detail based on examples. Tetracarboxylic acid dianhydrides, acid anhydrides, diamines, monoamines and solvents used in Examples and Comparative Examples are shown below.

### <Tetracarboxylic Acid Dianhydrides>

Acid anhydride (A-1): pyromellitic dianhydride

Acid anhydride (A-7): 3,4,3′,4′-diphenyl ether tetracarboxylic acid dianhydride

Acid anhydride (A-14): 1,2,3,4-cyclobutanetetracarboxylic acid dianhydride

### <Dicarboxylic Anhydrides>

PA: phthalic anhydride

NAA: 2,3-naphthalene dicarboxylic anhydride

### <Diamines>

Diamine (1-1): 4,4′-diaminoazobenzene

Diamine (3-1): 4,4′-diaminodiphenylmethane

Diamine (3-7): 4,4′-diaminodiphenylethane

### <Monoamines>

APSE: 3-aminopropyltriethoxysilane

### <Solvents>

NMP: N-methyl-2-pyrrolidone

BC: ethylene glycol monobutyl ether

Polymerizable liquid crystal compounds used in Examples are shown below. Each of these compounds was synthesized in accordance with the production method described in the reference described above.

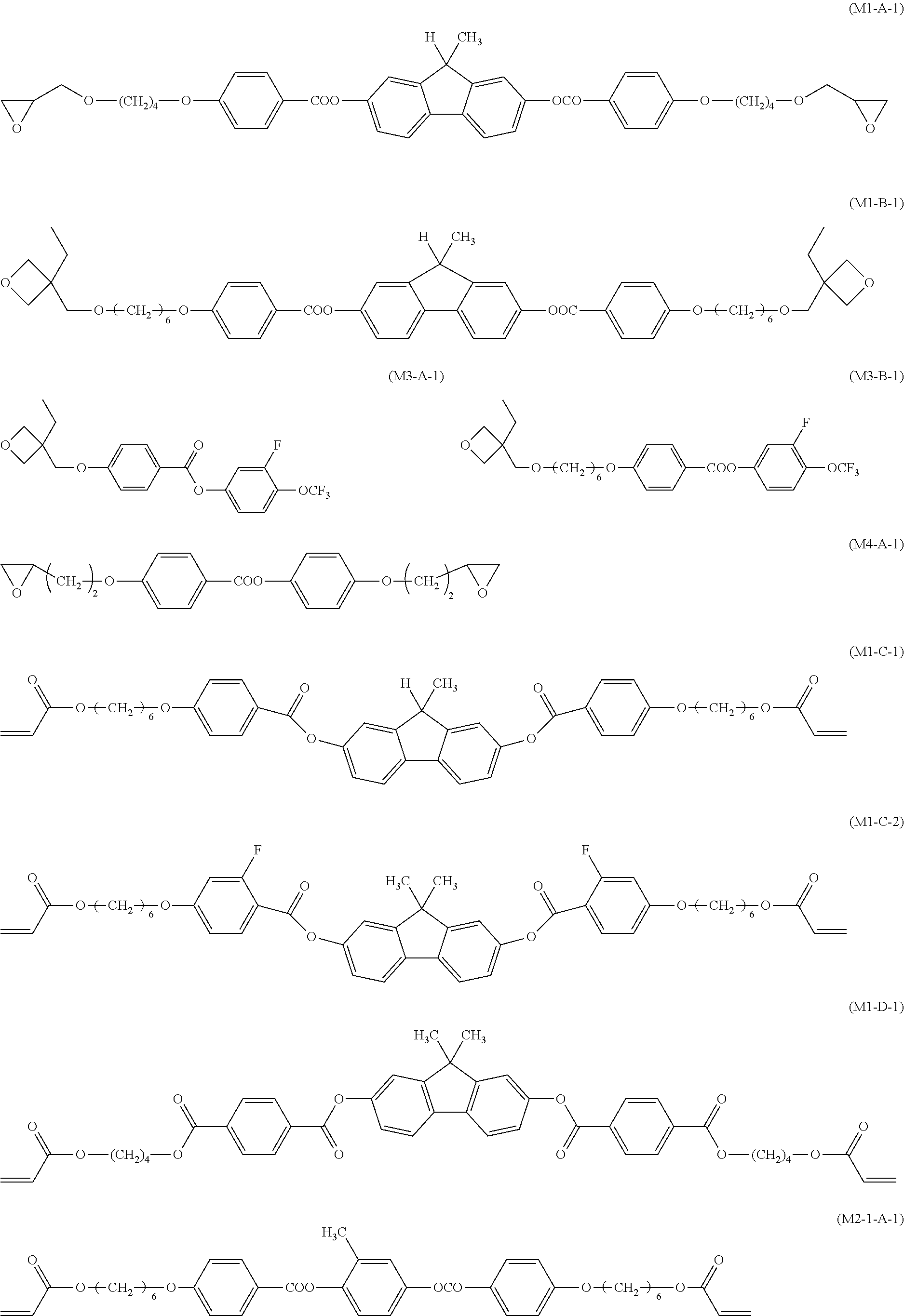

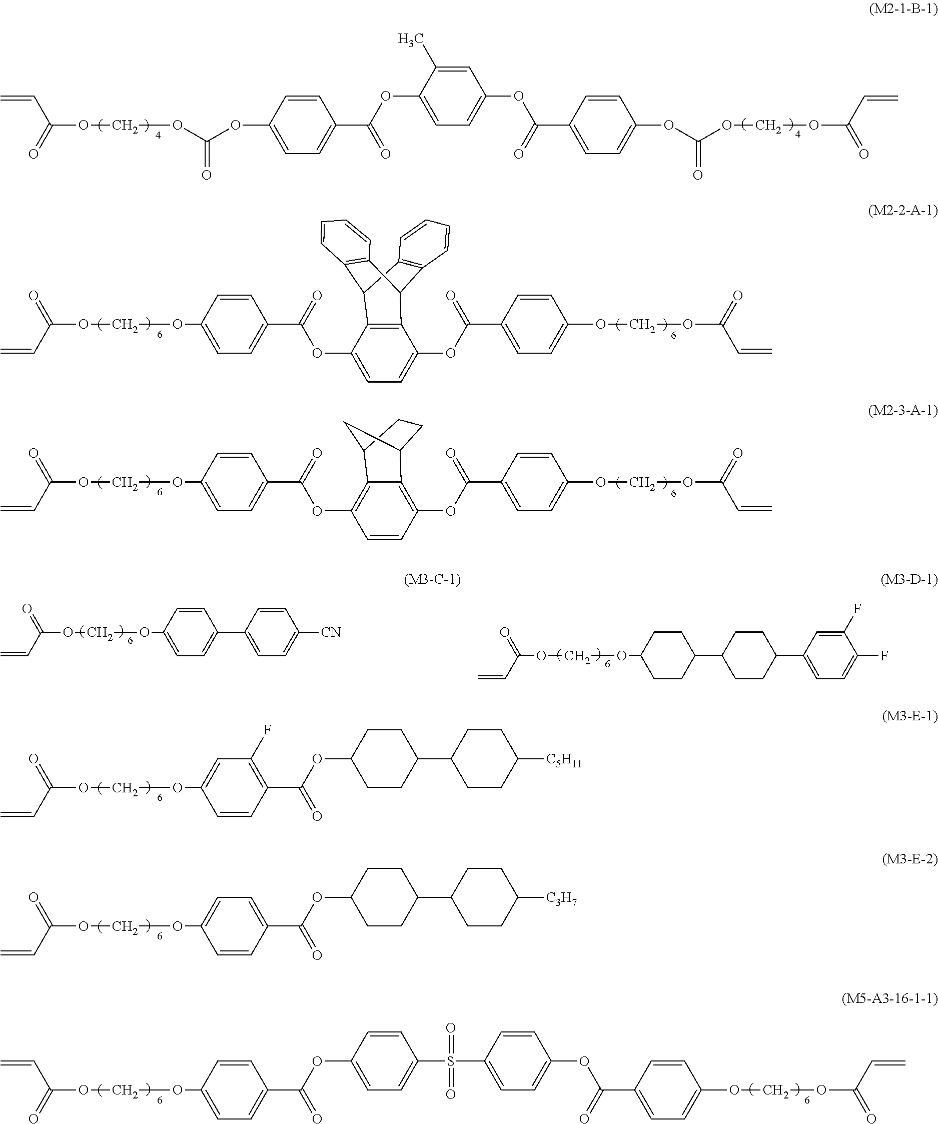

The compound (M2-3-A-1) was synthesized as follows.

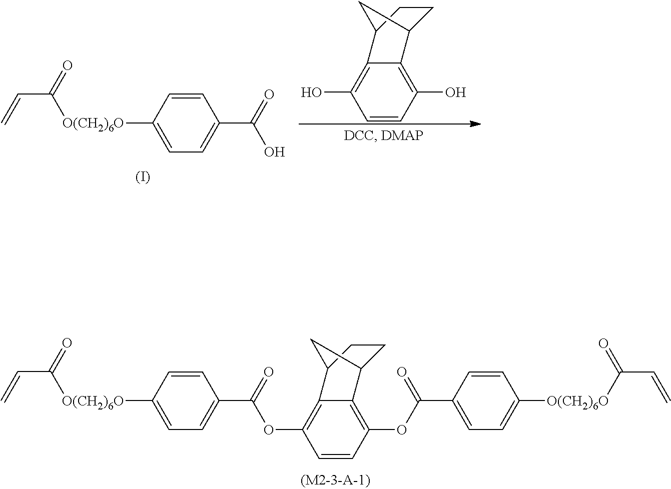

The compound (I) (74 mmol), 3′,6′-dihydroxybenzonorbornene (35 mmol), and 4-dimethylaminopyridine (DMAP) (21 mmol) were added to dichloromethane (200 mL), and the mixture was stirred under a nitrogen atmosphere. A dichloromethane solution (100 mL) of 1,3-dicyclohexylcarbodiimide (DCC) (74 mmol) was added there dropwise. After the dropwise addition, the mixture was stirred at room temperature for 8 hours. The deposited precipitate was filtered off, and the organic layer was washed with water and dried over anhydrous magnesium sulfate. Distillation of the solvent under reduced pressure, purification of the residue by means of column chromatography and recrystallization from ethanol gave the compound (M2-3-A-1) (15 mmol). The melting point of the obtained compound (M2-3-A-1) was 77° C.

The method for measuring physical properties is shown below.

### <Rotational Viscosity of a Polyamic Acid Varnish>

An E type viscometer was used. Measurement temperature was 25° C.

### <Weight Average Molecular Weight (Mw)>

The weight average molecular weight (Mw) of a polyamic acid was measured by means of gel permeation chromatography (GPC) at a column temperature of 50° C. The eluent was DMF to which phosphoric acid (0.6% by weight) was added, and polystyrene was used as the standard solution.

### <Photo-Curing Conditions of a Polymerizable Liquid Crystal Composition>

A polymerizable liquid crystal composition was irradiated, under a nitrogen atmosphere or in air at room temperature, with light of an intensity of 30 mW/cm² (365 nm) for 30 seconds, using a 250 W ultrahigh pressure mercury lamp.

### <Observation of Liquid Crystal Orientation State>

A substrate with an optically anisotropic substance was observed with a polarizing-microscope, and the presence or the absence of orientation defects was determined.

<Measurement with Polarized Light Analyzer>

The substrate with an optically anisotropic substance was irradiated with light of 550 nm wavelength by use of a polarimeter Model OPTIPRO made by Shintech, Inc. Retardation was measured while the incidence angle of the light to the film plane was decreased, starting from 90 degrees. Retardation (phase lag) is represented by Δn×d. The symbol Δn represents refractive index anisotropy and the symbol d represents the thickness of a polymer film.

### <Evaluation of Selective Reflection Wavelength>

The transmission spectrum of the obtained PET film with a cured layer was measured using a UV-Vis spectrophotometer (Model UV-1700; Shimadzu Corporation) and evaluated.

In the following explanation, “polyamic acid varnish” may simply be expressed as “varnish”.

### Example 1

### Preparation of the Varnish A1 Including Polyamic Acid Having Divalent Azobenzene Group

The diamine (1-1) (2.4660 g) and dried NMP (55.00 g) were introduced into a 200 ml four-neck flask equipped with a thermometer, stirrer, a starting material inlet and nitrogen gas inlet, and were stirred for dissolution under a nitrogen atmosphere. The acid anhydride (A-1) (2.5340 g) was added while the reaction mixture was kept at 5° C. After the reaction for 30 hours, BC (40.00 g) was added, giving the varnish in which the concentration of the polymer component was 5% by weight. After the stirring at around 60° C. for 4 hour, the varnish A1 having a viscosity of 33 mPa·s was obtained. The weight average molecular weight of the polyamic acid in this varnish was 52,000.

### Examples 2 to 9 and Comparative Examples 1 to 7

### Preparation of the Varnishes A2 to A7, the Varnishes B1 to B2 and the Varnishes R1 to R7

The varnish shown in Table 1 was prepared by a method similar to that of Example 1.

TABLE 1

| | | Tetracarboxilic Acid | | | Diarboxilic Acid | | | | | |
|---|---|---|---|---|---|---|---|---|---|---|
| Example | | Dianhydride | | | Anhydride | | Diamine | | | Monoamine |
| Number | Varnish | (A-1) | (A-14) | (A-7) | PA | NAA | (1-1) | (3-1) | (3-7) | APSE |
| Example 2 | A2 | 80 | 20 | | | | 30 | | 70 | |
| Example 3 | A3 | 80 | 20 | | | | 30 | 70 | | |
| Example 4 | A4 | | | 100 | | | 30 | | 70 | |
| Example 5 | A5 | | | 100 | | | 70 | | | 60 |
| Example 6 | A6 | | | 70 | 60 | | 100 | | | |
| Example 7 | A7 | | | 70 | | 60 | 100 | | | |
| Example 8 | B1 | 50 | 50 | | | | | 100 | | |
| Example 9 | B2 | 80 | 20 | | | | | 100 | | |
| Comparative | R1 | 100 | | | | | | | 100 | |
| Example 1 | | | | | | | | | | |
| Comparative | R2 | 80 | 20 | | | | | | 100 | |
| Example 2 | | | | | | | | | | |
| Comparative | R3 | 80 | 20 | | | | | 70 | 30 | |
| Example 3 | | | | | | | | | | |
| Comparative | R4 | | | 100 | | | | | 100 | |
| Example 4 | | | | | | | | | | |
| Comparative | R5 | | | 100 | | | | | 70 | 60 |
| Example 5 | | | | | | | | | | |
| Comparative | R6 | | | 70 | 60 | | | | 100 | |
| Example 6 | | | | | | | | | | |
| Comparative | R7 | | | 70 | | 60 | | | 100 | |
| Example 7 | | | | | | | | | | |

The viscosity and the weight average molecular weight of the polyamic acid in the varnish of Table 1 are shown in Table 2.

TABLE 2

| | | | Weight Average |
|---|---|---|---|
| Example Number | Varnish | Viscosity | Molecular Weight |
| Example 2 | A2 | 35 | 54,000 |
| Example 3 | A3 | 34 | 56,000 |
| Example 4 | A4 | 33 | 53,000 |
| Example 5 | A5 | 28 | 37,000 |
| Example 6 | A6 | 29 | 38,000 |
| Example 7 | A7 | 27 | 36,000 |
| Example 8 | B1 | 33 | 53,000 |
| Example 9 | B2 | 35 | 56,000 |
| Comparative Example 1 | R1 | 35 | 55,000 |
| Comparative Example 2 | R2 | 34 | 53,000 |
| Comparative Example 3 | R3 | 35 | 54,000 |
| Comparative Example 4 | R4 | 34 | 54,000 |
| Comparative Example 5 | R5 | 30 | 38,000 |
| Comparative Example 6 | R6 | 29 | 38,000 |
| Comparative Example 7 | R7 | 29 | 39,000 |

### Examples 10 to 17 and Comparative Examples 8 to 15

### Preparation of Mixed Varnishes

The mixed varnishes C1 to C16 were prepared as shown in Table 3.

TABLE 3

| Example Number | Mixed Varnish | Mixed Varnish | Mixing Ratio |
|---|---|---|---|
| Example 10 | C1 | A5/B1 | 1/1 |
| Example 11 | C2 | A5/B2 | 1/1 |
| Example 12 | C3 | A6/B1 | 3/7 |
| Example 13 | C4 | A6/B1 | 1/1 |
| Example 14 | C5 | A6/B2 | 1/2 |
| Example 15 | C6 | A7/B1 | 3/7 |
| Example 16 | C7 | A7/B1 | 1/1 |
| Example 17 | C8 | A7/B2 | 1/1 |
| Comparative Example 8 | C9 | R5/B1 | 1/1 |
| Comparative Example 9 | C10 | R5/B2 | 1/1 |
| Comparative Example 10 | C11 | R6/B1 | 3/7 |
| Comparative Example 11 | C12 | R6/B1 | 1/1 |
| Comparative Example 12 | C13 | R6/B2 | 1/1 |
| Comparative Example 13 | C14 | R7/B1 | 3/7 |
| Comparative Example 14 | C15 | R7/B1 | 1/1 |
| Comparative Example 15 | C16 | R7/B2 | 1/1 |

### Example 18

### Preparation of the Substrate A1 with a Photo-Alignment Layer

The varnish A1 described in Example 1 and a diluent solvent NMP/BC=1/1 (% by weight) were mixed, and the varnish A1 was diluted to 3% by weight. The polyamide acid solution (3% by weight) was dropped on an alkali-free glass plate (type 1737 made by Corning, Inc.), and applied by the spinner method (2,000 rpm, 15 seconds). After the application, the substrate was heated at 80° C. for 3 minutes and the solvent was evaporated. Then the substrate was irradiated with linearly polarized light (energy being about 2 J/cm² at 365 nm) through a polarizing plate, giving the substrate A1 with the photo-alignment layer.

### Examples 19 to 35

### Preparation of the Substrates A2 to A18 with a Photo-Alignment Layer

The substrates A2 to A18 with photo-alignment layers were obtained by a method similar to that of Example 18 except that the varnishes described in Table 4 were used.

TABLE 4

| | Photo- | | Drying Temper- | Irradiation |
|---|---|---|---|---|
| Example | aligned | | ature of Sub- | with Polarized |
| Number | Substrate | Varnish | strate (° C.) | UV (J/cm²) |
| Example 18 | A1 | A1 | 80 | 2 |
| Example 19 | A2 | A2 | 80 | 2 |
| Example 20 | A3 | A3 | 80 | 2 |
| Example 21 | A4 | A4 | 80 | 2 |
| Example 22 | A5 | C1 | 80 | 2 |
| Example 23 | A6 | C2 | 80 | 2 |
| Example 24 | A7 | C3 | 80 | 2 |
| Example 25 | A8 | C4 | 80 | 2 |
| Example 26 | A9 | C5 | 80 | 2 |
| Example 27 | A10 | C6 | 80 | 2 |
| Example 28 | A11 | C7 | 80 | 2 |
| Example 29 | A12 | C8 | 80 | 2 |
| Example 30 | A13 | A1 | 120 | 2 |
| Example 31 | A14 | A3 | 120 | 2 |
| Example 32 | A15 | A4 | 120 | 2 |
| Example 33 | A16 | A1 | 80 | 0.9 |
| Example 34 | A17 | A3 | 80 | 0.9 |
| Example 35 | A18 | A4 | 80 | 0.9 |

### Comparative Examples 16 to 33

### Preparation of the Substrates R1 to R18 with Photo-Alignment Layers

The photo-alignment layer substrates R1 to R18 were obtained by a method similar to that of Example 18 except that the varnishes described in Table 5 were used.

TABLE 5

| Comparative | Photo- | | Drying Temper- | Irradiation |
|---|---|---|---|---|
| Example | aligned | | ature of Sub- | with Polarized |
| Number | Substrate | Varnish | strate (° C.) | UV (J/cm²) |
| Comparative | R1 | R1 | 80 | 2 |
| Example 16 | | | | |
| Comparative | R2 | R2 | 80 | 2 |
| Example 17 | | | | |
| Comparative | R3 | R3 | 80 | 2 |
| Example 18 | | | | |
| Comparative | R4 | R4 | 80 | 2 |
| Example 19 | | | | |
| Comparative | R5 | C9 | 80 | 2 |
| Example 20 | | | | |
| Comparative | R6 | C10 | 80 | 2 |
| Example 21 | | | | |
| Comparative | R7 | C11 | 80 | 2 |
| Example 22 | | | | |
| Comparative | R8 | C12 | 80 | 2 |
| Example 23 | | | | |
| Comparative | R9 | C13 | 80 | 2 |
| Example 24 | | | | |
| Comparative | R10 | C14 | 80 | 2 |
| Example 25 | | | | |
| Comparative | R11 | C15 | 80 | 2 |
| Example 26 | | | | |
| Comparative | R12 | C16 | 80 | 2 |
| Example 27 | | | | |
| Comparative | R13 | R1 | 120 | 2 |
| Example 28 | | | | |
| Comparative | R14 | R3 | 120 | 2 |
| Example 29 | | | | |
| Comparative | R15 | R4 | 120 | 2 |
| Example 30 | | | | |
| Comparative | R16 | R1 | 80 | 2 |
| Example 31 | | | | |
| Comparative | R17 | R3 | 80 | 0.9 |
| Example 32 | | | | |
| Comparative | R18 | R4 | 80 | 0.9 |
| Example 33 | | | | |

### Example 36

### Preparation of the Polymerizable Liquid Crystal Composition (1)

The compound (M1-A-1), the compound (M1-B-1) and the compound (M4-A-1) were mixed at the weight ratio of 5:5:90, respectively. This composition was referred to as MIX1. A weight ratio of 0.001 of a nonionic fluorine-based surfactant (Futergent made by Neos Co., Ltd., FTX-218) and a weight ratio of 0.03 of a polymerization initiator CPI-110P (made by San-Apro Ltd.) were added to the MIX1, where the weight ratios were based on the weight of the MIX1. A mixed solvent of cyclopentanone/PGMEA=1/1 (at weight ratio) was added to this composition, giving the polymerizable liquid crystal composition (1) in which the ratio of the solvent was 80% by weight.

### Example 37

### Preparation of the Polymerizable Liquid Crystal Composition (2)

The polymerizable liquid crystal composition (2) was prepared by a method similar to that of Example 36 except that a mixture of the compound (M4-A-1):the compound (M3-A-1)=85:15 (at weight ratio) was used.

### Example 38

### Preparation of the Polymerizable Liquid Crystal Composition (3)

The polymerizable liquid crystal composition (3) was prepared by a method similar to that of Example 36 except that a mixture of the compound (M4-A-1):the compound (M3-B-1)=85:15 (at weight ratio) was used.

### Example 39

### Preparation of the Polymerizable Liquid Crystal Composition (4)

The compound (M1-C-1) and the compound (M3-C-1) were mixed at the weight ratio of 65:35, respectively. To the mixture, a weight ratio of 0.001 of a nonionic fluorine-based surfactant (Futergent made by Neos Co., Ltd., FTX-218), a weight ratio of 0.03 of a polymerization initiator Irgacure 907 (made by Ciba Japan K. K.) and a weight ratio of 0.03 of the polymerization initiator Irgacure 369 (made by Ciba Japan K. K.) were added, where the weight ratios were based on the weight of the mixture. A mixed solvent of cyclopentanone/PGMEA=1/1 (at weight ratio) was added to the mixture, giving the polymerizable liquid crystal composition (4) in which the ratio of the solvent was 80% by weight.

### Example 40

### Preparation of the Polymerizable Liquid Crystal Composition (5)

The polymerizable liquid crystal composition (5) was prepared by a method similar to that of Example 39 except that a mixture of the compound (M1-C-1):the compound (M1-C-2):the compound (M2-2-A-1)=62:35:3 (at weight ratio) was used.

### Example 41

### Preparation of the Polymerizable Liquid Crystal Composition (6)

The polymerizable liquid crystal composition (6) was prepared by a method similar to that of Example 39 except that the compound (M1-C-1):the compound (M1-D-1):the compound (M2-2-A-1)=30:30:40 (at weight ratio) was used.

### Example 42

### Preparation of the Polymerizable Liquid Crystal Composition (7)

The polymerizable liquid crystal composition (7) was prepared by a method similar to that of Example 39 except that the compound (M2-1-A-1):the compound (M2-1-B-1):the compound (M2-2-A-1)=30:30:40 (at weight ratio) was used.

### Example 43

### Preparation of the Polymerizable Liquid Crystal Composition (8)

The polymerizable liquid crystal composition (8) was prepared by a method similar to that of Example 39 except that the compound (M3-D-1):the compound (M2-2-A-1):the compound (M2-3-A-1):compound (M2-1-A-1)=20:40:37:3 (at weight ratio) was used.

### Example 44

### Preparation of the Polymerizable Liquid Crystal Composition (9)

The polymerizable liquid crystal composition (9) was prepared by a method similar to that of Example 39 except that the compound (M1-C-1):the compound (M2-1-A-1):the compound (M2-2-A-1):the compound (M5-A3-16-1-1)=10:48:40:2 (at weight ratio) was used.

### Example 45

### Preparation of the Polymerizable Liquid Crystal Composition (10)

The polymerizable liquid crystal composition (10) was prepared by a method similar to that of Example 39 except that the compound (M2-1-A-1):the compound (M2-3-A-1):the compound (M3-E-1):the compound (M3-E-2)=3:37:30:30 (at weight ratio) was used.

### Example 46

### Formation of an Optically Anisotropic Substance

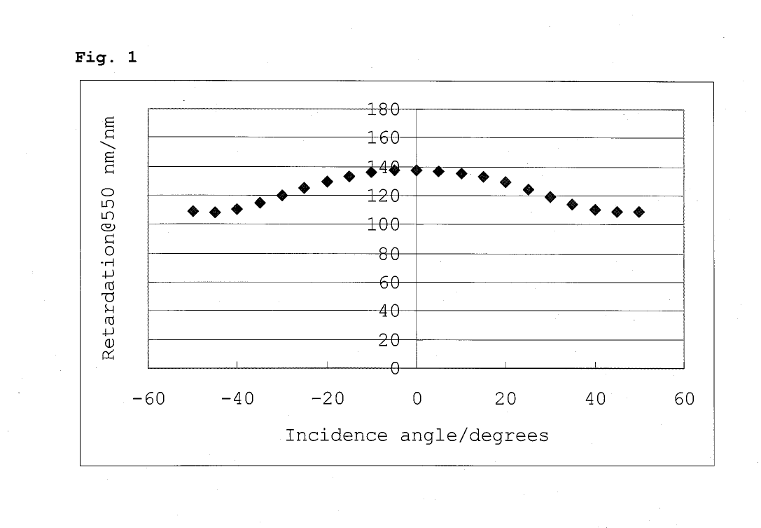

The polymerizable liquid crystal composition (1) was applied to the substrate A1 with a photo-alignment layer in Example 18, by a spin coating method. This substrate was heated at 80° C. for 3 minutes, and then cooled for 3 minutes at room temperature. The resulting layer from which the solvent was removed was polymerized in air with ultraviolet light, giving an optically anisotropic substance in which the orientation of a liquid crystal state was fixed. The optically anisotropic substance had no orientation defects but a uniform orientation when observed with a polarizing microscope. The optically anisotropic substance was found to have a homogeneous orientation based on the results as shown in FIG. 1 on measurement of the retardation.

### Examples 47 to 63

Optically anisotropic substances of the polymerizable liquid crystal composition (1) were formed by a method similar to that of Example 46 by using the substrates A2 to A18 with photo-alignment layers obtained in Examples 19 to 35. Any of the optically anisotropic substances had no orientation defects but a uniform orientation, and was found to have a homogeneous orientation since the retardation was similar to that in FIG. 1.

### Example 64

An optically anisotropic substance of the polymerizable liquid crystal composition (2) was formed on the substrate A1 with a photo-alignment layer described above by a method similar to that of Example 46. The substance had no orientation defects but a uniform orientation, and was found to have a homogeneous orientation since the retardation was similar to that in FIG. 1.

### Example 65

An optically anisotropic substance of the polymerizable liquid crystal composition (3) was formed on the substrate A1 with a photo-alignment layer described above by a method similar to that of Example 46. The substance had no orientation defects but a uniform orientation, and was found to have a homogeneous orientation since the retardation was similar to that in FIG. 1.

### Example 66

An optically anisotropic substance of the polymerizable liquid crystal composition (4) was formed on the substrate A1 with a photo-alignment layer described above by a method similar to that of Example 46. The substance had no orientation defects but a uniform orientation, and was found to have a homogeneous orientation since the retardation was similar to that in FIG. 1.

### Example 67

An optically anisotropic substance of the polymerizable liquid crystal composition (5) was formed on the substrate A1 with a photo-alignment layer described above by a method similar to that of Example 46. The substance had no orientation defects but a uniform orientation, and was found to have a homogeneous orientation since the retardation was similar to that in FIG. 1.

### Example 68

An optically anisotropic substance of the polymerizable liquid crystal composition (6) was formed on the substrate A1 with a photo-alignment layer described above by a method similar to that of Example 46. The substance had no orientation defects but a uniform orientation, and was found to have a homogeneous orientation since the retardation was similar to that in FIG. 1.

### Example 69

An optically anisotropic substance of the polymerizable liquid crystal composition (7) was formed on the substrate A1 with a photo-alignment layer described above by a method similar to that of Example 46. The substance had no orientation defects but a uniform orientation, and was found to have a homogeneous orientation since the retardation was similar to that in FIG. 1.

### Example 70

An optically anisotropic substance of the polymerizable liquid crystal composition (8) was formed on the substrate A1 with a photo-alignment layer described above by a method similar to that of Example 46. The substance had no orientation defects but a uniform orientation, and was found to have a homogeneous orientation since the retardation was similar to that in FIG. 1.

### Example 71

An optically anisotropic substance of the polymerizable liquid crystal composition (9) was formed on the substrate A1 with a photo-alignment layer described above by a method similar to that of Example 46. The substance had no orientation defects but a uniform orientation, and was found to have a homogeneous orientation since the retardation was similar to that in FIG. 1.

### Example 72

An optically anisotropic substance of the polymerizable liquid crystal composition (10) was formed on the substrate A1 with a photo-alignment layer described above by a method similar to that of Example 46. The substance had no orientation defects but a uniform orientation retardation, and was found to have a homogeneous orientation since the retardation was similar to that in FIG. 1.

### Example 73

A norbornene-based resin (a ZEONOR film /ZEONOR ZF14; made by Nippon Zeon Co., Ltd.) was used for a supporting substrate, and an Atmospheric Plasma Surface Treatment System (Model AP-T02-L) was used for surface hydrophilization treatment (plasma treatment). The plasma discharge conditions were as follows. A film was continuously wound off at a constant winding-off speed of 3 m/min, fed into a gap between electrodes (electrode width 700 mm×electrode length 40 mm) held 2 mm apart by a spacer, subjected to plasma treatment and wound up with a take-up roll. Glow discharge plasma was generated by first converting an alternating current into a direct current with a DC power supply, and then applying to electrodes pulse voltage with a rise-time of 5 μs, a pulse-width of 100 μs, a frequency of 3 kHz and a voltage of ±5 kV with a pulse unit. Moreover, mixed gas (nitrogen:oxygen=95:5 (V/V)) was supplied between electrodes as raw gas.

The degree of hydrophilization treatment was evaluated by measuring the contact angle (25° C.) of pure water dropped onto the norbornene-based resin base material (with a Contact Angle Meter Model CA-A; made by Kyowa Interface Science Co. Ltd.). The contact angle before the treatment was found to be 97 degrees° and that after the treatment 30 degrees. Photo-alignment treatment was carried out by a method similar to that described in Example 18 by use of the varnish A3 in Example 3. An optically anisotropic substance of the polymerizable liquid crystal composition (1) was formed by a method similar to that of Example 46. The optically anisotropic substance obtained had no orientation defects but a uniform orientation, and was found to have a homogeneous orientation since the retardation was similar to that in FIG. 1.

### Example 74

An optically anisotropic substance was formed by a method similar to that of Example 73 except that the polymerizable liquid crystal composition (1) was replaced by the polymerizable liquid crystal composition (9). The substance had no orientation defects but a uniform orientation, and was found to have a homogeneous orientation since the retardation was similar to that in FIG. 1.

### Example 75

An optically anisotropic substance was formed by a method similar to that of Example 73 except that the polymerizable liquid crystal composition (9) was cured under a nitrogen atmosphere instead of in air. The substance had no orientation defects but a uniform orientation, and was found to have a homogeneous orientation since the retardation was similar to that in FIG. 1.

### Example 76

The varnish A1 described in Example 1 was applied to an alkali-free glass supporting substrate, and was dried at 80° C. Next, a mask (a fused silica glass) having an arbitrary chromium patterning thereon was placed just above the layer of the polyamic acid A1, and the layer was irradiated with linearly polarized light (at 365 nm with an energy of 2 J/cm²) through a polarizing plate. Next, the position of the mask was adjusted so that an area which was first irradiated was hidden. Then, a new area masked was irradiated with linearly polarized light (at 365 nm with an energy of 2 J/cm²) having a polarization direction that was different from that of the first irradiation. An optically anisotropic substance of the polymerizable liquid crystal composition (1) was formed by a method similar to that of Example 46, using the resulting photo-alignment layer substrate. The substance had no orientation defects in both areas but a uniform orientation, and was found to have a homogeneous orientation since the retardation was similar to that in FIG. 1.

### Example 77

The compound (OP-1) described below was used as an optically active compound. This compound was synthesized by the method described in JP 2005-263778 A.

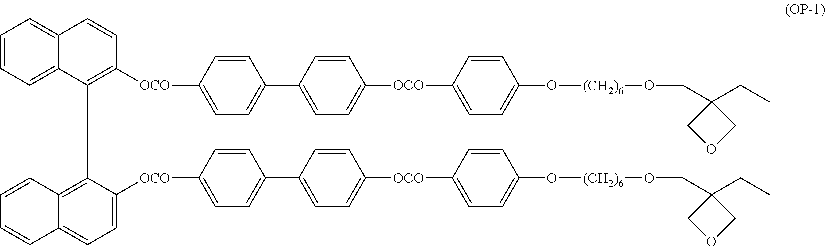

The polymerizable liquid crystal composition (11) was prepared by a method similar to that of Example 36 except that a weight ratio of 0.03 of the optically active compound (OP-1) was added to MIX1, where the weight ratio was based on the total weight of the MIX1 described in Example 36. Then, an optically anisotropic substance was formed by a method similar to that of Example 46 except that this polymerizable liquid crystal composition (11) was used. The optically anisotropic substance obtained had a transparent appearance and selective reflection of red. The center wavelength of the selective reflection of the optically anisotropic substance was 635 nm, and the selective reflection region was about 80 nm.

### Comparative Examples 34 to 51

An optically anisotropic substance of the polymerizable liquid crystal composition (1) was formed by a method similar to that of Example 46, using the photo-alignment layer substrate obtained in Comparative Examples 16 to 33 described in Table 5. Any optically anisotropic substance had an insufficient orientation and cloudy appearance.

The Examples and Comparative Examples described above show that an optically anisotropic substance in which various polymerizable liquid crystal compositions are uniformly oriented can be obtained by heating at a temperature below 140° C. and carrying out photo-alignment treatment to a layer formed from the polyamic acid varnish which has a divalent azobenzene group in the principal chain. They also show that an optically anisotropic substance in which the orientation direction of the liquid crystal molecules is adjusted is formed. They further show that an optically anisotropic substance formed by use of a glass plate as a supporting substrate is similar to that formed by use of a plastic film as a supporting substrate, since the drying temperature is below 140° C.

Although the invention has been described and illustrated with a certain degree of particularity, it is understood that the disclosure has been made only by way of example, and that numerous changes in the conditions and order of steps can be resorted to by those skilled in the art without departing from the spirit and scope of the invention.

### INDUSTRIAL APPLICABILITY

According to the invention, a heating step can be carried out at a condition as mild as below 140° C. even if a photo-alignment layer with a polyamic acid-type is used. The uniform orientation of various polymerizable liquid crystal compositions can be attained, and formation of the optically anisotropic substance onto a plastic film is realized.

What is claimed is:

1. An optically anisotropic substance obtained by applying a polyamic acid varnish which is a composition including a polyamic acid having a divalent azobenzene group in the principal chain or a composition including a mixture of this polyamic acid and other polyamic acids as a polymer component, to a supporting substrate, by drying the resultant layer at a temperature range of approximately 50° C. to approximately 140° C., by carrying out alignment treatment by irradiation of the layer with light, applying a polymerizable liquid crystal composition to a alignment layer formed by means of the treatment, and polymerizing the composition.

2. The optically anisotropic substance according to claim 1, wherein the polyamic acid having a divalent azobenzene group in the principal chain is a reaction product of a diamine having a divalent azobenzene group or of a mixture of the diamine having a divalent azobenzene group and other diamines with a tetracarboxylic acid dianhydride, where the diamine having a divalent azobenzene group is at least one of diamines represented by formula (1-1) to formula (1-7); and the polymerizable liquid crystal composition comprises at least one compound selected from the group of compounds represented by formula (M1), formula (M2-1) to formula (M2-3), formula (M3) and formula (M4): 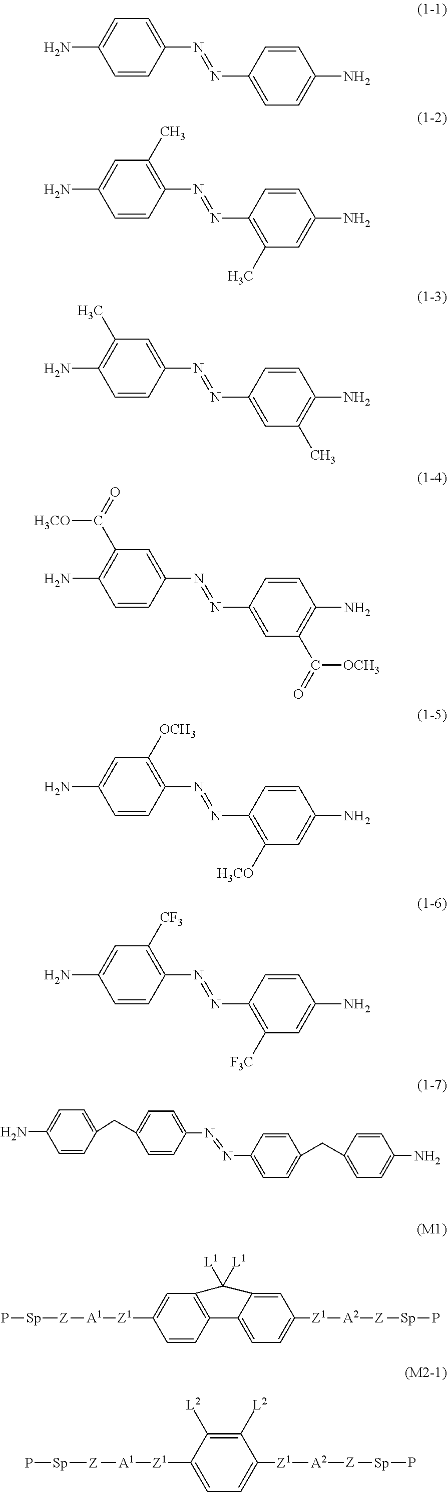 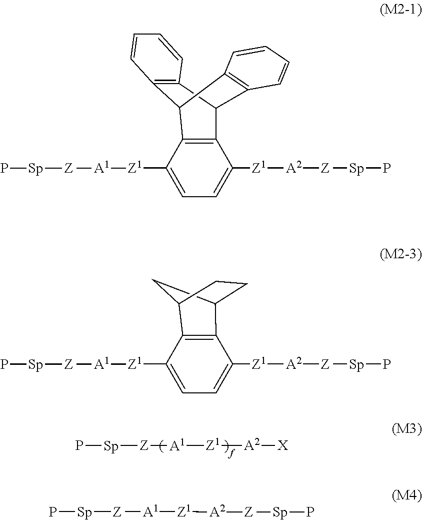
wherein
Sp is a single bond or alkylene having 1 to 20 carbons; and when the number of carbon is two or more in this alkylene, one or two nonadjacent —CH₂— may be replaced by —O—;
Z is independently a single bond, —O—, —COO—, —OCO— or —O—COO—;
A¹ and A² are each independently 1,4-cyclohexylene or 1,4-phenylene; and in these rings, one or two nonadjacent —CH₂— may be replaced by —O—, arbitrary —CH═ may be replaced by —N═, arbitrary hydrogen may be replaced by halogen, —C≡N, alkyl having 1 to 5 carbons or halogenated alkyl having 1 to 5 carbons;
Z¹ is independently a single bond or alkylene having 1 to 10 carbons; in this alkylene, arbitrary —CH₂— may be replaced by —O—, —CO—, —COO—, —OCO—, —CH═CH— or —C≡C— and arbitrary hydrogen may be replaced by halogen;
L¹ is independently hydrogen, fluorine or methyl;
L² is independently hydrogen, fluorine, methyl or trifluoromethyl;
f is an integer of 0 to 3; when f is 2 or 3, a plurality of A¹ in formula (M3) may be the same groups or may be consisting of at least two different groups, and a plurality of Z¹ in formula (M3) may be the same group or may be consisting of at least two different groups;
X is hydrogen, halogen, —C≡N, alkyl having 1 to 20 carbons or alkoxy having 1 to 20 carbons; arbitrary hydrogen of these alkyl and alkoxy may be replaced by halogen; and
P is any one of groups represented by formula (2-1) to formula (2-3), and formula (2-6): 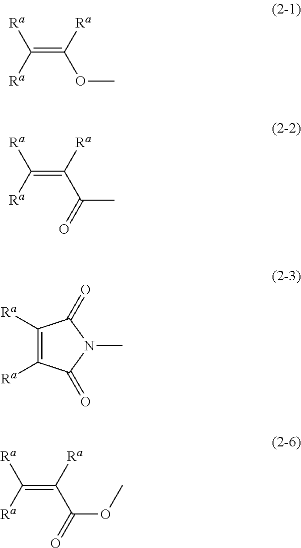
wherein R^{a} is independently hydrogen, halogen or alkyl having 1 to 5 carbons, and arbitrary hydrogen in this alkyl may be replaced by halogen.

3. The optically anisotropic substance according to claim 2, wherein the polyamic acid having a divalent azobenzene group in the principal chain is a reaction product of a mixture of a diamine having a divalent azobenzene group and other diamines with a tetracarboxylic acid dianhydride, where the other diamines are represented by formula (3): 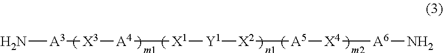
wherein A³, A⁴, A⁵ and A⁶ are each independently 1,3-cyclohexylene, 1,4-cyclohexylene, 1,3-phenylene or 1,4-phenylene, and arbitrary hydrogen of these rings may be replaced by alkyl having 1 to 4 carbons or benzyl; X¹ and X² are each independently a single bond, —O— or —S—; X³ and X⁴ are each independently a single bond, —CH₂—, —CH₂CH₂—, —O—, —S— or —C(R¹¹)(R¹²)—; Y¹ is alkylene having 1 to 12 carbons, —C(R¹¹)(R¹²)—, CO— or —SO₂—; R¹¹ and R¹² are each independently alkyl having 1 to 6 carbons or perfluoroalkyl having 1 to 6 carbons; and m1, m2 and n1 are each independently 0 or 1.

4. The optically anisotropic substance according to claim 3, wherein, in formula (3), A³, A⁴, A⁵ and A⁶ are each independently 1,3-phenylene or 1,4-phenylene; arbitrary hydrogen of these rings may be replaced by alkyl having 1 to 4 carbons; X¹ and X² are each independently a single bond, —O— or —S—; X³ and X⁴ are each independently a single bond, —CH₂—, —CH₂CH₂—, —O— or —C(R¹¹)(R¹²)—; Y¹ is alkylene having 1 to 8 carbons, —C(R¹¹)(R¹²)— or —CO—; R¹¹ and R¹² are each independently alkyl having 1 to 3 carbons or perfluoroalkyl having 1 to 3 carbons; and m1, m2 and n1 are each independently 0 or 1.

5. The optically anisotropic substance according to claim 3, wherein, in formula (3), A³, A⁴, A⁵ and A⁶ are each independently 1,3-phenylene or 1,4-phenylene; arbitrary hydrogen of these rings may be replaced by methyl; X¹ and X² are each independently a single bond, —O— or —S—; X³ and X⁴ are each independently a single bond, —CH₂—, —CH₂CH₂—, —O— or —C(R¹¹)(R¹²)—; Y¹ is alkylene having 1 to 6 carbons, —C(R¹¹)(R¹²)— or —CO—; R¹¹ and R¹² are each independently methyl or trifluoromethyl; and m1, m2 and n1 are each independently 0 or 1.

6. The optically anisotropic substance according to claim 2, wherein the tetracarboxylic acid dianhydride is at least one compound selected from the group of tetracarboxylic acid dianhydrides represented by formula (A-1) to formula (A-44).

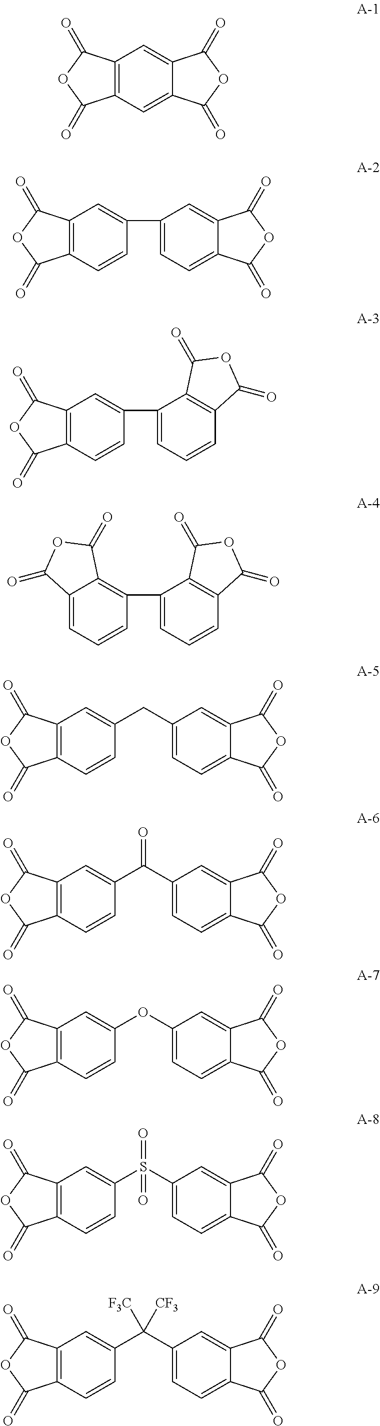

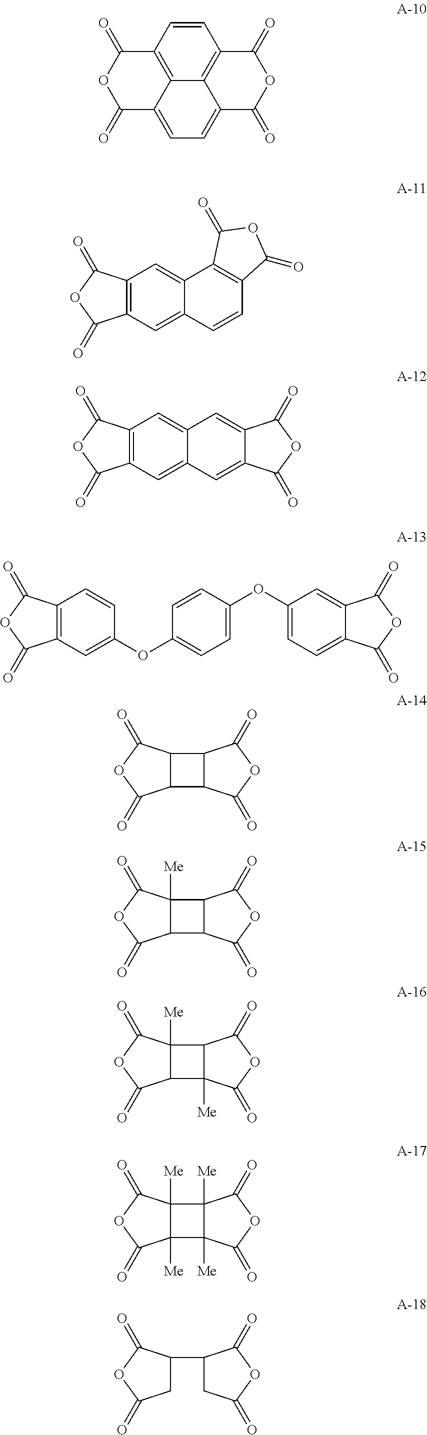

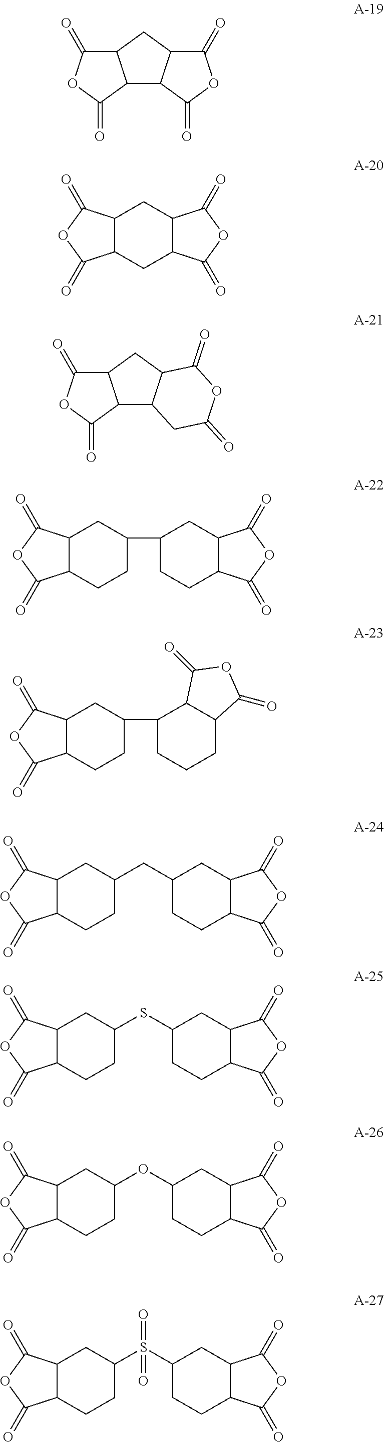

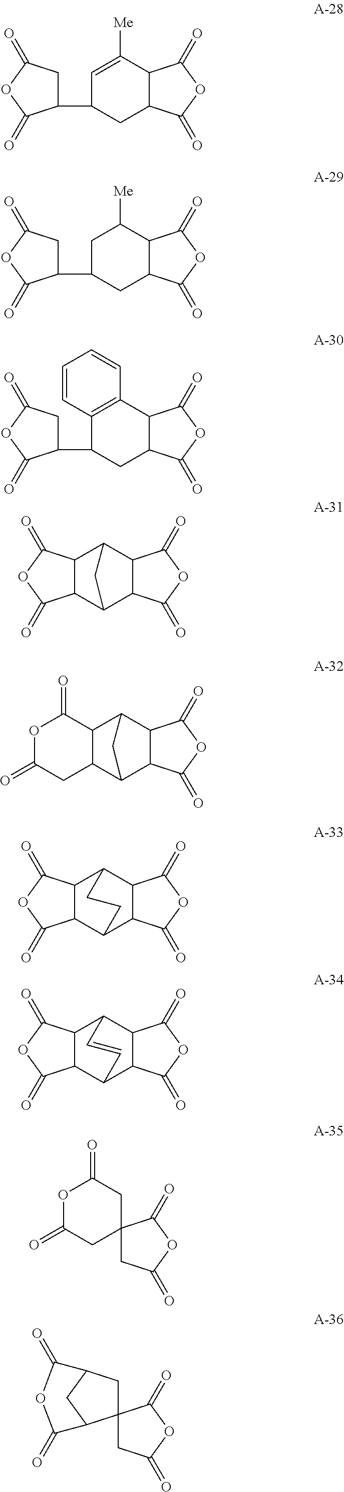

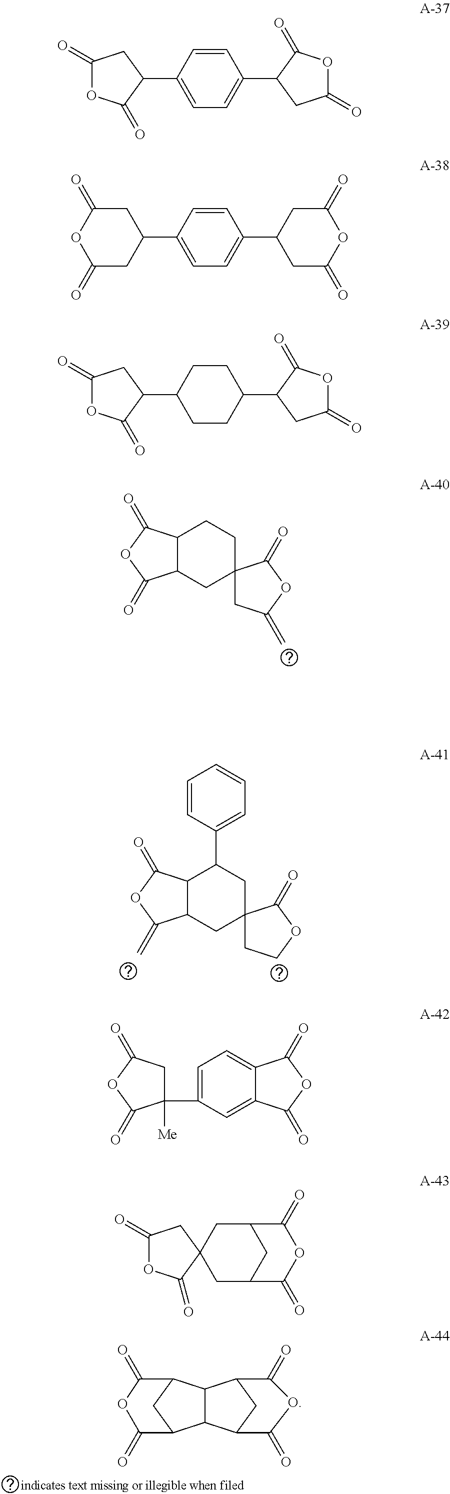

7. The optically anisotropic substance according to claim 6, wherein the tetracarboxylic acid dianhydride is at least one compound selected from the group of tetracarboxylic acid dianhydrides represented by formula (A-1), formula (A-2), formula (A-5) to formula (A-7), formula (A-9), formula (A-14) to formula (A-22), formula (A-24) to formula (A-26) and formula (A-28) to formula (A-44).

8. The optically anisotropic substance according to claim 2, wherein the polymerizable liquid crystal composition comprises at least one compound selected from the group of compounds represented by formula (M1), formula (M2-1), formula (M2-2), formula (M2-3), formula (M3) and formula (M4),
Sp is a single bond or alkylene having 1 to 12 carbons; in this alkylene, when the number of carbon is two or more, one or two nonadjacent —CH₂ may be replaced by —O—;
Z is a single bond, —O—, —COO—, —OCO— or —OCOO—;
A¹ and A² are each independently 1,4-cyclohexylene or 1,4-phenylene; in these rings, arbitrary hydrogen may be replaced by fluorine, —C≡N, alkyl having 1 to 5 carbons or fluoroalkyl having 1 to 5 carbons;
Z¹ is independently a single bond or alkylene having 1 to 10 carbons; in this alkylene, arbitrary —CH₂— may be replaced by —O—, —COO—, —OCO— or —CH═CH—;
L¹ is independently hydrogen, fluorine or methyl;
L² is independently hydrogen, fluorine, methyl or trifluoromethyl; and
P is a group represented by formula (2-6), where R^{a} is hydrogen, methyl or ethyl.

9. The optically anisotropic substance according to claim 8, wherein the polymerizable liquid crystal composition comprises at least one compound selected from the group of compounds represented by formula (M1-C), formula (M1-D), formula (M2-1-A), formula (M2-1-B), formula (M2-2-A), formula (M2-3-A), formula (M3-C), formula (M3-D) and formula (M3-E): 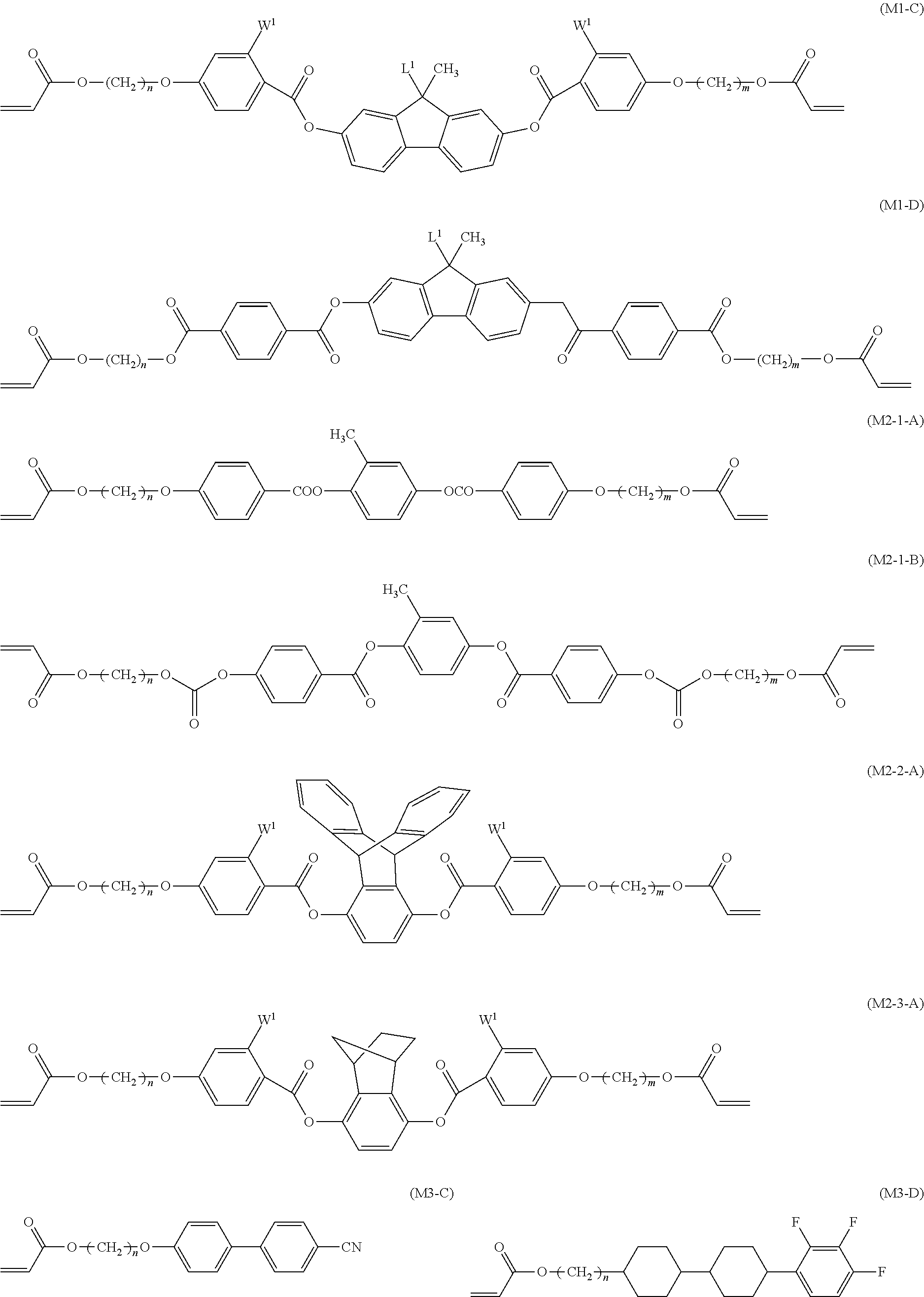 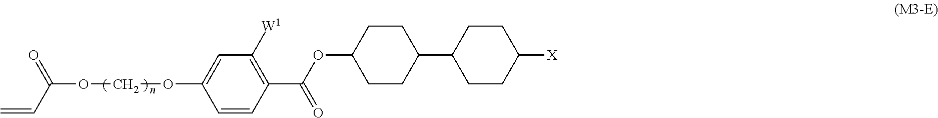
wherein L¹ is hydrogen or methyl; W¹ is hydrogen or fluorine; X is alkyl having 1 to 20 carbons; and n and m are each independently an integer of 2 to 12.

10. The optically anisotropic substance according to claim 9, wherein, in the polymerizable liquid crystal composition,
the ratio of a compound represented by formula (M1-C) is in the range of approximately 0% to approximately 85% by weight;
the ratio of a compound represented by formula (M1-D) is in the range of approximately 0% to approximately 50% by weight;
the ratio of a compound represented by formula (M2-1-A) is in the range of approximately 0% to approximately 70% by weight;
the ratio of a compound represented by formula (M2-1-B) is in the range of approximately 0% to approximately 70% by weight;
the ratio of a compound represented by formula (M2-2-A) is in the range of approximately 0% to approximately 70% by weight;
the ratio of a compound represented by formula (M2-3-A) is in the range of approximately 0% to approximately 70% by weight;
the ratio of a compound represented by formula (M3-C) is in the range of approximately 0% to approximately 45% by weight;
the ratio of a compound represented by formula (M3-D) is in the range of approximately 0% to approximately 30% by weight;
the ratio of a compound represented by formula (M3-E) is in the range of approximately 0% to approximately 70% by weight;
the ratio of a compound selected from the group of compounds represented by formula (M2-2-A), formula (M2-3-A), formula (M3-C), formula (M3-D) and formula (M3-E) is in the range of approximately 3% to approximately 97% by weight; and
the ratio of a compound selected from the group of compounds represented by formula (M1-C), formula (M1-D), formula (M2-1-A) and formula (M2-1-B) is in the range of approximately 3% to approximately 97% by weight,
based on the total amount of compounds represented by formula (M1-C), formula (M1-D), formula (M2-1-A), formula (M2-1-B), formula (M2-2-A), formula (M2-3-A), formula (M3-C), formula (M3-D) and formula (M3-E).

11. The optically anisotropic substance according to claim 8, wherein the polymerizable liquid crystal composition further comprises the polymerizable compound represented by formula (M5): 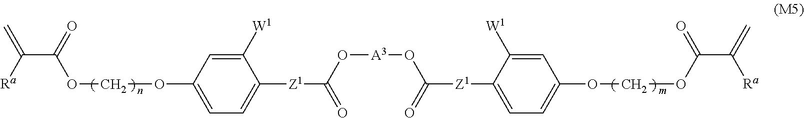
wherein R^{a} is independently hydrogen or methyl; W¹ is independently hydrogen or fluorine; Z¹ is independently a single bond, —CH₂CH₂— or —CH═CH—; n and m are each independently an integer of 2 to 12; and A³ is a group represented by any one of formula (A3-1) to formula (A3-18).

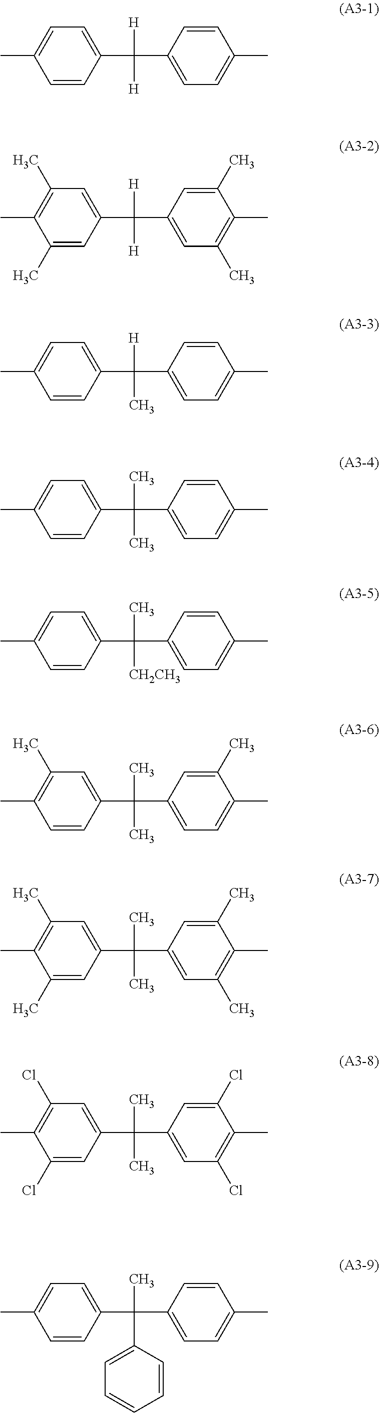

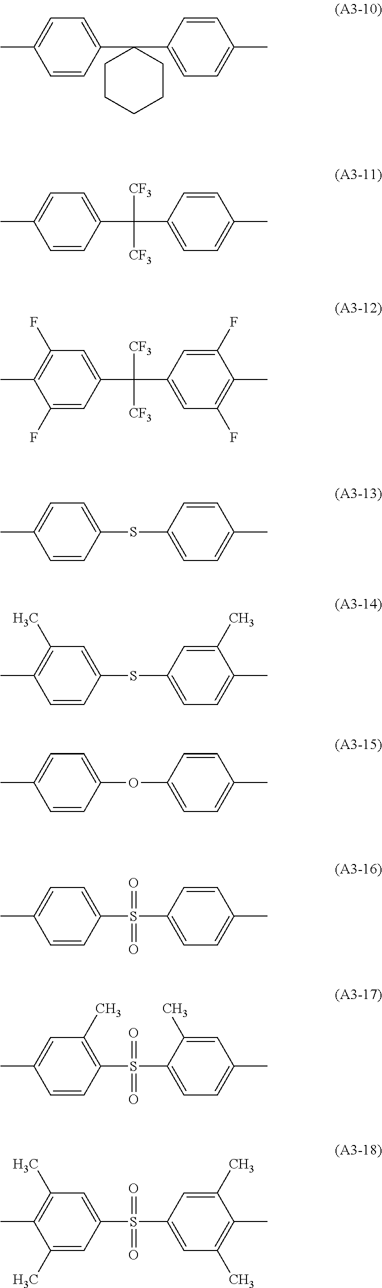

12. The optically anisotropic substance according to claim 11, wherein, in formula (M5), R^{a} is hydrogen; W¹ is independently hydrogen or fluorine; Z¹ is independently a single bond, —CH₂CH₂— or —CH═CH—; n and m are each independently an integer of 2 to 12; and A³ is a group represented by any one of formula (A3-3), formula (A3-11), formula (A3-12), formula (A3-16), formula (A3-17) and formula (A3-18).

13. The optically anisotropic substance according to claim 8, wherein the polymerizable liquid crystal composition further comprises an optically active compound.

14. The optically anisotropic substance according to claim 2, wherein the light irradiation for orientation treatment is carried out by irradiation with linearly polarized light at an arbitrary angle to the supporting substrate.

15. The optically anisotropic substance according to claim 2, wherein the light irradiation for orientation treatment is carried out by a combination of irradiation with linearly polarized light in the perpendicular direction and irradiation with unpolarized light at an arbitrary angle.

16. The optically anisotropic substance according to claim 2, wherein liquid crystal molecules are oriented in a pattern of two or more different directions by carrying out orientation treatment by irradiation with light.

17. The optically anisotropic substance according to claim 2, wherein the supporting substrate is a glass substrate.

18. The optically anisotropic substance according to claim 2, wherein the supporting substrate is a plastic substrate composed of a plastic film.

19. The optically anisotropic substance according to claim 18, wherein material of the plastic film is any one selected from polyimide, polyamidoimide, polyamide, polyetherimide, polyetheretherketone, polyetherketone, polyketone sulfide, polyether sulfone, polysulfone, polyphenylene sulfide, polyphenylene oxide, polyethylene terephthalate, polybutylene terephthalate, polyethylene naphthalate, polyacetal, polycarbonate, polyarylate, acrylic resins, polyvinyl alcohol, polypropylene, cellulose, triacetyl cellulose, partially saponified triacetyl cellulose, epoxy resins, phenol resins and cycloolefin-based resins.

20. The optically anisotropic substance according to claim 18, wherein material of the plastic film is any one selected from polyimide, polyvinyl alcohol, triacetyl cellulose, partially saponified triacetyl cellulose and cycloolefin-based resins.

21. An optical retardation film having the optically anisotropic substance according to claim 2.

22. A liquid crystal display device having the optical retardation film according to claim 21.

23. A liquid crystal display apparatus having the liquid crystal display device according to claim 22.
